(19) United States
(12) Patent Application Publication
(10) Pub. No.: US 2010/0204046 A1
(43) Pub. Date: Aug. 12, 2010

(54) Processes for the Control of Undesired Vegetation

(75) Inventors: Ronnie Helms, Stuttgart, AR (US); Wallace Keith Majure, West Monroe, LA (US); Mominic Frank Alonso, Linden, CA (US); Kevin Wayne Stewart, Collierville, TN (US); Nick Vandervort, Cresco, IA (US); Paul Joseph David, Litilz, PA (US); Brian Duane Deeter, Auberry, CA (US); George David Newberry, Boise, ID (US); Gary Joseph Melchior, Walla Walla, WA (US); James Richard Brazzle, Sacramento, CA (US); Kenneth Roger Muzyk, Brandon, FL (US); Charles Paul Grasso, Yuma, AZ (US); Frank Rene Miranda, Holtville, CA (US); Sandra Alcaraz, Yuma, AZ (US); Tak Wai Cheung, Yuma, AZ (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Gowan Co., Yuma, AZ (US)

(21) Appl. No.: 12/668,958

(22) PCT Filed: Jul. 21, 2008
(86) PCT No.: PCT/US08/70589

§ 371 Date: Jan. 13, 2010

Related U.S. Application Data
(60) Provisional application No. 60/951,299, filed on Jul. 23, 2007.
(60) Provisional application No. 60/951,300, filed on Jul. 23, 2007.

(51) Int. Cl. A01N 25/32; A01N 43/40

(52) U.S. Cl. 504/105; 504/130

(57) ABSTRACT

Improved agricultural processes for the controlled cultivation of crops are disclosed. In one aspect, crops of different types, namely that is to say crops grown from seeds, plants or cultivars having resistance to two (or more) different classes of herbicides, are treated to control undesired vegetative growth using a single class of herbicides.

This application is US National Stage application based on PCT/US2008/070589, which in turn claims priority from U.S. Ser. No. 60/951299 and U.S. Ser. No. 60/951300 both filed 23 Jul. 2007.

Broadly the present invention relates to an improved process for the control of undesired vegetation amongst crops.

In order to improve the crop yields of desirable crops which are used for foodstuffs, human or animal consumption, or other purposes such as biofuels it has long been the practice in the fields to utilize on the one hand a broad spectrum type of herbicide or compositions which are effective at controlling or eradicating the growth of undesired vegetation, i.e., weeds, within fields or plots having were in such crops are grown and ultimately harvested, and on the other hand to grow such crops from seeds, plants, or cultivars which haven't been genetically modified, crossbred, or otherwise altered in order to present specific resistance to, alternately also referred to as “tolerance to” specific classes of herbicides. Crop yields are expected to be best when a specific type or class of seed, plants, or cultivar having a specific tolerance is treated by a herbicide of that type. In such a manner, undesired vegetation growing among the plants of the crop can be controlled and or eradicated by use of the specific herbicide to which the seed, plants or cultivars exhibits resistance thereto. This is advantageous in that the farmer or other producer is not required to necessarily use two or more types of different herbicidal compounds or compositions, or to prepare multiple herbicidal preparations which may require separate applications to a crop either pre-planting, or post emergence of such herbicidal preparations to the crop.

A particularly popular and successful class of herbicide compounds are those based on glyphosates, with the most salient commercial product being commercially sold as “Roundup®” (ex. Monsanto). This glyphosate type herbicide has been known for many years to be highly effective in the control and eradication of undesired vegetative growth in crops and has found widespread acceptance and use. Such widespread acceptance and use is further bolstered by the fact that the supplier of Roundup® also has developed various seed lines for crops, such as soybeans, which have been genetically modified, crossbred or otherwise altered in order to exhibit resistance to the Roundup® line of herbicides, viz, are “tolerant to” Roundup®. The combined use of both Roundup® herbicides in conjunction with specific seed lines which are tolerant to Roundup® has led to improved crop yields, and has reduced the amount and/or the frequency of the application of herbicidal treatment compositions to crops as the application of glyphosate based herbicidal preparations is usually successful in eradicating weeds while at the same time minimizing damage to the crop.

Notwithstanding the popularity of the above, many other classes of herbicides are also known and similarly, various suppliers have produced and made commercially available various seed lines, plants or cultivars for crops which exhibit tolerance to and/or resistance to one or more of the specific classes of herbicides. For example, varieties of rice have been developed which have been genetically modified, crossbred or otherwise altered in order to exhibit resistance to the class of sulfonylurea based herbicides. Such varieties are in widespread use, as they are found to be very effectively treated by the use of sulfonylurea based herbicidal treatment preparations which are known to be effective in controlling the growth of undesired vegetation within the rice crop, while at the same time not unduly affecting the vitality of the rice crop itself or its rice yield.

Unfortunately, the effectiveness of the classes are herbicides as a broad-spectrum herbicides has been found to have a deleteriously effect when improperly applied appeared for example, it is unexpected in the art that a plant or crop which may exhibit either naturally occurring resistance to and/or tolerance to, or which has been genetically modified, crossbred or otherwise altered to be resistant to and/or tolerant to a specific herbicide would be expected to have any reasonable resistance to different herbicides of a different class. For example, seeds or plants which are produced to be tolerant to Roundup® would be expected to be destroyed or stunted if treated with a different class of herbidices, e.g., sulfonyl ureas or other ALS inhibiting herbicides. In fact, misapplication, such as by inadvertent spraying of herbicidal treatment preparations, e.g., such as by error, or by wind drifting of the herbicidal treatment preparations onto a crop which has not been imparted with the resistance to and/or tolerance to such herbicide typically results in serious damage or destruction of the seeds or crop. This result is not surprising nor unexpected and as it is known that popular classes of herbicides are commercially successful as they do exhibit broad-spectrum efficacy.

Such a technical effect is however not without technical shortcomings. As noted above, one shortcoming is the misapplication of a herbicidal treatment preparation to the wrong type of crop. Such is expected to unduly deleteriously damage, or even to destroy the crop. A further shortcoming is that it is normal practice to limit the planting to a single crop having a single and common herbicidal resistant characteristic. For example, in order to maximize crop yield and minimize unnecessary damage, a single crop such as soybean having a resistance to and/or tolerance to a single class of herbicides would be planted on wide tracts of land, typically not geographically near or proximate to other crops which might be damaged by the application of the herbicidal treatment preparation used to treat the said a single crop. This is due to the fact that during the growth of the said single crop, single or often multiple applications of a herbicidal treatment preparation would need to be applied either as a preplanting treatment, post planting of the seeds but preemergence to the seeds or soil, or onto the emerged plants. Growing a single crop having herbicidal tolerance to a specific class of herbicides which is physically separated from other crops having no tolerance to, or having herbicidal tolerance to a different class of herbicides than the aforesaid single crop, minimizes the risk of unwanted damage to these other crops. However, such a practice undesirably limits the types of crops which might be grown by a farmer or other producer where land is limited, and a limiting the farmer or producer to a single crop or to waste arable land in order to provide sufficient physical barriers between differing crops having tolerance to different classes of herbicides. Neither of these is particularly technically or commercially advantageous.

Thus, as can be understood from the foregoing while current agricultural practices in the cultivation of crops is highly effective, there is nonetheless a continuing and real need in the art for still further improvements to such agricultural practices.

Surprisingly it has been found that halosulfuron-methyl, from the sulfonyl urea class of herbicides, also referred to as ALS inhibiting herbicides, demonstrates improved tolerance and safety when applied to, around, and adjacent to glyphosate tolerant crops. This finding now provides an additional tool for the use of halosulfuron-methyl, an alternate mode of action herbicide, to be used in conjunction with glyphosate tolerant crops to assist in the control of undesired vegetation in, around, and adjacent to these crops and to suppress the related development of glyphosate tolerant weed species and shifting weed pressure to more tolerant weeds. Such a behavior has been observed with a commercially available compound marketed under the tradename PERMIT, (ex. Gowan Co., Yuma, Ariz.) but while not wishing to be bound by the following it is believed that such behavior might also be observed with other specific sulfonylurea herbicide compounds.

Accordingly, in one aspect of the present invention, the present inventors provide improved agricultural processes for the controlled cultivation of crops are the different types, namely that is to say crops grown from seeds, plants or cultivars having resistance to two (or more) different classes of herbicides, wherein the crops are treated to control undesired vegetative growth using a single class of herbicides.

According to a second aspect of the invention at present inventors provide improved agricultural method for planting different crops having tolerance to different classes of herbicides, either adjacent to one another or in reasonable sufficient geographic proximity to one another and to treat the first crops with at least a first herbicide without unduly damaging or risking the undesirable damage of the second crop by either directly, or indirectly contacting the second crop with the first herbicide.

According to a third aspect of the invention, there is provided an improved agricultural method for the control of undesired vegetative growth in two (or more) crops each having a specific resistance to different classes of herbicides, especially preferably wherein at least one of the crops has a resistance to/tolerance to sulfonyl urea type herbicides, especially where such is halosulfuron methyl, and at least one of the other crops has does not exhibit a resistance to/tolerance to sulfonyl urea type herbicides, especially where such is halosulfuron methyl, wherein the said crops are either adjacent to each other, or are in sufficient geographical proximity to one another whereby there exists a likelihood of inadvertent or of direct application of a first herbicide treatment preparation being applied to the said first crop to be either inadvertently or directly applied to at least a part of the second crop, wherein said application of said first herbicide treatment preparation does not undesirably or unduly deleteriously effect the treated seeds, or plants forming part of said second crop.

According to a fourth aspect of the invention there is provided an improved agricultural method for the control of undesired vegetative growth especially in a field or plot wherein a crop plant is to be planted or is already present in the form of a seed or plant having a resistance to/tolerance to glyphosate-type herbicides wherein undesired vegetative growth amongst the crop is controlled with or eradicated by the use of a herbicidal treatment preparation comprising a herbicidally effective amount of a sulfonylurea based herbicide which may be applied either pre-planting, pre-emergence or post-emergence of the said crop. Preferably the glyphosate-type herbicides are those based on the commercially available class of herbicides presently being marketed as Roundup® (ex. Monsanto.)

According to a fifth aspect of the invention there are provided herbicide treatment preparations which comprise at least one sulfonylurea herbicide, (or salt thereof) especially wherein said sulfonylurea herbicide is a halosulfuron methyl which may be represented by the structure:

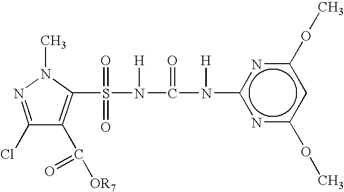

wherein R₇ is hydrogen or is a C₁-C₆ straight or branched alkyl group, preferably is hydrogen, methyl or ethyl but in a particularly preferred embodiment R₇ is hydrogen, and the resultant compound (in an acid form) is sometimes identified as methyl, 3-chloro-5-(4,6-dimethoxypyrimidin-2-ylcarbamoylsulfamoyl)-1-methylpyrazole-4-carboxylic acid; the foregoing compound wherein R₇ is hydrogen also referred to in this specification by its brief tradename “PERMIT” (ex. Gowan Co., Yuma, Ariz.), wherein the use of such sulfonylurea herbicide provides a safening effect or safening benefit to other constituents which may be present in the said herbicide treatment preparations which other constituents may otherwise exhibit an unwanted and/or deleterious effect to fields (e.g., preemergent treatment), seeds, plant parts or crops.

According to a sixth aspect of the invention there are provided methods for improvements in the control of undesired vegetative growth in a crop, particularly wherein the crop is corn (maize) grown from corn seeds or corn plants having glyphosate tolerance, and the undesired vegetative growth is one or more of: Lambsquarter, Velvetleaf, Sesbania (hemp), Morningglory, ragweed, palmer amaranth, cocklebur, sunflower and foxtail which methods comprises the step of applying a herbicidally effective amount of a treatment composition comprising a sulfonylurea herbicide, especially preferably halosulfuron methyl optionally but preferably also with a glyphosate herbicidal compound to the crop, in order to control the said undesired vegetative growth within the crop.

According to a seventh aspect of the invention there are provided methods for the use of a sulfonylurea herbicide, especially preferably halosulfuron methyl as a safener constituent to herbicidal compositions applied to soybeans or soybean plants.

According to an eighth aspect of the invention there are provided methods for the treatment of cotton crops which methods include the application of a sulfonylurea herbicide, especially preferably halosulfuron methyl to a cotton crop, preferably wherein such application occurs prior to planting of the crop.

According to a ninth aspect of the invention there are provided methods for controlling undesired vegetative growth amongst rice plants in a rice crop, which method includes the application of a sulfonylurea herbicide, especially preferably halosulfuron methyl to the rice crop.

According to a tenth aspect of the invention there are provided methods for increasing the harvestable yield of alfalfa, which method comprises the application of a sulfonylurea herbicide, especially preferably halo sulfuron methyl to a dormant alfalfa crop following its final annual cutting, and prior to its reemergence in the spring.

These and other aspects of the invention will become more apparent from the following specification and claims.

Practice of certain aspects of the present invention contemplate the use of herbicide treatment preparations which comprise at least one sulfonylurea herbicide, and may optionally include one or more further herbicides other than the sulfonylurea herbicide, and which may include one or more further constituents, including but not limited to insecticides, acaricides, herbicides, fungicides, safeners, fertilizers, growth regulators, surfactants and/or carriers and the like.

Exemplary potentially useful sulfonylurea herbicides include those according to the following formula and/or their salts:

Rₐ—SO₂—NR_{b}—CO—(NR_{c})ₓ—R_{d}

in which Rₐ is a hydrocarbon radical, preferably an aryl radical such as phenyl, which is unsubstituted or substituted or a heterocyclic radical, preferably a heteroaryl radical such as pyridyl, which is unsubstituted or substituted, and where the radicals including substituents have 1-30 carbon atoms, preferably 1-20 carbon atoms, or Rₐ is an electron-attracting group such as a sulfonamide radical, R_{b} is a hydrogen atom or a hydrocarbon radical which is unsubstituted or substituted and including substituents has 1-10 carbon atoms, for example unsubstituted or substituted C₁-C₆-alkyl, preferably a hydrogen atom or methyl, R_{c} is a hydrogen atom or a hydrocarbon radical which is unsubstituted or substituted and including substituents has 1-10 carbon atoms, for example unsubstituted or substituted C₁-C₆-alkyl, preferably a hydrogen atom or methyl, x equals zero or 1 and R_{d} is a heterocyclic radical. Metal salts thereof include, inter alia, alkali metal salts or alkaline earth metal salts, in particular sodium and potassium salts, or else ammonium salts or salts with organic amines Likewise, salt formation can be effected by addition of an acid onto basic groups, such as, for example, amino and alkylamino. Acids which are suitable for this purpose are strong inorganic and organic acids, for example HCl, HBr, H₂SO₄ or HNO₃.

Further potentially useful sulfonylureas include pyrimidinyl- or triazinylaminocarbonyl[benzene-, pyridine-, pyrazole-, thiophene- and (alkylsulfonyl)alkylamino]sulfamides. Preferred as substituents on the pyrimidine ring or triazine ring are alkoxy, alkyl, haloalkoxy, haloalkyl, halogen or dimethylamino, it being possible for all substituents to be combined independently of one another. Preferred substituents in the benzene-, pyridine-, pyrazole-, thiophene- or (alkylsulfonyl)alkylamino moiety are alkyl, alkoxy, halogen such as F, Cl, Br or I, amino, alkylamino, dialkylamino, acylamino such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Examples of such suitable sulfonylureas are disclosed in detail in U.S. Pat. No. 6,770,594 to Bickers, et al. the contents of which are herein incorporated by reference.

Further exemplary possibly useful sulfonyl urea compounds include herbicidal sulfonylureas of the following formula:

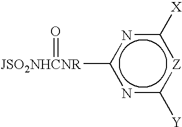

wherein:
R is H or CH₃;
J is selected from

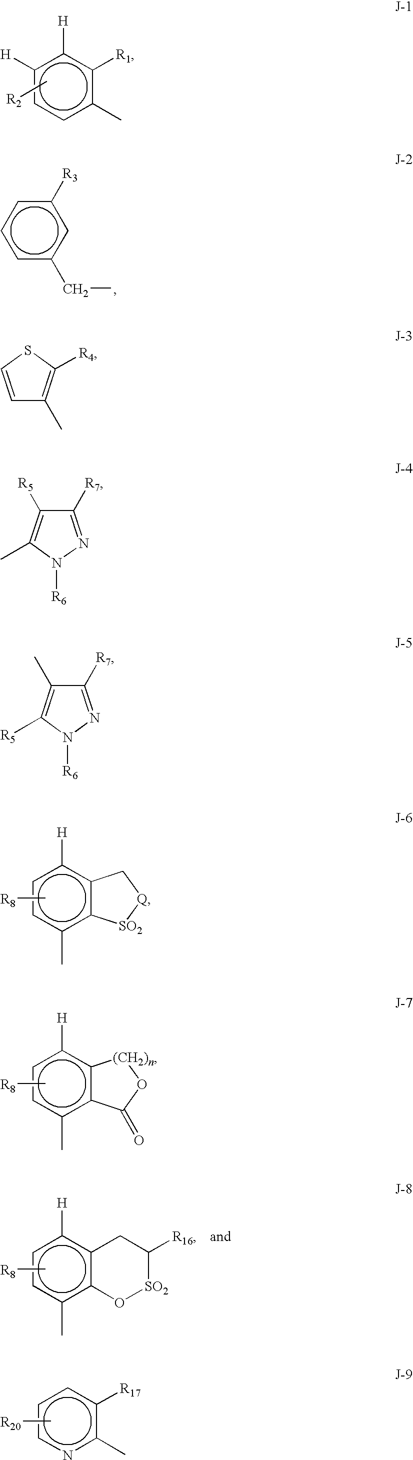

R₁ is Cl, Br, NO₂, C₁-C₄ alkyl, C₂-C₄ alkenyl, CF₃, C₁-C₄ alkoxy, C₁-C₄ haloalkoxy, C₃-C₄ alkenyloxy, C₂-C₄ haloalkenyloxy, C₃-C₄ alkynyloxy, CO₂R₉, CONR₁₀R₁₁, S(O)ₘR₁₂, OSO₂ R₁₂, phenyl, SO₂N(OCH₃)CH₃, SO₂NR₁₀R₁₁,

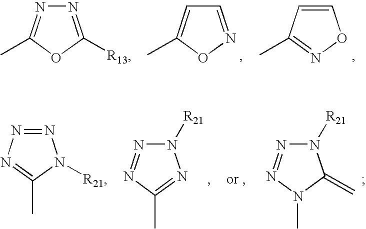

R₂ is H, Cl, Br, F, CH₃, NO₂, SCH₃, OCF₂H, OCH₂CF₃ or OCH₃;
R₃ is Cl, NO₂, CO₂ CH₃, CO₂C₂H₅, SO₂N(CH₃)₂, SO₂CH₃ or SO₂C₂H₅;
R₄ is C₁-C₃ alkyl, Cl, Br, NO₂, CO₂R₉, CON(CH₃)₂, SO₂N(CH₃)₂, SO₂N(OCH₃)CH₃ or S(O)ₘR₁₂;
R₅ is C₁-C₃ alkyl, C₄-C₅cycloalkylcarbonyl, F, Cl, Br, NO₂, CO₂R₁₄, SO₂N(CH₃)₂, SO₂R₁₂ or phenyl;
R₆ is H, C₁-C₃ alkyl or CH₂ CH═CH₂;
R₇ is H, CH₃, OCH₃, Cl or Br;
R₈ is H, F, Cl, Br, CH₃, OCH₃, CF₃, SCH₃ or OCF₂H;
R₉ is C₁-C₄alkyl, C₃-C₄alkenyl or CH₂—CH₂Cl;
R₁₀ is H or C₁-C₃ alkyl;
R₁₁ is H or C₁-C₂ alkyl;
R₁₂ is C₁-C₃ alkyl;
R₁₃ is H or CH₃;
R₁₄ is C₁-C₃ alkyl or CH₂CH═CH₂;
m is 0, 1 or 2;
n is 1 or 2;
Q is CH₂, CHCH₃ or NR₁₅;
R₁₅ is H or C₁-C₄ alkyl;
P is O or CH₂;
R₁₆ is H or CH₃;
R₁₇ is C(O)NR₁₈R₁₉, CF₃, COOCH₃ or SO₂CH₂CH₃;
R₁₈ is H or CH₃;
R₁₉ is CH₃;
R₂₀ is H, Cl, F, Br, CH₃, CF₃, OCH₃ or OCF₂H;
R₂₁ is H or CH₃;
X is CH₃, OCH₃, OC₂ H₅ or NHCH₃;
Y is CH₃, C₂H₅, OCH₃, OC₂H₅, OCF₂H, OCH₂ CF₃, Cl, CH₂OCH₃ or cyclopropyl;
Z is CH or N;
   and their agriculturally suitable salts.

Such potentially suitable sulfonylureas are disclosed in detail in U.S. Pat. No. 5,084,082 to Sebastian the contents of which are herein incorporated by reference.

Preferred as sulfonylurea herbicides are heribicide compounds selected from the class of pyrazole herbicides and particularly pyrimidinylsulfonylurea herbicides.

A specific preferred class of sulfonylurea herbicides include pyrazole herbicides and specifically include those pyrazolecarboxylic acid derivatives represented by the following formula:

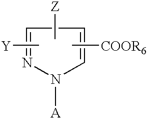

wherein Y and Z each represent a hydrogen atom, a halogen atom, a nitro group, a cyano group, COOR₁, NR₁R₂, CONR₁R₂, SR₁, SO₂NR₁R₂, SO₂R₃, R₃CO, OR₄, CHX₂ or CX₃; A represents a hydrogen atom, an alkyl group having 1 to 4 carbon atoms, a substituted or unsubstituted phenyl group, a substituted or unsubstituted pyridyl group or OR₅; where R₁ and R₂ each represent a hydrogen atom or an alkyl group having 1 to 10 carbon atoms; R₃ represents an alkyl group having 1 to 10 carbon atoms; R₄ represents a hydrogen atom, an alkyl group having 1 to 10 carbon atoms, a substituted or unsubstituted phenyl group, CHF₂, CF₃ or CF₃CH₂; R₅ represents an alkyl group having 1 to 10 carbon atoms; and X represents a halogen atom, and R₆ is hydrogen or is a C₁-C₆ straight or branched alkyl group. These are described more fully in U.S. Pat. No. 5,053,517 to Takigawa, et al., as well as U.S. Pat. No. 5,220,028 to Iwasawa the contents of which are herein incorporated by reference.

Certain particularly preferred sulfonylurea herbicide compounds which have been observed to be useful in accordance with the present invention are halosulfuron-based herbicides, specifically a halosulfuron methyl which may be represented by the structure:

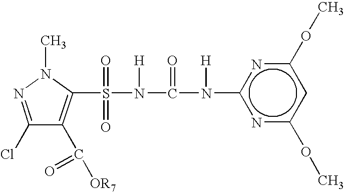

Wherein R₇ is is hydrogen or is a C₁-C₆ straight or branched alkyl group, preferably is hydrogen, methyl or ethyl but in a particularly preferred embodiment R₇ is hydrogen, and the resultant compound (in an acid form) is sometimes identified as methyl, 3-chloro-5-(4,6-dimethoxypyrimidin-2-ylcarbamoylsulfamoyl)-1-methylpyrazole-4-carboxylic acid. The foregoing compound wherein R₇ is hydrogen also referred to in this specification by its brief tradename “PERMIT” (ex. Gowan Co.) which is prominent member of halosulfuron-methyl compounds having herbicidal properties.

Salts or acids of the above halosulfuron-methyl compounds may also be used.

Two or more sulfonylurea herbicide compounds may be present, or a single sulfonylurea herbicide compound may be present. Such sulfonylurea herbicide compounds may also be interchangeably referred to and class as ALS inhibitor herbicidal compounds.

In certain particularly preferred embodiments PERMIT is the sole sulfonylurea herbicide compound present.

An important aspect of the present invention is the unexpected finding that introduction of the glyphosate tolerance to plants resulted in unanticipated tolerance and/or a safening to halosulfuron-methyl based herbicide compounds, specifically to the PERMIT compound as depicted above.

The sulfonylurea herbicide compounds may be present in the sulfonylurea based herbicide treatment preparations in any amount which is found to be herbicidally effective against unwanted vegetative growth, viz., weeds and the like and at the same time to be not unduly detrimental to the crop or soil onto which it is applied. Advantageously the sulfonylurea herbicide compounds, and especially preferably the particularly preferred halosulfuron-methyl compounds having herbicidal properties and most preferably the PERMIT herbicidal compound is/are present in amounts corresponding to of from about 0.01 to about 5 ounces per acre, preferably from about 0.05 to about 5 ounces per acre, and more preferably in amounts of about 0.5 to about 4 ounces per acre. Such amounts are found to be effective on “over the top” application on to soil or soybean plants. It will be appreciated that the actual amount of the sulfonylurea herbicide compounds which may be required in order to achieve a desired herbicidal effect may vary from the above cited amounts as variable factors including (but not limited to): mode of application, frequency of application, the presence of or alternately the absence of a co-herbicide or an insecticide in a sulfonylurea based herbicide treatment preparation. Other factors and variables will be recognized by a skilled artisan. Alternately the amount of the sulfonylurea herbicide compound(s) present in the sulfonylurea based herbicide treatment preparation is generally 0.0001 to 20% by weight, preferably 0.001 to 3% by weight, based on the total weight of the sulfonylurea based herbicide treatment preparation as applied to soil or onto a plant crop.

The sulfonylurea based herbicide treatment preparation may optionally also include one or more herbicides other than sulfonylurea based in the sulfonylurea based herbicide treatment preparations and their methods of use taught herein. It is contemplated that essentially, any other chemical compounds or compounds which are known to provide a herbicidal effect may be used in conjunction with the sulfonylurea herbicide compounds. Such may be provided for example, as preblends or may separately provided and combined as a tank mix by the farmer or grower. By way of non-limiting example such non-sulfonylurea based herbicides include one or more of: carbamates, thiocarbamates, haloacetanilides, substituted phenoxy-, naphthoxy- and phenoxyphenoxycarboxylic acid derivatives, and heteroaryloxyphenoxyalkanecarboxylic acid derivatives such as quinolyloxy-, quinoxalyloxy-, pyridyloxy-, benzoxazolyloxy- and benzothiazolyloxyphenoxyalkanecarboxylic esters, cyclohexanedione derivatives, imidazolinones, phosphorus-containing herbicides, for example of glufosinate type or of the glyphosate type, pyrimidinyloxypyridinecarboxylic acid derivatives, pyrimidyloxybenzoic acid derivatives, triazolopyrimidinesulfonamide derivatives and S-(N-aryl-N-alkylcarbamoylmethyl)dithiophosphoric esters. Preferred in this context are phenoxyphenoxy- and heteroaryloxyphenoxycarboxylic acid esters and salts, imidazolinones and herbicides such as bentazone, cyanazine, atrazine, dicamba or hydroxybenzonitriles such as bromoxynil and ioxynil and other foliar-acting herbicides. Further and more specific examples of herbicides which may be included for use with sulfonylurea herbicide compounds include herbicides from the following groups of compounds (referred to by the “common names” under the reference “The Pesticide Manual” 11th Ed., British Crop Protection Council 1997, abbreviated to “PM”). By way of non-limiting examples these include one or more of:

flumioxazin (PM, pp. 576-577), for example N-(7-fluoro-3,4-dihydro-3-oxo-4-prop-2-inyl-2H-1,4-benzoxazin-6-yl)cyclohex-1-ene-1,2-dicarboxamide,

alachlor (PM, pp. 23-24), for example 2-chloro-N-(2,6-diethylphenyl)-N-(methoxymethyl)acetamide,

metolachlor (PM, pp.833-834), for example 2-chloro-N-(2-ethyl-6-methylphenyl)-N-(2-methoxy-1-methylethyl)acetamide,

acetochlor (PM, pp. 10-12), for example 2-chloro-N-(ethoxymethyl)-N-(2-ethyl-6-methylphenyl)-acetamide,

dimethenamid (PM, pp. 409-410), for example 2-chloro-N-(2,4-dimethyl-3-thienyl)-N-(2-methoxy-1-methylethyl)acetamide,

pethoxamide, for example 2-chloro-N-(2-ethoxyethyl)-N-(2-methyl-1-phenyl-1-propenyl)acetamide,

atrazine (PM, pp. 55-57), for example N-ethyl-N-isopropyl-6-chloro-2,4-diamino-1,3,5-triazine,

simazine (PM, pp. 1106-1108), for example 6-chloro-N,N-diethyl-2,4-diamino-1,3,5-triazine,

cyanazine (PM, pp. 280-283), for example 2-(4-chloro-6-ethylamino-1,3,5-triazin-2-ylamino)-2-methylpropionitrile,

terbuthylazine (PM, pp.1168-1170), for example N-ethyl-N-tert-butyl-6-chloro-2,4-diamino-1,3,5-triazine,

metribuzin (PM, pp. 840-841), for example 4-amino-6-tert-butyl-3-methylthio-1,2,4-triazin-5(4H)-one,

isoxaflutole (PM, pp. 737-739), for example (5-cyclopropyl-4-isoxazolyl)[2-(methylsulfonyl)-4-(trifluoromethyl)phenyl]methanone,

fluthiamid (=flufenacet) (PM, pp. 82-83), for example 4′-fluoro-N-isopropyl-2-(5-trifluoromethyl-1,3,4-thiadiazol-2-yloxy)acetan ilide,

terbutryne (PM, pp.1170-1172), for example N-(1,1-dimethylethyl)-N-ethyl-6-(methylthio)-1,3,5-triazine-2,4-diamine,

pendimethalin (PM, pp. 937-939), for example N-(1-ethylpropyl)-2,6-dinitro-3,4-xylidine,

sulcotrione (PM, pp. 1124-1125), for example 2-(2-chloro-4-mesylbenzoyl)cyclohexane-1,3-dione,

dicamba (PM, pp. 356-357), for example 3,6-dichloro-o-anisic acid and its salts,

mesotrione, for example 2-(4-mesyl-2-nitrobenzoyl)cyclohexane-1,3-dione,

linuron (PM, pp. 751-753), for example 3-(3,4-dichlorophenyl)-1-methoxy-1-methylurea,

benoxacor (PM, pp.102-103), for example (.+−.)-4-dichloroacetyl-3,4-dihydro-3-methyl-2H-1,4-benzoxazine,

metosulam (PM, pp. 836-838), for example 2′,6′-dichloro-5,7-dimethoxy-3′-methyl[1,2,4]triazolo[1,5-a]pyrimidine-2-sulfonamide,

flumetsulam (PM, pp. 573-574), for example 2′,6′-difluoro-5-methyl[1,2,4]triazolo[1,5-a]pyrimidine-2-sulfonamide,

sethoxydim (PM, pp. 1101-1103), for example (.+−.)-(EZ)-(1-ethoxyiminobutyl)-5-[2-ethylthio)propyl]-3-hydroxycyclohex-2-enone,

cycloxydim (PM, pp. 290-291), for example (.+−.)-2-[1-ethoxyimino)butyl]-3-hydroxy-5-thian-3-ylcyclohex-2-enone,

clethodim (PM, pp. 250-251), for example (.+−.)-2-[(E)-1-[(E)-3-chloroallyloxyimino]propyl]-5-[2-(ethylthio)propyl]-3-hydrocyclohex-2-enone,

clefoxidim, for example 2-[1-(2-(4-chlorophenoxy)-propoxyimino)butyl]-3-oxo-5-thion-3-ylcyclohex-1-enol,

aclonifen, in particular also including its salts, such as the sodium salt, (PM, pp. 14-15), for example 2-chloro-6-nitro-3-phenoxyanilin,

MCPA (PM, pp. 770-771), for example (4-chloro-2-methylphenoxy)acetic acid, predominantly employed forms, inter alia, MCPA-butotyl, MCPA-dimethylammonium, MCPA-isoctyl, MCPA-potassium. MCPA-sodium,

2,4-D (PM, pp. 323-327), for example (2,4-dichloro-phenoxy)acetic acid, frequently employed forms: 2,4-D-butotyl, 2,4-D-butyl, 2,4-D-dimethylammonium, 2,4-D-diolamine, 2,4-D-isooctyl, 2,4-D-isopropyl, 2,4-D-trolamine,

bromoxynil (PM, pp. 149-151), for example 3,5-dibromo-4-hydroxybenzonitrile,

bentazone (PM, pp. 1064-1066), for example 3-isopropyl-2,2-dioxo-1H-2,1,3-benzothiadiazine-4(3H)-one,

fluthiacet (PM, pp. 606-608), for example [2-chloro-4-fluoro-5-[5,6,7,8-tetrahydro-3-oxo-1H,3H-1,3,4-thiadiazolo[3,4-a]pyridazine-1-ylideneamino)phenylthio]acetic acid and preferably the methyl ester,

pyridate (PM, pp. 1064-1066), for example O-6-chloro-3-phenylpyridazin-4-yl)S-octyl thiocarbonate,

diflufenzopyr (BAS 65 00 H, PM, pp. 81-82), for example 2-{1-[4-(3,5-difluorophenyl)semicarbazono]ethyl}nicotinic acid,

carfentrazone (PM, pp. 191-193), for example ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate, also applied as, inter alia, carfentrazone-ethyl (as stated) or else as the acid,

clopyralid (PM, pp. 260-263), for example 3,6-dichloropyridin-2-carboxylic acid,

mecoprop, also including mecoprop-p and the esters and salts, (PM, pp. 776-779), for example (RS)-2-(4-chloro-o-tolyloxy)propionic acid,

dichlorprop, also including dichlorprop-p and the esters and salts, (PM, pp. 368-372), for example (RS)-2,4-dichlorophenoxy) propionic acid,

fluroxypyr, (PM, pp. 597-600), for example 4-amino-3,5-dichloro-6-fluoro-2-pyridyloxyacetic acid,

profluazole, for example 1-chloro-N-[2-chloro-4-fluoro-5-[(6S,7aR)-6-fluorotetrahydro-1,3-dioxo-1 H-pyrrolo[1,2-c]imidazol-2(3H)-yl]phenyl]methanesulfonamide,

amicarbazone, for example 4-amino-N-(1,1-dimethylethyl)-4,5-dihydro-3-(1-methylethyl)-5-oxo-1H-1,2,4-triazole-1-carboxamide),

trifloxysulfuron, also including its esters and salts, for example the sodium salt, for example N-[[(4,6-dimethoxy-2-pyrimidinyl)amino]carbonyl]-3-(2,2,2-trifluoroethoxy)-2-pyridinesulfonamide,

glufosinate, (PM, pp. 643-645), for example D,L-2-amino-4-[hydroxy(methyl)phosphinyl]butanoic acid and its salts and esters,

glufosinate-ammonium, (PM, pp. 643-645), for example amonium 4-[hydroxy(methyl)prosphinoyl]-DL-homoalaninate, the monoammonium salt of the acid form,

glyphosate, (PM, pp. 646-649), N-(phosphonomethyl)glycine and its salts and esters,

glyphosate-isopropylammonium, (PM, pp. 646-649), for example N-(phosphonomethyl)glycine,

imazapyr, also including its salts and esters, (PM, pp. 697-699), for example 2-(4-isopropyl-4-methyl-5-oxo-2-imidazol in-2-yl)nicotinic acid,

imazethapyr, also including its salts and esters, (PM, pp. 701-703), (RS)-5-ethyl-2-(4-isopropyl-4-methyl-5-oxo-2-imidazolin-2-yl)nicotinic acid,

imazamethabenz, also including its salts and esters, (PM, pp. 694-696), for example imazamethabenz-methyl, for example methyl (.+−.)-6-(4-isopropyl-4-methyl-5-oxo-2-imidazolin-2-yl)-m-toluate,

imazamox, also including its salts and esters, (PM, pp. 696-697), for example (RS)-2-(4-isopropyl-4-methyl-5-oxo-2-imidazolin-2-yl)-5-methoxymethylnicotinic acid,

imazaquin, also including its salts and esters, for example the ammonium salt (PM, pp. 699-701), for example (RS)-2-(4-isopropyl-4-methyl-5-oxo-2-imidazolin-2-yl)quinolin-3-carboxylic acid,

imazapic (AC 263,222), also including its salts and esters, for example the ammonium salt, (PM, pp. 5 and 6), for example (RS)-2-(4,5-dihydro-4-isopropyl-4-methyl-5-oxoimidazol-2-yl)-5-methylnicot inic acid,

clomazone, also including its salts and esters, for example, 2-[(2-chlorophenyl)methyl]-4,4-dimethyl-3-isoxazolidinone,

pyridazinone, also including its salts and esters, and

triazoles, also including its salts and esters.

Two or more such further optional herbicides may be present, or alternately a single of these optional herbicides may be present.

When present, these one or more optional herbicides may be present in addition to the sulfonylurea based herbicide constituent in the sulfonylurea based herbicide treatment preparations in any amount which is found to be herbicidally effective against unwanted vegetative growth, viz., weeds and the like and at the same time to be not unduly detrimental to the crop or soil onto which it is applied. Advantageously such further herbicide constituents when present may be present in amounts corresponding to of from about 0.01 to about 5 ounces per acre, as variable factors including as will be recognized by a skilled artisan may dictate different amounts as being suitable for application in specific applications. Alternately, when present the amount of any further optional herbicide compounds present in the sulfonylurea based herbicide treatment preparation is generally 0.0001 to 20% by weight, preferably 0.001 to 5% by weight, based on the total weight of the sulfonylurea based herbicide treatment preparation as applied to soil or onto a plant crop.

The sulfonylurea based herbicide treatment preparation may optionally also include one or more pesticides as well. Such are per-se known to the art, and include, for example, those described in The Pesticide Manual, eleventh ed., British Crop Protection Council, 1997. Preferred pesticides for the use with the system according to the present invention are e.g. selected from the group comprising Prosulfuron, Pyridate, Pyriftalid, S-Metolachlor, Simazine, Terbuthylazine, Terbutryn, Triasulfuron, Trifloxysulfuron, Trinexapac-ethyl, Ametryn, Atrazine, Benoxacor, Butafenacil, Chlortoluron, Cinosulfuron, Clodinafop, Cloquintocet, Desmetryn, Dicamba, Dimethachlor, Dimethametryn, DTPA NaFe, EDDHA NaFe, Fenclorim, Flumetralin, Fluometuron, Fluthiacetmethyl, Isoproturon, Metobromuron, Metolachlor, S-Metolachlor, Norflurazon, Oxasulfuron, Piperophos, Pretilachlor, Primisulfuron, Prometryn, Propaquizafop, Acibenzolar-S-methyl, Chlorothalonil, Cyproconazole, Cyprodinil, Difenoconazole, Fenpropidin, Fenpropimorph, Furalaxyl, Metalaxyl, Metalaxyl-M, Oxadixyl, Penconazole, Propiconazole, Pyrifenox, Thiabendazol, Abamectin, Bromopropylate, Cypermethrin, Cypermethrin High-Cis, Cyromazine, Diafenthiuron, Diazinon, Dichlorvos, Disulfoton, Emamectinbenzoate, Fenoxycarb, Formothion, Furathiocarb, Lufenuron, Methidathion, Permethrine, Codlemone, Phosphamidon, Profenofos, Pymetrozine, Quinalphos, Thiamethoxam, Thiocyclam, Thiometon and Trifloxystrobin. While pesticides may be omitted, when present they may be included in any effective amounts. Representative amounts are from about 0.001 to about 99.9% by weight, preferably from about 0.01 to about 99% by weight, based on the total weight of the sulfonylurea based herbicide treatment preparation with which the pesticide is present, or of which the pesticide forms a part.

The sulfonylurea based herbicide treatment preparations may include still further optional constituents which will be recognized as being commonly encountered as useful in herbicidal compositions, particularly largely aqueous herbicidal compositions which are adapted to be applied by conventional spraying methods and machinery. Such include by way of example: surfactants, safeners, oils, conventional adhesives, wetters, dispersants, emulsifiers, preservatives, antifreeze agents, solvents, oils, fillers, colorants, carriers, antifoams, evaporation inhibitors, pH regulators or viscosity regulators.

One such optional constituent are one or more surfactants. Exemplary useful surfactants include those which may be of the ionic and nonionic type, such as aromatic-based surfactants, e.g., surface-active benzenes or phenols which are substituted by one or more alkyl groups and have subsequently been derivatized, or nonaromatic-based surfactants, for example heterocycle-, olefin-, aliphatic- or cycloaliphatic-based surfactants, for example surface-active pyridine, pyrimidine, triazine, pyrrole, pyrrolidine, furan, thiophene, benzoxazole, benzothiazole and triazole compounds which are substituted by one or more alkyl groups and have subsequently been derivatized.

Examples of aromatic surfactants include phenols, phenyl (C₁-C₄)alkyl ethers or (poly)alkoxylated phenols for example those having 1 to 50 alkyleneoxy units in the (poly)alkyleneoxy moiety, where the alkylene moiety has preferably in each case 1 to 4 carbon atoms, preferably phenol which has been reacted with 3 to 10 mol of alkylene oxide, (poly)alkylphenols or (poly)alkylphenol alkoxylates for example those having 1 to 12 carbon atoms per alkyl radical and 1 to 150 alkyleneoxy units in the polyalkyleneoxy moiety, preferably triisobutylphenol or tri-n-butylphenol which has been reacted with 1 to 50 mol of ethylene oxide, polyarylphenols or polyarylphenol alkoxylates, for example tristyrylphenol polyalkylene glycol ethers with 1 to 150 alkyleneoxy units in the polyalkyleneoxy moiety, preferably tristyrylphenol which has been reacted with 1 to 50 mol of ethylene oxide, compounds which formally constitute the reaction products of the foregoing molecules with sulfuric acid or phosphoric acid and their salts which have been neutralized with suitable bases, for example the acid phosphoric ester of the triethoxylated phenol, the acid phosphoric ester of a nonylphenol which has been reacted with 9 mol of ethylene oxide, and the triethanolamine-neutralized phosphoric acid ester of the reaction product of 20 mol of ethylene oxide and 1 mol of tristyrylphenol, and, acid (poly)alkyl- and (poly)arylbenzenesulfonates which have been neutralized with suitable bases, for example having 1 to 12 carbon atoms per alkyl radical, or having up to 3 styrene units in the polyaryl radical, preferably (linear) dodecylbenzenesulfonic acid and its oil-soluble salts such as, for example, the isopropylammonium salt of dodecylbenzenesulfonic acid.

Examples of nonaromatic surfactants are described hereinafter wherein it is to be understood that “EO” represents ethylene oxide units, “PO” represents propylene oxide units and “BO” represents butylene oxide units. Usually, in the case of the alkyleneoxy units, ethyleneoxy, propyleneoxy and butyleneoxy units, in particular ethyleneoxy units, are preferred.

Exemplary nonaromatic surfactants include fatty alcohols having 10-24 carbon atoms with 0-60 EO and/or 0-20 PO and/or 0-15 BO in any desired sequence. The terminal hydroxyl groups of these compounds can be terminally capped by an alkyl, cycloalkyl or acyl radical having 1-24 carbon atoms. Examples of such compounds are commercially available in the Genapol® C,L,O,T,UD,UDD,X (ex. Clariant), Plurafac® and Lutensol® A,AT,ON,TO (ex. BASF), Marlipal®24 and 013 (ex. Condea), Dehypon® (ex. Henkel), series of surfactants, as well as anionic derivatives of the immediately foregoing described nonaromatic surfactants in the form of ether carboxylates, sulfonates, sulfates and phosphates and their inorganic salts (for example alkali metal salts and alkaline earth metal salts) and/or their organic salts (for example on an amine or alkanolamine base) such as are presently commercially available as Genapol® LRO, Sandopan®, and Hostaphat/Hordaphos® series of surfactants (ex. Clariant.) Further exemplarly useful nonaromatic surfactants include copolymers composed of EO,PO and/or BO units such as, for example, block copolymers such as those currently commercially available as Pluronic® (ex. BASF) having a molecular weight of 400 to 10⁸. Further useful nonaromatic surfactants include alkylene oxide adducts of C₁-C₉alcohols such as Atlox® 5000 (ex. Uniquema).

Further useful nonaromatic surfactants include anionic derivatives of certain of the foregoing nonaromatic surfactants in the form of ether carboxylates, sulfonates, sulfates and phosphates and their inorganic salts (for example alkali metal salts and alkaline earth metal salts) and organic salts (for example on an amine or alkanolamine base). Still further useful nonaromatic surfactants include fatty acid and triglyceride alkoxylates, salts of aliphatic, cycloaliphatic and olefinic carboxylic acids and polycarboxylic acids, and alpha-sulfofatty acid esters, fatty acid amide alkoxylates, alkylene oxide adducts of alkyne diols such as are presently commercially available as Surfynol® (ex. Air Products).

Yet further useful nonaromatic surfactants which may be used include sugar derivatives such as amino and amido sugars, glucitols, alkyl polyglycosides such are presently commercially available as APG® (ex. Henkel), sorbitan esters such as are available as Span® or Tween® surfactants (ex. Uniquema), cyclodextrin esters or ethers from (ex. Wacker), surface-active cellulose and algin, pectin and guar derivatives, and guar derivatives.

Still further useful nonaromatic surfactants include alkylene oxide adducts on a polyol base, surface-active polyglycerides, sulfosuccinates, alkanesulfonates, paraffin- and olefinsulfonates, alkylene oxide adducts of fatty amines, surface-active, zwitterionic compounds including as taurides, betaines and sulfobetaines, perfluorinated as well as polyfluorinated surface-active compounds such as are presently commercially available as Fluowet®. (ex. Clariant), or Bayowet® (ex. Bayer), or Zonyl® (ex. DuPont) series of products.

Yet further useful as nonaromatic surfactants are surface-active polyacrylic and methacrylic derivatives such as the Sokalan® (ex. BASF) materials, surface-active polyamides such as modified gelatin or derivatized polyaspartic acid (e.g., ex. Bayer) and their derivatives, surface-active polymers based on maleic anhydride and/or reaction products of maleic anhydride, and copolymers comprising maleic anhydride and/or reaction products of maleic anhydride, surface-active derivatives of polyethylene and polypropylene waxes, surface-active phosphonates and phosphinates such as are presently commercially available as Fluowet®-PL (ex. Clariant) and, poly- or perhalogenated surfactants such as, for example, Emulsogen®-1557 (ex. Clariant).

Further surfactants include silicone based surfactants, viz, those which include at least one silicone atom. Such are per se, known to the art.

When present the one or more surfactants which may be present will be included in the sulfonylurea based herbicide treatment preparations in effective amounts. In general, the total concentration of any surfactants present is advantageously from about 0.001 to about 5% by weight, preferably 0.1 to 2.0% by weight, in particular 0.1 to 0.5% by weight, based on the total weight of the sulfonylurea based herbicide treatment preparation of which it forms a part.

One or more safeners may be included in the sulfonylurea based herbicide treatment preparations in effective amounts. Various classes of chemical compounds are known to the art as effective safeners, non-limiting examples of which include: a) compounds of the dichlorophenylpyrazolin-3-carboxylic acid type, preferably compounds such as ethyl 1-(2,4-dichlorophenyl)-5-(ethoxycarbonyl)-5-methyl-2-pyrazoline-3-carboxylate; b) dichlorophenylpyrazolecarboxylic acid derivatives, preferably compounds such as ethyl 1-(2,4-dichlorophenyl)-5-methylpyrazole-3-carboxylate, ethyl 1-(2,4-dichlorophenyl)-5-isopropylpyrazole-3-carboxylate, ethyl 1-(2,4-dichlorophenyl)-5-(1,1-dimethylethyl)pyrazole-3-carboxylate, ethyl 1-(2,4-dichlorophenyl)-5-phenylpyrazole-3-carboxylate and related compounds; compounds of the triazolecarboxylic acids type, preferably compounds such as ethyl 1-(2,4-dichlorophenyl)-5-trichloromethyl-(1H)-1,2,4-triazole-3-carboxylate and related compounds; compounds of the dichlorobenzyl-2-isoxazoline-3-carboxylic acid type, compounds of the 5-benzyl- or 5-phenyl-2-isoxazoline-3-carboxylic acid type, preferably compounds such as ethyl 5-(2,4-dichlorobenzyl)-2-isoxazoline-3-carboxylate or ethyl 5-phenyl-2-isoxazoline-3-carboxylate and related compounds; e) compounds of the 8-quinolinoxyacetic acid type, preferably compounds such as 1-methylhex-1-yl-(5-chloro-8-quinolinoxy)acetate, 1,3-dimethylbut-1-yl-(5-chloro-8-quinolinoxy)acetate, 4-allyloxy-(5-chloro-8-quinolinoxy)acetate, 1-allyloxy-prop-2-yl-(5-chloro-8-quinolinoxy)acetate, ethyl-(5-chloro-8-quinolinoxy)acetate, methyl-(5-chloro-8-quinolinoxy)acetate, allyl-(5-chloro-8-quinolinoxy)acetate, 2-(2-propylideneiminoxy)-1-ethyl-(5-chloro-8-quinolinoxy)acetate, 2-oxoprop-1-yl-(5-chloro-8-quinolinoxy)acetate and related compounds; f) compounds of the (5-chloro-8-quinolinoxy)malonic acid type, preferably compounds such as diethyl-(5-chloro-8-quinolinoxy)malonate, diallyl-(5-chloro-8-quinolinoxy)malonate, methyl ethyl-(5-chloro-8-quinolinoxy)malonate and related compounds; g) active substances of the type of the phenoxyacetic acid derivatives or phenoxypropionic acid derivatives or of the aromatic carboxylic acids such as, for example, 2,4-dichlorophenoxyacetic acid (and esters), 4-chloro-2-methylphenoxypropionic acid (mecoprop), MCPA or 3,6-dichloro-2-methoxybenzoic acid (and esters) (dicamba); h) compounds of the 5,5-diphenyl-2-isoxaoline-3-carboxylic acid type, preferably ethyl 5,5-diphenyl-2-isoxazoline-3-carboxylate (isoxadifen-ethyl); i) compounds which are known as safeners, for example for rice, such as fenclorim (=4,6-dichloro-2-phenylpyrimidine), dimepiperate (═S-1-methyl-1-phenylethyl piperidine-1-thiocarboxylate), daimuron (=1-(1-methyl-1-phenylethyl)-3-p-tolylurea,), cumyluron (=3-(2-chlorophenylmethyl)-1-(1-methyl-1-phenylethyl) urea), methoxyphenone (=3,3′-dimethyl-4-methoxybenzophenone, as well as CSB (=1-bromo-4-(chloromethylsulfonyl)benzene, CAS-Reg. No. 54091-06-4).

When present the one or more safeners which may be present will be included in the sulfonylurea based herbicide treatment preparations in effective amounts. In general, the total concentration of any surfactants present is advantageously from about 0.001 to about 5% by weight, preferably 0.1 to 4% by weight, in particular 0.1 to 3% by weight, based on the total weight of the sulfonylurea based herbicide treatment preparation of which it forms a part.

The foregoing safeners may beneficially reduce or prevent phytotoxic effects which may be observed when the sulfonylurea based herbicide treatment preparation according to the invention are employed in crops of useful plants, without adversely affecting the efficacy of the herbicides against harmful plants. This makes it possible considerably to widen the spectrum of application of the sulfonylurea based herbicide treatment preparation according to the invention; in particular, the use of safeners makes possible the application of sulfonylurea based herbicide treatment preparation which could previously only be employed to a limited extent or with insufficient success, i.e. of combinations which, at low dosages with a poor spectrum of action, led to insufficient control of the harmful plants without safener. Depending on their properties, when present and/or when used, one or more of the foregoing safeners can be used for pretreating the seed of the crop plant (seed dressing) or introduced into the seed furrows prior to sowing or applied together with the sulfonylurea based herbicide treatment preparation before or after emergence of the plants. Pre-emergence treatment includes both the treatment of the area under cultivation before sowing and the treatment of the areas under cultivation where seed has been sown, but growth is as yet not present. The joint application with the sulfonylurea based herbicide treatment preparation is preferred. Tank mixes or ready mixes can be employed for this purpose.

The application rates of the safeners, can vary within wide limits, but in general, the total concentration of any safener present is advantageously from about 0.001 to about 8% by weight, preferably 0.1 to 4.0% by weight, in particular 0.1 to 0.5% by weight, based on the total weight of the sulfonylurea based herbicide treatment preparation with which the safener is used, or of which the safener forms a part.

The sulfonylurea based herbicide treatment preparations may include one or more oils in effective amounts.

The herbicidal activity can also be increased by using vegetable oils. The term vegetable oils is to be understood as meaning oils from oil-plant species, such as soya oil, rapeseed oil, corn oil, sunflower oil, cottonseed oil, linseed oil, coconut oil, palm oil, safflower oil or castor oil, in particular soybean oil, castor oil, rapeseed oil, and their transesterification products, for example alkyl esters, such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular those with an even number of carbon atoms, for example erucic acid, lauric acid, palmitic acid and, in particular, C₁₈-fatty acids such as stearic acid, oleic acid, linoleic acid or linolenic acid. Specific examples of C₁₀-C₂₂-fatty acid esters are esters obtained by reacting glycerol or glycol with the C₁₀-C₂₂-fatty acids as they exist, for example, in oils from oil-plant species, or C₁-C₂₀-alkyl-C₁₀-C₂₂-fatty acid esters as can be obtained, for example, by transesterification of the abovementioned glycerol- or glycol-C₁₀-C₂₂-fatty acid esters with C₁-C₂₀-alcohols (for example methanol, ethanol, propanol or butanol). Preferred C₁-C₂₀-alkyl-C₁₀-C₂₂-fatty acid esters are the methyl, ethyl, propyl, butyl, 2-ethylhexyl and dodecyl esters. Preferred glycol- and glycerol-C₁₀-C₂₂-fatty acid esters are the uniform or mixed glycol esters and glycerol esters of C₁₀-C₂₂-fatty acids, in particular of those fatty acids which have an even number of carbon atoms, for example erucic acid, lauric acid, palmitic acid and, in particular, C₁₈-fatty acids such as stearic acid, oleic acid, linolic acid or linolenic acid.

The application rates for one or more oils, when present as part of sulfonylurea based herbicide treatment preparations, may vary widely but in general are advantageously from about 0.001 to about 50% by weight, preferably 0.01-40% by weight, based on the total weight of the sulfonylurea based herbicide treatment preparation of which one or more such oils form a part.

The sulfonylurea based herbicide treatment preparations may include one or more non-aqueous solvents in effective amounts. Representative solvents include: aromatic hydrocarbons, preferably the fractions containing 8 to 12 carbon atoms such as mixtures of alkylbenzenes, typically xylene mixtures or alkylated naphthalenes; aliphatic and cycloaliphatic hydrocarbons such as paraffins, cyclohexane or tetrahydronaphthalene; alcohols such as ethanol, propanol or butanol; glycols and their ethers and esters such as propylene glycol or dipropylene glycol ether; ketones such as cyclohexanone, isophorone or diacetone alcohol; strongly polar solvents such as N-methyl-2-pyrrolidone, dimethyl sulfoxide, and in some cases also silicone oils. While such non-aqueous solvents may be omitted, when present they may be included in any effective amounts. Representative amounts are from about 0.001 to about 95% by weight, preferably from about 5% to about 90% by weight, based on the total weight of the sulfonylurea based herbicide treatment preparation with which the non-aqueous solvent is present, or of which the non-aqueous solvent forms a part.

The sulfonylurea based herbicide treatment preparations may include solid carriers in effective amounts. Non-limiting examples of suitable carriers include materials known to the relevant art and are solid carriers typically used for dusts and dispersible powders are usually natural mineral fillers such as calcite, talcum, kaolin, montmorillonite or attapulgite. To improve the physical properties it is also possible to add highly dispersed silicic acid or highly dispersed absorbent polymers. Suitable granulated adsorptive carriers are porous types, including pumice, broken brick, sepiolite or bentonite; and suitable nonsorbent carriers are materials such as calcite or sand. In addition, innumerable pregranulated materials of inorganic or organic origin may be used, especially dolomite or pulverised plant residues. When present, such solid carriers may be included in any effective amounts. Representative amounts are from about 0.001 to about 95% by weight, preferably from about 5 to about 90% by weight, based on the total weight of the sulfonylurea based herbicide treatment preparation with which the solid carriers is present, or of which the solid carriers forms a part.

In certain products formats of the sulfonylurea based herbicide treatment preparation, a major amount of water may be added to the forgoing constituents present in the sulfonylurea based herbicide treatment preparations in order to form a tank mix or working solution or dispersion of the said forgoing constituents which in such a form is particularly adapted to be delivered by spraying. Water may be used as a carrier or a solvent for one or more of the constituents present in a sulfonylurea based herbicide treatment preparation, or may be both a solvent and carrier.

The sulfonylurea based herbicide treatment preparations can exist not only as at least one sulfonylurea herbicide which may be provided without any further constituents or components, but usually may further include one or more agrochemically active constituents, additives and/or customary formulation auxiliaries, which are then applied in the customary manner as a dilution with water, but also as so-called tank mixes by jointly diluting the separately formulated, or partially separately formulated, components with water.

The sulfonylurea based herbicide treatment preparations can be formulated in various ways, depending on the prevailing biological and/or chemical-physical parameters. The following are examples of general possibilities for formulations: wettable powders (WP), water-soluble concentrates, emulsifiable concentrates (EC), aqueous solutions (SL), emulsions (EW) such as oil-in-water and water-in-oil emulsions, sprayable solutions or emulsions, suspension concentrates (SC), oil- or water-based dispersions, suspoemulsions, dusts (DP), seed-dressing materials, granules for soil application or for broadcasting, or water-dispersible granules (WG), ULV formulations, microcapsules or waxes.

Advantageously, the sulfonylurea based herbicide treatment preparations may be combinations with further constituents, e.g., other pesticidally active substances, such as other herbicides, fungicides or insecticides, and with safeners, fertilizers and/or growth regulators, may also be prepared, for example in the form of a readymix or a tank mix.

Wettable powders (sprayable powders) are products which are uniformly dispersible in water and which, in addition to the sulfonylurea based herbicide and any other optional constituents, frequently also comprise ionic or nonionic surfactants (wetters, dispersants), for example polyoxethylated alkylphenols, polyethoxylated fatty alcohols or fatty amines, alkanesulfonates or alkylbenzenesulfonates, sodium lignosulfonate, sodium 2,2′-dinaphthylmethane-6,6′-disulfonate, sodium dibutyinaphthalenesulfonate or else sodium oleoylmethyltauride, in addition to a diluent or inert material.

Emulsifiable concentrates are prepared by dissolving the sulfonylurea based herbicide in an organic solvent, for example butanol, cyclohexanone, dimethylformamide, xylene or else higher-boiling aromatics or hydrocarbons with addition of one or more ionic or nonionic surfactants (emulsifiers). Examples of emulsifiers which may be used are: calcium salts of alkylarylsulfonic acids, such as calcium dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Typically, dusts are obtained by grinding the sulfonylurea based herbicide with finely divided solid materials, for example talc, natural clays such as kaolin, bentonite and pyrophyllite, or diatomaceous earth.

Suspension concentrates (SC) can be water- or oil-based. They can be prepared, for example, by wet grinding by means of commercially available bead mills and, if appropriate, addition of further surfactants as they have already been mentioned for example above in the case of the other formulation types.

Emulsions, for example oil-in-water emulsions (EW), can be prepared for example by means of stirrers, colloid mills and/or static mixers using aqueous organic solvents and, if appropriate, further surfactants as have already been mentioned for example above in the case of the other formulation types.

Granules can be prepared either by spraying the sulfonylurea based herbicide and any further optional constituents (where appropriate) onto adsorptive, granulated inert material or by applying sulfonylurea based herbicide and any further optional constituents (where appropriate) to the surface of carriers such as sand, kaolites or granulated inert material with the aid of binders, for example polyvinyl alcohol, sodium polyacrylate or else mineral oils. Granulation may occur in the manner conventionally used for the production of fertilizer granules, if desired in a mixture with fertilizers. As a rule, water-dispersible granules are prepared by conventional processes such as spray drying, fluidized-bed granulation, disk granulation, mixing with high-speed mixers and extrusion without solid inert material, according to techniques known to the art.

As a rule, the sulfonylurea based herbicide treatment preparations comprise 0.01 to 99 percent by weight, in particular 0.1 to 95% by weight, of sulfonylurea based herbicide, the following concentrations being customary, depending on the type of formulation: The concentration of the sulfonylurea based herbicide in wettable powders is, for example, approximately 10 to 95% by weight, the remainder to 100% by weight being composed of customary formulation constituents. In the case of emulsifiable concentrates, the concentration of sulfonylurea based herbicide may amount to, for example, 1 to 80% by weight. Sulfonylurea based herbicide treatment preparations in the form of dusts comprise, in most cases, 1 to 30% by weight of sulfonylurea based herbicide, while preparations in the form of sprayable solutions typically comprise approximately 0.01 to 25% by weight of sulfonylurea based herbicide.

In the case of granules such as dispersible granules, the active ingredient content, viz, the sulfonylurea based herbicide and any other optional herbicides, pesticides depends partly on whether the sulfonylurea based herbicide and any other optional herbicides, pesticides is present in liquid or solid form and on which granulation auxiliaries and fillers are being used. As a rule, the content amounts to between 10 and 90% by weight in the case of the water-dispersible granules.

Preferred formulations include the following compositions (throughout, percentages are by weight):

### Emulsifiable Concentrates:

sulfonylurea based herbicide: 1 to 90% wt., preferably 5 to 20% wt.

surfactant(s): 1 to 30% wt., preferably 10 to 20% wt.

liquid carrier: 5 to 94% wt., preferably 70 to 85% wt.

optional constituents: 0 to 35% wt.

### Dusts:

sulfonylurea based herbicide: 0.1 to 10% wt., preferably 0.1 to 5% wt.

solid carrier 5 to 95% wt., preferably 15 to 90% wt.

optional constituents: 0 to 35% wt.

### Suspension Concentrates:

sulfonylurea based herbicide: 5 to 75% wt., preferably 10 to 50% wt.

oil and/or water: 94 to 24% wt., preferably 88 to 30% wt.

surfactant(s): 1 to 40% wt., preferably 2 to 30% wt.

optional constituents; 0 to 35% wt.

### Wettable Powders:

sulfonylurea based herbicide: 0.5 to 90% wt., preferably 1 to 80% wt.

surface-active agent: 0.5 to 20% wt., preferably 1 to 15% wt.

solid carrier: 5 to 95% wt., preferably 15 to 90% wt.

optional constituents: 0 to 35% wt.

### Granules:

sulfonylurea based herbicide: 0.1 to 30% wt., preferably 0.1 to 15% wt.

solid carrier: 70 to 99.5% wt., preferably 85 to 97% wt.

optional constituents: 0 to 35% wt.

A particularly preferred product form of the sulfonylurea based herbicide treatment preparations are water dispersible granules. Such offer good product stability, relatively easy handling and when necessary measuring, and ready dispersability into a liquid carrier, e.g., water. For use, the sulfonylurea based herbicide treatment preparations, and where applicable the co-herbicide treatment preparation, are optionally diluted in the customary manner, for example using water in the case of wettable powders, emulsifiable concentrates, dispersions and water-dispersible granules. Sulfonylurea based herbicide treatment preparations and where applicable the co-herbicide treatment preparation, in the form of dusts, soil granules, granules for broadcasting and sprayable solutions are usually not diluted further with other inert substances prior to use.

The sulfonylurea based herbicide treatment preparations can be applied to the plants, parts of the plants, seeds of the plants or the area under cultivation (soil of a field), preferably to the green plants and parts of the plants and, if appropriate, additionally to the soil of the field. One possible use is the joint application of the active ingredients in the form of tank mixes, the concentrated formulations of the individual active ingredients, in optimal formulations, jointly being mixed with water in the tank and the resulting spray mixture being applied.

Sprayable forms of sulfonylurea based herbicide treatment preparations can be prepared from the liquid concentrate by diluting a liquid concentrate containing at least the sulfonylurea based herbicide in an appropriate volume of water and agitating as needed. The resulting sprayable composition can then be applied, for example by spraying, to any unwanted vegetation to be killed or controlled. Sprayable forms of sulfonylurea based herbicide treatment preparations can be prepared from particulate solids by dissolving or dispersing the particulate solids in an appropriate volume of water, agitating as needed, and applying to unwanted vegetation. Once prepared, such should be used within 24 to 48 hours following preparation, depending upon various conditions.

Advantageously, such sprayable forms of sulfonylurea based herbicide treatment preparations applied as aqueous solutions or dispersions, whether they result from the further dilution of the liquid concentrate or the addition of water to the particulate solid concentrate. The term “aqueous” as used herein is not intended to exclude the presence of some small amount of nonaqueous solvent, so long as the predominant solvent present, other than the glycol or glycol ester component of the surfactant composition, is water. Said sprayable compositions included in the present invention can be applied to the foliage of the plants to be treated through any of the appropriate methods that are well known to those having skill in the art.

The sulfonylurea based herbicide treatment preparations provide herbicidal effectiveness is one of the biological effects that can be enhanced through this invention. “Herbicidal effectiveness,” as used herein, refers to any observable measure of control of plant growth, which can include one or more of the actions of (1) killing, (2) inhibiting growth, reproduction or proliferation, and (3) removing, destroying, or otherwise diminishing the occurrence and activity of plants. The herbicidal effectiveness data set forth herein report “control” as a percentage following a standard procedure in the art which reflects a visual assessment of plant mortality and growth reduction by comparison with untreated plants, made by technicians specially trained to make and record such observations.

The selection of application rates that are biologically effective for the sulfonylurea based herbicide treatment preparations taught herein is within the skill of the ordinary agricultural scientist. Those of skill in the art will likewise recognize that individual plant conditions, weather and growing conditions, as well as the specific sulfonylurea based herbicide treatment preparation selected for use, will affect the efficacy achieved in practicing this invention. Useful application rates for sulfonylurea based herbicide treatment preparations can depend upon all of the above conditions. In general, the sulfonylurea based herbicide treatment preparations of the present invention is applied to plants at a rate sufficient to give the desired biological effects: control of plant growth and/or visual symptoms of treatment. The amount of the sulfonylurea based herbicide treatment preparations applied to plants in combination generally provides a herbicidally-effective amount of at least the sulfonylurea based herbicide. These application rates are usually expressed as amount of sulfonylurea based herbicide per unit area treated, e.g. grams per hectare (g/ha). What constitutes a “desired effect” varies according to the standards and practice of those who investigate, develop, market and use herbicidal compositions and/or other plant treatment compositions. Typically, the amount of an effective herbicidal composition, e.g., the sulfonylurea based herbicide treatment preparation, applied per unit area of to give at least 85% control of a plant species as measured by growth reduction or mortality is often used to define a commercially effective rate for the herbicidal composition. Early visual symptoms of treatment generally should appear no later than seven days after treatment, preferably no later than four days after treatment, more preferably no later than three days after treatment.

The invention therefore also relates to a method of controlling undesired-vegetation (e.g. harmful plants), preferably in plant crops such as cereals (e.g. wheat, barley, rye, oats, hybrids thereof, such as triticale, rice, corn, maize, sorghum), sugar beet, sugar cane, oilseed rape, cotton and soya beans, preferably in corn (maize), soybeans, rice as well as cotton, which comprises applying, together or separately, for example pre-emergence, post-emergence or pre- and post-emergence, the sulfonylurea based herbicide treatment preparations, especially wherein the sulfonylurea based herbicide treatment preparations are halosulfuron methyl to the plants, e.g. the harmful plants, parts of these plants, seeds of these plants, or the area on which the plants grow, for example the area under cultivation.

Examples of such undesired vegetation, also referred to as undesired vegetative growth, include American beauty berry flower; American holly; angelica, purple-stemmed; annual sowthistle; aster; barnyardgrass; beggarsticks, (aka bur-marigold, sticktight); bergamot (horse-mint); big bluestem; bigroot morningglory (aka wild sweet potato); birdsfoot trefoil; bitter nightshade; black henbane; black (honey) locust (aka coffee bean tree); black medic; black nightshade; blackgrass; blue vervain; bouncingbet, (aka soapwort); brackenfern western (aka fiddlehead); bristly foxtail (aka bur bristlegrass); broadleaf dock; broadleaf plantain; browneyed susan(aka black-eyed susan); broomrape; crenate (aka scalloped broomrape); Egyptian broomrape; buckwheat; bull thistle; bur cucumber; burdock; buttercup; Canada thistle; cardinal flower (aka scarlet lobelia); carpetweed; castorbean; catchweed bedstraw; catnip; cattail; cheat; chickweed, common; chickweed, mouseear; chicory; Chinese lantern; chokecherry; cinquefoil; clammy; coundcherry; climbing milkweed, (aka honeyvine milkweed); cogongrass; common buttercup; common cocklebur; common lambsquarters; common mallow, (aka wild geranium, roundleaf mallow); common milkweed; common mullien (aka candelwick); common ragweed; common yarrow; compass plant; coneflower (purple); corn cockle; corn row; cornflower; cow cockle; creeping charlie; cupplant; curly dock (aka sour dock); cutleaf coneflower; daisy fleabane; dandelion; dodder, field (aka foddergrass); downy brome, (aka cheatgrass); eastern black shade; English ivy; evening primrose; fall panicum; fescue; field bindweed, (aka wild morningglory); field pennycress; flixweed; foxglove; foxtail barley; giant foxtail; giant green foxtail; giant ragweed, (aka horseweed); goatsbeard, (aka western salsify); goldenrod; goosegrass; goutweed; grain amaranth; ground cherry; ground ivy; hairy crabgrass; hedge bindweed; hemp, (aka marijuana); hemp dogbane, (aka Indian hemp); hemp sesbania (aka indigoweed); henbit; honeyvine milkweed, (aka climbing milkweed); hophornbeam copperleaf; horsenettle; horseweed (marestail); hyacinth; Indiangrass; ivy; ivyleaf morningglory; Jerusalem artichoke; jimsonweed; johnsongrass; knapweed; knotweed; kochia; ladysthumb smartweed; lambsquarter; longspine sandbur; maximillian sunflower; meadow foxtail; meadow salsify; morningglory; motherwort; mowed hay; musk thistle; narzissus; nettle; Ohio buckeye; orchardgrass; oxalis; palouse tarweed; Pennslyvania s martweed; Pennycress; perennial sowthistle; philodendron; phlox; pigweed; pineappleweed; poison hemlock; poison ivy; pokeweed, common; poppy; prairie bush clover; prairie dock; prickly lettuce; prickly sida; prostrate spurge; purple coneflower; purple loosestrife; purslane; purslane speedwell; quackgrass; Queen Anne's lace; rattlebox; rattlesnake brome; red clover; redroot pigweed; redstem filaree; redtop; reed canarygrass; rough fleabane; roundleaf mallow; rush; Russian knapweed; salsify; scouring-rush, common; Scotch thistle; senicio; shattercane/wild cane; shepherdspurse; small whorled pogonia; smallflower buttercup; smartweed, light (or pale); smartweed, swamp; smooth bromegrass; smooth crabgrass; smooth groundcherry; sorghum almum; sowthistle; spiny amaranth; splitleaf philodendron; spotted knapweed; squirreltail; star of Bethlehem; stinging nettle; switchgrass; tall/ivyleaf morningglory; tall morningglory, tall waterhemp; tansy mustard, (aka pinole); thistles; tickseed coreopsis; Timothy trumpet creeper; velvetleaf, (aka elephant ear, butterprint); Venice mallow, (aka flower-of-an-hour); vetch; Virginia creeper; Virginia pepperweed; volunteer corn; zea mays; water hemlock; water-lilly; waterpod; white bryony on hawthorn; white clover; white snakeroot; white sweetclover; whorled milkweed; whorled tickseed; wild buckwheat; wild 4 o'clock; wild garlic; wild grape; wild mustard; wild onion; wild parsnip; wild proso millet; wild salsify; wild sunflower; wild sweet potato, (aka bigroot morningglory); wild violets; wirestem muhley; witchgrass; wood sorrel; woodland sunflower; woolly cupgrass; yarrow; yellow clover; yellow foxtail; yellow nutsedge, (aka chufa); yellow rocket; yew; yucca; and yellow nutsedge.

The plant crops treatable with the sulfonylurea based herbicide treatment preparations can also have been genetically modified or been obtained by mutation/selection and are preferably tolerant to glyphosates, e.g. Roundup®.

The rate of application of the sulfonylurea based herbicide treatment preparations may vary within wide limits and depends on the nature of the soil, the type of use (pre- or post-emergence; seed dressing; application to the seed furrow; no tillage application etc.), the crop plant, the weed to be controlled, the prevailing climatic conditions, and other factors determined by the type of use, time of use and target crop. Generally, the sulfonylurea based herbicide treatment preparations according to the invention can be applied at a rate of application of from 0.1 to 5000 grams of the sulfonylurea based herbicide present in a treatment preparation per hectare.

The following examples below illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### EXAMPLES

### Study I:

Controlled greenhouse laboratory studies were undertaken to evaluate the relative effect of the application of a halosulfuron methyl herbicide, at various application rates and timings onto a series of commercially available soybean seed varieties certain of which are marketed by their respective suppliers to exhibit specific traits, including: “RR”, or “Roundup® Ready” and hence tolerant specifically to the class of glyphosate based herbicides as commercially available under the tradename Roundup® (ex. Monsanto Corp., St. Louis, Mo.), and/or be additionally “STS” resistant, hence additionally specifically tolerant to sulfonyl urea based herbicides, wherein soybean seeds of such combined tolerance are indicated to be “STS/RR” types. One soybean variety, “UA 485” was used which variety was not marketed as being either STS and/or RR types, and its trait is indicated as “none”.

Three separate test series were performed on separate series of soybeans in order to evaluate the effect of the application of two different concentrations of a halosulfuron methyl herbicide, commercially available as “PERMIT” applied either pre-planting, pre-emergence, or post emergence onto the soybean seedlings. Three identical but separate series of soybeans were used in the test. These tests were conducted independently, and not in a series such that the specific effect of the application of the halosulfuron methyl herbicide could be established. Additionally, for each variety of soybean tested a “control” sample of the particular soybean was also present but which control sample was not treated with any herbicide composition. Such was provided as a comparative sample with respect to the same varieties of soybean which were however treated by the halosulfuron methyl herbicide. For each variety of soybean tested the halosulfuron methyl herbicide was applied at a rate of either a 1 ounce per acre, or 2 ounces per acre.

The specific soybean varieties, there indicated traits and their suppliers are identified in the following Table 1:

TABLE 1

| Seed Variety | | |
|---|---|---|
| No. | Soybean Variety | Trait: |
| 1 | Dairyland DL1701 | RR/STS |
| 2 | Dairyland DL2000 | RR/STS |
| 3 | Asgrow AG2204 | RR/STS |
| 4 | Dairyland DL2702 | RR/STS |
| 5 | Dairyland DL3003 | RR/STS |
| 6 | DPL 4112 | RR/STS |
| 7 | Asgrow AG4403 | RR |
| 8 | Asgrow AG4404 | RR/STS |
| 9 | Schillinger 457RC | RR |
| 10 | DPL 4546 | RR |
| 11 | Armor 47-G7 | RR |
| 12 | Asgrow AG4703 | RR |
| 13 | Pioneer 94B73 | RR |
| 14 | Armor 47-F8 | RR/STS |
| 15 | Pioneer 94M80 | RR |
| 16 | UA 485 | -- none -- |
| 17 | DPL 4888 | RR/STS |
| 18 | Asgrow AG4903 | RR/STS |
| 19 | DPL 4919 | RR/STS |
| 20 | HBK 4924 | RR |
| 21 | Armor 49-T3 | RR/STS |
| 22 | Schillinger 495RC | RR |
| 23 | DPL 5115 | RR/STS |
| 24 | Pioneer 95M30 | RR |
| 25 | DPL 5335 | RR/STS |
| 26 | Armor 54-03 | RR/STS |
| 27 | Stine 5482 | RR/STS |
| 28 | Pioneer 95M50 | RR/STS |
| 29 | Asgrow AG5605 | RR/STS |
| 30 | DPL 5634 | RR |

The results of the separate tests of the application of the halosulfuron methyl herbicide at the following stages: (I) pre-planting, (II) pre-emergence, or (III) post emergence indicated in the respective Table 2, Table 3 and Table 4 below. In the following table, “DAP” indicates “days after planting”, the application rate of the herbicide “PERMIT” is indicated in ounces/acre, and the untreated “control” samples are indicated as being “UTC” or “untreated crop”. In the following tables the “% injury phyto” was evaluated at 14 days after planting and was based on visual observation and assessment. Similarly the “V-stage” assessment was based on visual observation and assessment of the plants 42 days after planting and were scaled from 0 to 5, with example ratings of “0.5” for plants in the cotyledon stage “1” for the V1 stage, “2” for the V2 stage, “3” for the V3 stage, “4” for the V4 stage and “5” for the V5 stage.

TABLE 2
Pre-Planting Application of Herbicide:

| | | | | Herbicide | | | | | | |
|---|---|---|---|---|---|---|---|---|---|---|
| Seed | | | | (PERMIT) | % Injury | % | Height | V-stage | Top Weight | Root Weight |
| Variety | | | | application | Phyto | Germination | (cm) | (0-5 scale) | (grams) | (grams) |
| No. | Source | Variety | Trait | (oz) | 14 DAP | 21 DAP | 42 DAP | 42 DAP | 42 DAP | 42 DAP |
| 1 | Dairyland | DL1701 | RR/STS | 1 | 0 | 75 | 14.4 | 1.5 | 0.76 | 0.20 |
| | | | | 2 | 0 | 100 | 15.8 | 2.3 | 2.8 | 1.2 |
| | | | | UTC | 0 | 58 | 13.4 | 1.3 | 1.7 | 1.0 |
| 2 | Dairyland | DL2000 | RR/STS | 1 | 0 | 100 | 12.3 | 1.0 | 1.6 | 0.1 |
| | | | | 2 | 0 | 83 | 10.8 | 1.0 | 1.7 | 0.7 |
| | | | | UTC | 0 | 83 | 12.4 | 0.9 | 1.3 | 0.6 |
| 3 | Asgrow | AG2204 | RR/STS | 1 | 0 | 92 | 19.4 | 2.3 | 1.6 | 0.4 |
| | | | | 2 | 0 | 92 | 18.5 | 2.3 | 3.6 | 1.4 |
| | | | | UTC | 0 | 100 | 18.6 | 2.5 | 3.6 | 2.6 |
| 4 | Dairyland | DL2702 | RR/STS | 1 | 0 | 83 | 16.3 | 1.8 | 1.1 | 0.2 |
| | | | | 2 | 0 | 83 | 17.1 | 2.3 | 3.7 | 1.4 |
| | | | | UTC | 0 | 92 | 16.2 | 1.8 | 2.6 | 1.0 |
| 5 | Dairyland | DL3003 | RR/STS | 1 | 0 | 92 | 18.1 | 1.8 | 1.2 | 0.3 |
| | | | | 2 | 0 | 41 | 12.5 | 2.0 | 2.2 | 0.9 |
| | | | | UTC | 0 | 67 | 18.3 | 2.3 | 3.2 | 2.2 |
| 6 | DPL | 4112 | RR/STS | 1 | 0 | 92 | 14.8 | 2.0 | 1.1 | 0.2 |
| | | | | 2 | 0 | 83 | 14.9 | 2.8 | 3.4 | 1.4 |
| | | | | UTC | 0 | 75 | 14.4 | 2.3 | 2.5 | 1.5 |
| 7 | Asgrow | AG4403 | RR | 1 | 0 | 100 | 5.5 | 0.5 | 0.3 | 0.1 |
| | | | | 2 | 0 | 83 | 8.9 | 0.5 | 1.0 | 0.1 |
| | | | | UTC | 0 | 83 | 10.4 | 2.3 | 1.3 | 1.0 |
| 8 | Asgrow | AG4404 | RR/STS | 1 | 0 | 100 | 16.5 | 1.8 | 1.1 | 0.3 |
| | | | | 2 | 0 | 75 | 15.8 | 1.5 | 1.9 | 0.5 |
| | | | | UTC | 0 | 91 | 18.7 | 2.3 | 3.4 | 1.5 |
| 9 | Schillinger | 456RC | RR | 1 | 0 | 75 | 5.9 | 0.5 | 0.3 | 0.1 |
| | | | | 2 | 0 | 75 | 6.3 | 0.5 | 0.7 | 0.1 |
| | | | | UTC | 0 | 75 | 14.1 | 2.5 | 3.1 | 2.2 |
| 10 | DPL | 4546 | RR | 1 | 0 | 92 | 6.6 | 0.5 | 0.4 | 0.1 |
| | | | | 2 | 0 | 83 | 6.9 | 0.6 | 0.9 | 0.2 |
| | | | | UTC | 0 | 92 | 16.9 | 1.3 | 3.5 | 1.5 |
| 11 | Armor | 47-G7 | RR | 1 | 0 | 83 | 6.0 | 0.5 | 0.4 | 0.1 |
| | | | | 2 | 0 | 83 | 6.9 | 0.5 | 0.6 | 0.1 |
| | | | | UTC | 0 | 100 | 18.6 | 2.0 | 2.4 | 1.1 |
| 12 | Asgrow | AG4703 | RR | 1 | 0 | 83 | 8.0 | 0.5 | 0.3 | 0.1 |
| | | | | 2 | 0 | 83 | 7.8 | 0.6 | 0.8 | 0.2 |
| | | | | UTC | 0 | 100 | 19.2 | 2.5 | 4.1 | 2.3 |
| 13 | Pioneer | 94B73 | RR | 1 | 0 | 67 | 9.3 | 0.6 | 0.4 | 0.1 |
| | | | | 2 | 0 | 58 | 8.6 | 0.5 | 0.8 | 0.2 |
| | | | | UTC | 0 | 67 | 14.5 | 1.6 | 1.8 | 0.8 |
| 14 | Armor | 47-F8 | RR/STS | 1 | 0 | 92 | 12.8 | 1.8 | 0.9 | 0.2 |
| | | | | 2 | 0 | 83 | 12.7 | 1.8 | 1.9 | 0.7 |
| | | | | UTC | 0 | 92 | 14.7 | 1.8 | 3.2 | 1.7 |
| 15 | Pioneer | 94M80 | RR | 1 | 0 | 100 | 5.8 | 0.6 | 0.3 | 0.1 |
| | | | | 2 | 0 | 58 | 3.3 | 0.4 | 0.3 | 0.1 |
| | | | | UTC | 0 | 83 | 14.0 | 2.0 | 2.9 | 1.5 |
| 16 | UA | 485 | -none- | 1 | 0 | 100 | 6.1 | 0.5 | 0.4 | 0.1 |
| | | | | 2 | 0 | 92 | 6.3 | 0.5 | 0.3 | 0.1 |
| | | | | UTC | 0 | 100 | 19.1 | 2.8 | 4.8 | 2.4 |
| 17 | DPL | 4888 | RR/STS | 1 | 0 | 100 | 16.0 | 2.0 | 1.5 | 0.4 |
| | | | | 2 | 0 | 83 | 15.4 | 1.8 | 2.9 | 1.0 |
| | | | | UTC | 0 | 100 | 11.9 | 2.0 | 2.0 | 0.9 |
| 18 | Asgrow | AG4903 | RR/STS | 1 | 0 | 100 | 17.4 | 2.0 | 1.5 | 0.3 |
| | | | | 2 | 0 | 66 | 17.1 | 2.8 | 3.7 | 1.1 |
| | | | | UTC | 0 | 83 | 14.0 | 1.8 | 2.7 | 0.9 |
| 19 | DPL | 4919 | RR/STS | 1 | 0 | 100 | 15.8 | 2.0 | 1.2 | 0.4 |
| | | | | 2 | 0 | 92 | 16.5 | 1.8 | 2.3 | 1.2 |
| | | | | UTC | 0 | 75 | 17.0 | 3.3 | 5.7 | 2.8 |
| 20 | HBK | 4924 | RR | 1 | 0 | 92 | 6.3 | 0.5 | 0.4 | 0.1 |
| | | | | 2 | 0 | 50 | 4.8 | 0.4 | 0.9 | 0.2 |
| | | | | UTC | 0 | 58 | 16.4 | 2.5 | 2.8 | 1.2 |
| 21 | Armor | 49-T3 | RR/STS | 1 | 0 | 83 | 11.8 | 2.0 | 1.1 | 0.3 |
| | | | | 2 | 0 | 100 | 13.4 | 1.8 | 2.5 | 1.0 |
| | | | | UTC | 0 | 75 | 13.0 | 3.0 | 2.7 | 1.4 |
| 22 | Schillinger | 495RC | RR | 1 | 0 | 92 | 7.9 | 0.9 | 0.4 | 0.1 |
| | | | | 2 | 0 | 66 | 6.7 | 0.5 | 0.7 | 0.2 |
| | | | | UTC | 0 | 75 | 14.4 | 2.0 | 2.3 | 0.9 |
| 23 | DPL | 5115 | RR/STS | 1 | 0 | 92 | 15.5 | 2.5 | 1.3 | 0.3 |
| | | | | 2 | 0 | 100 | 13.3 | 1.3 | 1.4 | 0.6 |
| | | | | UTC | 0 | 100 | 15.0 | 2.5 | 2.4 | 1.2 |
| 24 | Pioneer | 95M30 | RR | 1 | 0 | 92 | 5.5 | 0.5 | 0.4 | 0.1 |
| | | | | 2 | 0 | 67 | 4.2 | 0.4 | 0.2 | 0.1 |
| | | | | UTC | 0 | 92 | 20.1 | 3.0 | 4.4 | 1.7 |
| 25 | DPL | 5335 | RR/STS | 1 | 0 | 83 | 16.0 | 2.5 | 1.7 | 0.3 |
| | | | | 2 | 0 | 100 | 14.7 | 1.8 | 2.5 | 0.9 |
| | | | | UTC | 0 | 92 | 16.1 | 3.5 | 4.0 | 1.9 |
| 26 | Armor | 54-03 | RR/STS | 1 | 0 | 83 | 21.3 | 3.8 | 2.1 | 0.4 |
| | | | | 2 | 0 | 91 | 16.5 | 2.0 | 2.1 | 0.6 |
| | | | | UTC | 0 | 75 | 18.0 | 2.8 | 3.1 | 1.2 |
| 27 | Stine | 5482 | RR/STS | 1 | 0 | 58 | 16.8 | 2.8 | 1.4 | 0.3 |
| | | | | 2 | 0 | 58 | 13.3 | 2.0 | 1.9 | 0.8 |
| | | | | UTC | 0 | 75 | 16.5 | 2.0 | 3.1 | 2.0 |
| 28 | Pioneer | 95M50 | RR/STS | 1 | 0 | 83 | 19.8 | 2.0 | 2.0 | 0.3 |
| | | | | 2 | 0 | 92 | 15.9 | 1.3 | 1.4 | 0.4 |
| | | | | UTC | 0 | 83 | 19.2 | 2.3 | 3.8 | 1.8 |
| 29 | Asgrow | AG5605 | RR/STS | 1 | 0 | 92 | 14.7 | 1.5 | 1.1 | 0.2 |
| | | | | 2 | 0 | 100 | 13.7 | 1.5 | 1.2 | 0.5 |
| | | | | UTC | 0 | 83 | 12.2 | 1.6 | 1.6 | 0.9 |
| 30 | DPL | 5634 | RR | 1 | 0 | 92 | 10.0 | 0.5 | 0.5 | 0.1 |
| | | | | 2 | 0 | 75 | 1.1 | 0.1 | 0.04 | 0.05 |
| | | | | UTC | 0 | 67 | 13.3 | 1.8 | 1.6 | 0.9 |

TABLE 3
Pre-Emergence Application of Herbicide:

| | | | | Herbicide | | | | | | |
|---|---|---|---|---|---|---|---|---|---|---|
| Seed | | | | (PERMIT) | % Injury | % | Height | V-stage | Top Weight | Root Weight |
| Variety | | | | application | Phyto | Germination | (cm) | (0-5 scale) | (grams) | (grams) |
| No. | Source | Variety | Trait | (oz) | 14 DAP | 21 DAP | 42 DAP | 42 DAP | 42 DAP | 42 DAP |
| 1 | Dairyland | DL1701 | RR/STS | 1 | 0 | 100 | 18.4 | 2.5 | 4.1 | 1.9 |
| | | | | 2 | 0 | 100 | 14.0 | 1.5 | 1.8 | 0.7 |
| | | | | UTC | 0 | 58 | 13.4 | 1.3 | 1.7 | 1.0 |
| 2 | Dairyland | DL2000 | RR/STS | 1 | 0 | 83 | 15.9 | 2.3 | 2.6 | 1.3 |
| | | | | 2 | 0 | 100 | 16.4 | 2.0 | 2.2 | 0.8 |
| | | | | UTC | 0 | 83 | 12.4 | 0.9 | 1.3 | 0.6 |
| 3 | Asgrow | AG2204 | RR/STS | 1 | 0 | 92 | 21.0 | 2.5 | 3.9 | 1.8 |
| | | | | 2 | 0 | 100 | 19.3 | 2.5 | 3.6 | 1.5 |
| | | | | UTC | 0 | 100 | 18.6 | 2.5 | 3.6 | 2.6 |
| 4 | Dairyland | DL2702 | RR/STS | 1 | 0 | 100 | 22.3 | 2.8 | 5.0 | 1.8 |
| | | | | 2 | 0 | 66 | 18.0 | 2.0 | 3.2 | 1.4 |
| | | | | UTC | 0 | 92 | 16.2 | 1.8 | 2.6 | 1.0 |
| 5 | Dairyland | DL3003 | RR/STS | 1 | 0 | 92 | 23.6 | 3.0 | 4.9 | 2.2 |
| | | | | 2 | 0 | 58 | 13.4 | 1.8 | 2.1 | 1.0 |
| | | | | UTC | 0 | 67 | 18.3 | 2.3 | 3.2 | 2.2 |
| 6 | DPL | 4112 | RR/STS | 1 | 0 | 83 | 17.5 | 2.5 | 3.7 | 1.8 |
| | | | | 2 | 0 | 100 | 15.9 | 1.8 | 2.4 | 1.2 |
| | | | | UTC | 0 | 78 | 14.4 | 2.3 | 2.5 | 1.6 |
| 7 | Asgrow | AG4403 | RR | 1 | 0 | 75 | 5.3 | 0.5 | 0.6 | 0.4 |
| | | | | 2 | 0 | 83 | 8.7 | 1.3 | 1.5 | 0.9 |
| | | | | UTC | 0 | 83 | 10.4 | 2.3 | 1.3 | 1.0 |
| 8 | Asgrow | AG4404 | RR/STS | 1 | 0 | 75 | 20.0 | 2.3 | 4.3 | 1.5 |
| | | | | 2 | 0 | 83 | 20.1 | 1.8 | 3.6 | 1.3 |
| | | | | UTC | 0 | 92 | 18.7 | 2.3 | 3.4 | 1.6 |
| 9 | Schillinger | 457RC | RR | 1 | 0 | 75 | 11.6 | 1.4 | 1.6 | 0.3 |
| | | | | 2 | 0 | 58 | 4.2 | 0.4 | 0.8 | 0.2 |
| | | | | UTC | 0 | 75 | 14.1 | 2.8 | 3.1 | 2.2 |
| 10 | DPL | 4546 | RR | 1 | 0 | 83 | 11.8 | 0.9 | 2.5 | 1.0 |
| | | | | 2 | 0 | 92 | 10.7 | 0.8 | 2.1 | 0.9 |
| | | | | UTC | 0 | 92 | 16.0 | 1.3 | 3.5 | 1.6 |
| 11 | Armor | 47-G7 | RR | 1 | 0 | 63 | 9.7 | 0.8 | 1.2 | 0.2 |
| | | | | 2 | 0 | 83 | 8.4 | 0.5 | 0.9 | 0.2 |
| | | | | UTC | 0 | 100 | 18.6 | 2.0 | 2.4 | 1.1 |
| 12 | Asgrow | AG4703 | RR | 1 | 0 | 100 | 11. | 1.0 | 1.5 | 0.3 |
| | | | | 2 | 0 | 100 | 8.0 | 0.5 | 1.1 | 0.3 |
| | | | | UTC | 0 | 100 | 19.2 | 2.5 | 4.1 | 2.3 |
| 13 | Pioneer | 94B73 | RR | 1 | 0 | 83 | 12.7 | 1.6 | 1.4 | 0.3 |
| | | | | 2 | 0 | 50 | 6.0 | 0.5 | 0.9 | 0.3 |
| | | | | UTC | 0 | 67 | 14.5 | 1.6 | 1.8 | 0.8 |
| 14 | Armor | 47-F8 | RR/STS | 1 | 0 | 100 | 19.4 | 2.5 | 3.6 | 0.8 |
| | | | | 2 | 0 | 100 | 16.5 | 2.5 | 3.2 | 2.0 |
| | | | | UTC | 0 | 92 | 14.7 | 1.8 | 3.2 | 1.7 |
| 15 | Pioneer | 94M80 | RR | 1 | 0 | 50 | 6.9 | 1.0 | 1.4 | 0.4 |
| | | | | 2 | 0 | 66 | 6.5 | 0.8 | 0.7 | 0.2 |
| | | | | UTC | 0 | 83 | 14.0 | 2.0 | 2.9 | 1.5 |
| 16 | UA | 485 | -none- | 1 | 0 | 41 | 10.7 | 0.9 | 1.6 | 0.5 |
| | | | | 2 | 0 | 41 | 8.0 | 0.6 | 1.0 | 0.3 |
| | | | | UTC | 0 | 100 | 19.1 | 2.8 | 4.8 | 2.4 |
| 17 | DPL | 4888 | RR/STS | 1 | 0 | 92 | 15.7 | 2.0 | 2.7 | 1.4 |
| | | | | 2 | 0 | 100 | 18.6 | 2.0 | 3.3 | 1.8 |
| | | | | UTC | 0 | 100 | 11.9 | 2.0 | 2.1 | 0.9 |
| 18 | Asgrow | AG4903 | RR/STS | 1 | 0 | 100 | 18.5 | 2.8 | 4.2 | 2.0 |
| | | | | 2 | 0 | 75 | 17.3 | 2.0 | 2.9 | 1.5 |
| | | | | UTC | 0 | 83 | 14.0 | 1.8 | 2.7 | 0.9 |
| 19 | DPL | 4919 | RR/STS | 1 | 0 | 58 | 18.4 | 3.8 | 5.0 | 2.5 |
| | | | | 2 | 0 | 75 | 17.8 | 3.3 | 3.6 | 2.0 |
| | | | | UTC | 0 | 75 | 17.0 | 3.3 | 5.7 | 2.8 |
| 20 | HBK | 4924 | RR | 1 | 0 | 66 | 11.6 | 1.4 | 2.0 | 0.6 |
| | | | | 2 | 0 | 92 | 7.9 | 0.6 | 1.5 | 0.4 |
| | | | | UTC | 0 | 66 | 16.4 | 2.5 | 2.8 | 1.2 |
| 21 | Armor | 49-T3 | RR/STS | 1 | 0 | 83 | 16.6 | 3.5 | 4.9 | 2.7 |
| | | | | 2 | 0 | 75 | 14.5 | 2.8 | 2.9 | 1.4 |
| | | | | UTC | 0 | 75 | 13.0 | 3.0 | 2.7 | 1.4 |
| 22 | Schillinger | 495RC | RR | 1 | 0 | 66 | 12.1 | 1.5 | 1.5 | 0.6 |
| | | | | 2 | 0 | 58 | 9.6 | 0.9 | 1.2 | 0.4 |
| | | | | UTC | 0 | 75 | 14.4 | 2.0 | 2.3 | 0.9 |
| 23 | DPL | 5115 | RR/STS | 1 | 0 | 69 | 20.9 | 4.8 | 5.4 | 2.4 |
| | | | | 2 | 0 | 100 | 15.2 | 2.8 | 2.9 | 1.4 |
| | | | | UTC | 0 | 100 | 15.0 | 2.5 | 2.4 | 1.2 |
| 24 | Pioneer | 95M30 | RR | 1 | 0 | 83 | 14.8 | 1.8 | 3.2 | 0.9 |
| | | | | 2 | 0 | 83 | 6.8 | 0.6 | 1.1 | 0.3 |
| | | | | UTC | 0 | 92 | 20 1 | 3.0 | 4.4 | 1.7 |
| 25 | DPL | 5335 | RR/STS | 1 | 0 | 66 | 17.1 | 2.8 | 3.6 | 1.6 |
| | | | | 2 | 0 | 92 | 16.6 | 2.5 | 3.0 | 1.5 |
| | | | | UTC | 0 | 92 | 16.1 | 3.5 | 4.0 | 1.9 |
| 26 | Armor | 54-03 | RR/STS | 1 | 0 | 92 | 21.6 | 3.0 | 4.8 | 1.8 |
| | | | | 2 | 0 | 100 | 18.9 | 2.0 | 2.7 | 1.2 |
| | | | | UTC | 0 | 75 | 18.0 | 2.8 | 3.2 | 1.2 |
| 27 | Stine | 5482 | RR/STS | 1 | 0 | 100 | 19.2 | 2.5 | 3.6 | 1.6 |
| | | | | 2 | 0 | 83 | 17.6 | 2.3 | 2.8 | 1.2 |
| | | | | UTC | 0 | 75 | 16.5 | 2.0 | 3.1 | 2.0 |
| 28 | Pioneer | 95M50 | RR/STS | 1 | 0 | 50 | 21.9 | 4.0 | 5.3 | 2.2 |
| | | | | 2 | 0 | 92 | 21.1 | 2.3 | 3.8 | 2.0 |
| | | | | UTC | 0 | 83 | 19.2 | 2.3 | 3.8 | 1.8 |
| 29 | Asgrow | AG5605 | RR/STS | 1 | 0 | 100 | 21.6 | 5.5 | 6.0 | 1.8 |
| | | | | 2 | 0 | 100 | 19.3 | 2.0 | 2.6 | 1.1 |
| | | | | UTC | 0 | 83 | 12.2 | 1.6 | 1.6 | 0.9 |
| 30 | DPL | 5634 | RR | 1 | 0 | 92 | 12.0 | 1.4 | 1.9 | 0.6 |
| | | | | 2 | 0 | 92 | 8.1 | 0.5 | 1.3 | 0.6 |
| | | | | UTC | 0 | 67 | 13.3 | 1.8 | 1.6 | 0.9 |

TABLE 4
Post-Emergence Application of Herbicide:

| | | | | Herbicide | | | | | | |
|---|---|---|---|---|---|---|---|---|---|---|
| Seed | | | | (PERMIT) | % Injury | % | Height | V-stage | Top Weight | Root Weight |
| Variety | | | | application | Phyto | Germination | (cm) | (0-5 scale) | (grams) | (grams) |
| No. | Source | Variety | Trait | (oz) | 14 DAP | 21 DAP | 42 DAP | 42 DAP | 42 DAP | 42 DAP |
| 1 | Dairyland | DL1701 | RR/STS | 1 | 100 | 0 | 15.2 | 2.0 | 1.5 | 0.3 |
| | | | | 2 | 100 | 2 | 12.7 | 2.3 | 1.8 | 0.2 |
| | | | | UTC | 58 | 0 | 13.4 | 1.3 | 1.7 | 1.0 |
| 2 | Dairyland | DL2000 | RR/STS | 1 | 83 | 0 | 9.6 | 1.5 | 0.7 | 0.1 |
| | | | | 2 | 100 | 2 | 13.5 | 1.8 | 1.5 | 1.4 |
| | | | | UTC | 83 | 0 | 12.4 | 0.9 | 1.3 | 0.6 |
| 3 | Asgrow | AG2204 | RR/STS | 1 | 92 | 10 | 13.2 | 2.0 | 1.4 | 0.3 |
| | | | | 2 | 92 | 11 | 14.1 | 2.0 | 1.6 | 0.3 |
| | | | | UTC | 25 | 0 | 18.6 | 2.5 | 3.6 | 2.6 |
| 4 | Dairyland | DL2702 | RR/STS | 1 | 100 | 5 | 13.2 | 1.5 | 1.0 | 0.1 |
| | | | | 2 | 92 | 13 | 14.7 | 2.3 | 1.7 | 0.4 |
| | | | | UTC | 92 | 0 | 16.2 | 1.8 | 2.6 | 1.0 |
| 5 | Dairyland | DL3003 | RR/STS | 1 | 83 | 4 | 17.1 | 2.5 | 1.6 | 0.3 |
| | | | | 2 | 75 | 15 | 14.9 | 2.5 | 1.5 | 0.3 |
| | | | | UTC | 67 | 0 | 18.3 | 2.3 | 3.2 | 2.2 |
| 6 | DPL | 4112 | RR/STS | 1 | 78 | 1 | 13.3 | 1.8 | 1.0 | 0.1 |
| | | | | 2 | 83 | 2 | 14.6 | 2.3 | 1.6 | 0.3 |
| | | | | UTC | 75 | 0 | 14.4 | 2.3 | 2.5 | 1.6 |
| 7 | Asgrow | AG4403 | RR | 1 | 92 | 100 | 0.0 | 0.5 | 0.4 | 0.0 |
| | | | | 2 | 92 | 78 | 9.7 | 0.5 | 0.5 | 0.1 |
| | | | | UTC | 83 | 0 | 10.4 | 2.3 | 1.3 | 1.0 |
| 8 | Asgrow | AG4404 | RR/STS | 1 | 100 | 3 | 13.9 | 1.8 | 1.2 | 0.2 |
| | | | | 2 | 75 | 5 | 13.7 | 1.5 | 1.3 | 0.2 |
| | | | | UTC | 92 | 0 | 18.7 | 2.3 | 3.4 | 1.5 |
| 9 | Schillinger | 457RC | RR | 1 | 58 | 83 | 4.0 | 0.8 | 0.4 | 0.1 |
| | | | | 2 | 83 | 56 | 11.6 | 1.0 | 0.7 | 0.1 |
| | | | | UTC | 75 | 0 | 14.1 | 2.8 | 3.1 | 2.2 |
| 10 | DPL | 4546 | RR | 1 | 78 | 95 | 0.0 | 0.5 | 0.3 | 0.0 |
| | | | | 2 | 83 | 84 | 11.0 | 0.5 | 0.4 | 0.1 |
| | | | | UTC | 92 | 0 | 16.9 | 1.3 | 3.5 | 1.6 |
| 11 | Armor | 47-G7 | RR | 1 | 92 | 70 | 12.0 | 0.6 | 0.7 | 0.1 |
| | | | | 2 | 100 | 88 | 8.9 | 0.8 | 0.8 | 0.1 |
| | | | | UTC | 100 | 0 | 18.6 | 2.0 | 2.4 | 1.1 |
| 12 | Asgrow | AG4703 | RR | 1 | 100 | 93 | 3.5 | 0.5 | 0.4 | 0.0 |
| | | | | 2 | 100 | 95 | 3.3 | 0.5 | 0.5 | 0.1 |
| | | | | UTC | 100 | 0 | 19.2 | 2.5 | 4.1 | 2.3 |
| 13 | Pioneer | 94B73 | RR | 1 | 75 | 91 | 8.8 | 0.5 | 0.5 | 0.1 |
| | | | | 2 | 50 | 93 | 3.9 | 0.6 | 0.4 | 0.0 |
| | | | | UTC | 67 | 0 | 14.5 | 1.6 | 1.8 | 0.8 |
| 14 | Armor | 47-F8 | RR/STS | 1 | 83 | 2 | 12.1 | 1.5 | 0.8 | 0.2 |
| | | | | 2 | 100 | 3 | 10.5 | 1.3 | 0.8 | 0.2 |
| | | | | UTC | 92 | 0 | 14.7 | 1.8 | 3.2 | 1.7 |
| 15 | Pioneer | 94M80 | RR | 1 | 92 | 99 | 0.0 | 0.5 | 0.4 | 0.0 |
| | | | | 2 | 83 | 88 | 6.2 | 0.5 | 0.5 | 0.1 |
| | | | | UTC | 83 | 0 | 14.0 | 2.0 | 2.9 | 1.5 |
| 16 | UA | 485 | Conv | 1 | 92 | 79 | 10.8 | 0.5 | 0.3 | 0.1 |
| | | | | 2 | 100 | 89 | 6.9 | 0.5 | 0.4 | 0.1 |
| | | | | UTC | 100 | 0 | 19.1 | 2.8 | 4.8 | 2.4 |
| 17 | DPL | 4888 | RR/STS | 1 | 100 | 0 | 11.7 | 1.8 | 1.1 | 0.2 |
| | | | | 2 | 100 | 3 | 14.2 | 2.0 | 1.5 | 0.4 |
| | | | | UTC | 100 | 0 | 11.9 | 2.0 | 2.0 | 0.9 |
| 18 | Asgrow | AG4903 | RR/STS | 1 | 66 | 8 | 10.0 | 1.0 | 0.6 | 0.1 |
| | | | | 2 | 83 | 13 | 13.6 | 2.0 | 1.5 | 0.4 |
| | | | | UTC | 83 | 0 | 14.0 | 1.8 | 2.7 | 0.9 |
| 19 | DPL | 4919 | RR/STS | 1 | 83 | 3 | 13.1 | 1.9 | 1.5 | 0.3 |
| | | | | 2 | 92 | 4 | 11.6 | 1.8 | 1.2 | 0.3 |
| | | | | UTC | 75 | 0 | 17.0 | 3.3 | 5.7 | 2.8 |
| 20 | HBK | 4924 | RR | 1 | 66 | 49 | 11.0 | 0.5 | 0.4 | 0.1 |
| | | | | 2 | 75 | 61 | 7.1 | 0.6 | 0.4 | 0.1 |
| | | | | UTC | 66 | 0 | 16.4 | 2.5 | 2.8 | 1.2 |
| 21 | Armor | 49-T3 | RR/STS | 1 | 92 | 1 | 11.8 | 2.8 | 1.5 | 0.3 |
| | | | | 2 | 75 | 2 | 10.6 | 1.8 | 1.4 | 0.3 |
| | | | | UTC | 75 | 0 | 13.0 | 3.0 | 2.7 | 1.4 |
| 22 | Schillinger | 495RC | RR | 1 | 66 | 84 | 5.2 | 0.5 | 0.3 | 0.1 |
| | | | | 2 | 83 | 86 | 6.7 | 0.6 | 0.4 | 0.1 |
| | | | | UTC | 75 | 0 | 14.4 | 2.0 | 2.3 | 0.9 |
| 23 | DPL | 5115 | RR/STS | 1 | 100 | 2 | 9.9 | 1.5 | 0.9 | 0.2 |
| | | | | 2 | 92 | 5 | 13.2 | 3.5 | 1.8 | 0.3 |
| | | | | UTC | 100 | 0 | 15.0 | 2.5 | 2.4 | 1.2 |
| 24 | Pioneer | 95M30 | RR | 1 | 50 | 78 | 6.8 | 0.5 | 0.4 | 0.1 |
| | | | | 2 | 92 | 91 | 3.8 | 0.8 | 0.6 | 0.1 |
| | | | | UTC | 92 | 0 | 20.1 | 3.0 | 4.4 | 1.7 |
| 25 | DPL | 5335 | RR/STS | 1 | 67 | 2 | 13.8 | 2.3 | 1.7 | 0.4 |
| | | | | 2 | 83 | 5 | 15.2 | 3.5 | 2.8 | 0.5 |
| | | | | UTC | 92 | 0 | 16.1 | 3.5 | 4.1 | 1.9 |
| 26 | Armor | 54-03 | RR/STS | 1 | 92 | 4 | 16.1 | 3.0 | 1.6 | 0.3 |
| | | | | 2 | 75 | 4 | 12.2 | 2.5 | 1.4 | 0.2 |
| | | | | UTC | 75 | 0 | 18.0 | 2.8 | 3.1 | 1.2 |
| 27 | Stine | 5482 | RR/STS | 1 | 75 | 11 | 11.7 | 2.3 | 0.9 | 0.2 |
| | | | | 2 | 42 | 14 | 10.8 | 2.3 | 1.3 | 0.3 |
| | | | | UTC | 75 | 0 | 16.5 | 2.0 | 3.1 | 2.0 |
| 28 | Pioneer | 95M50 | RR/STS | 1 | 75 | 4 | 16.2 | 2.3 | 1.7 | 0.2 |
| | | | | 2 | 92 | 4 | 17.6 | 3.3 | 2.2 | 0.4 |
| | | | | UTC | 83 | 0 | 19.2 | 2.3 | 3.8 | 1.8 |
| 29 | Asgrow | AG5605 | RR/STS | 1 | 100 | 4 | 19.5 | 3.5 | 1.9 | 0.4 |
| | | | | 2 | 92 | 14 | 15.8 | 2.3 | 1.2 | 0.3 |
| | | | | UTC | 83 | 0 | 12.2 | 1.6 | 1.6 | 0.9 |
| 30 | DPL | 5634 | RR | 1 | 92 | 80 | 9.8 | 0.5 | 0.3 | 0.1 |
| | | | | 2 | 92 | 94 | 3.4 | 0.6 | 0.4 | 0.1 |
| | | | | UTC | 67 | 0 | 13.3 | 1.8 | 1.6 | 0.9 |

Analysis of the foregoing data of Table 2, 3 and 4 presented several surprising findings.

First it was unexpectedly observed that the application of the sulfonylurea based herbicide did not unduly adversely affect the germination rate of only “RR” types of soybean varieties as compared to the germination rate of “RR/STS” types of soybean varieties as well as the germination rate of the “UA 485” soybean variety having neither “RR” or “STS” traits. As is observed from the following Table 5 which relates to the % germination rates of the different categories of soybean varieties as observed at 21 days after planting:

TABLE 5

| | Pre- | Post- | Avg. total |
|---|---|---|---|
| Trait: | emergence: | emergence: | per trait |
| RR/STS | 84.0 | 85.9 | 84.9 |
| RR | 81.6 | 78.6 | 80.1 |
| UA 485 | 97.3 | 60.7 | 79.0 |
| Avg. total per | 83.6 | 82.4 | 83.0 |
| application method | | | |

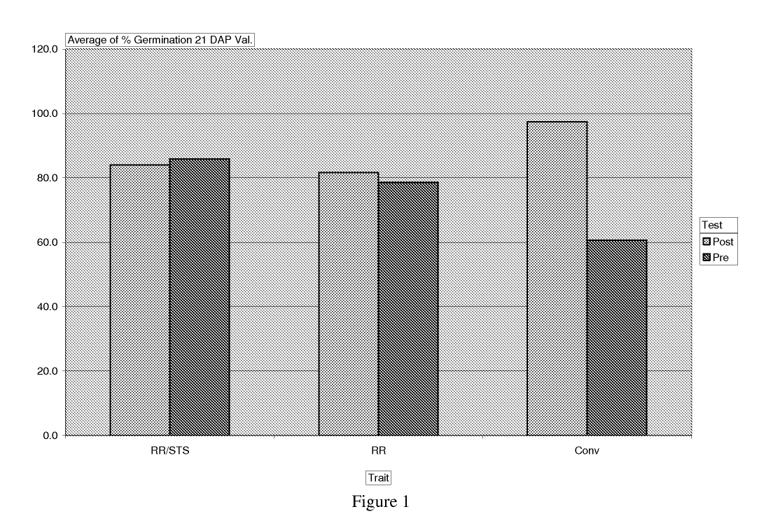

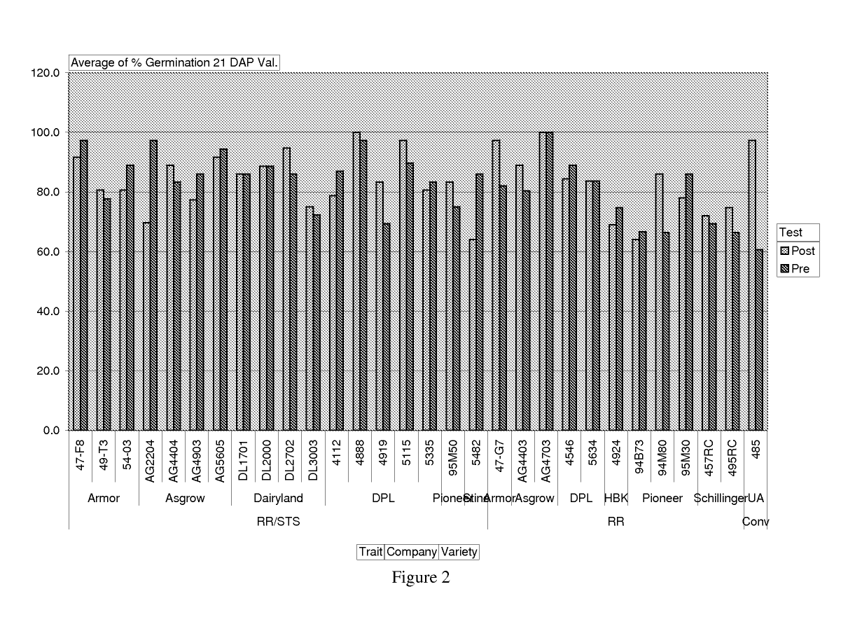

These results are also represented on FIG. 1 as well as on FIG. 2. From FIG. 1 is clearly seen that the rate of germination of the “RR” trait soybeans were comparable to “RR/STS” trait soybeans. From FIG. 2 is similarly clearly seen that the germination rate of both “RR” trait soybeans and “RR/STS” trait soybeans was also quite similar. As is seen from the above and from the figures, the germination rate of the “RR” only type soybean varieties was not unduly deleteriously affected by treatment with the sulfonyl urea type herbicide in both pre-emergence and post-emergence applications. Such is unexpected in the art as it is normally anticipated that application of a specific herbicide, here sulfonyl urea, to which a soybean variety which is not tolerant is expected to destroy the specific soybean variety. Thus the observed results are surprising and would be unexpected by a skilled artisan.

The benefits of this discovery are real and are several.

First, it now appears feasible to plant crops having different seeds or varieties, wherein a first crop is from a plant, seed, or a cultivar which has been genetically modified, crossbred, or otherwise imparted with resistance to a first class of herbicides, adjacent to or geographically proximate to and a second crop which is of a plant, seed, or a cultivar which has either no genetic modification wherein it has resistance to said first class of herbicide, and/or has been genetically modified, crossbred or otherwise imparted with resistance to a second (as well as further) class of herbicides, wherein the first class of herbicides and the second (and further) class of herbicides are different than the first class of herbicides. With the present inventors discovery, it is now apparently feasible to plant different crops having tolerance to different classes of herbicides, either adjacent to or contiguous to one another or in reasonable sufficient geographic proximity to one another and to treat the first crops with at least a first herbicide without unduly damaging or risking the undesirable damage of the second crop by either directly, or indirectly contacting the second crop with the first herbicide. For example, from the foregoing data as presented in Tables 2-5, it has been discovered that many varieties of soybean seed which had previously been only expected to be tolerant to glyphosate herbicides, particularly Roundup®, are not eradicated, nor undesirably stunted in their growth when contacted with sulfonyl urea-based herbicides to which the said varieties of soybean seed have not been indicated as having any specific tolerance thereto.

Thus, it is contemplated that in accordance with one aspect of the present invention, there is provided in agricultural method for the control of undesired vegetative growth in two (or more) crops each having a specific resistance to different classes of herbicides, especially preferably wherein at least one of the crops has a resistance to/tolerance to sulfonyl urea type herbicides and at least one of the other crops has a resistance to/tolerance to herbicides other than sulfonyl urea type herbicides or which has not been genetically modified, crossbred or otherwise altered to exhibit a resistance to a specific herbicide , wherein the said crops are either adjacent to each other, or are in sufficient geographical proximity to one another whereby there exists a likelihood of inadvertent or of direct application of a first herbicide treatment preparation being applied to the said first crop to be either inadvertently or directly applied to at least a part of the second crop, wherein said application of said first herbicide treatment preparation does not undesirably or unduly deleteriously effect the treated seeds, or plants forming part of said second crop. Preferably, in accordance to the foregoing inventive aspect the first herbicide treatment preparation comprises a herbicidally effective amount of a sulfonylurea based herbicide, and the seeds and/or plants of the second crop have not been imparted with resistance to/tolerance to sulfonyl urea type herbicides. Yet more preferably, in accordance to the foregoing inventive aspect the first herbicide treatment preparation comprises a herbicidally effective amount of a sulfonylurea based herbicide, and the seeds and/or plants of the second crop (or further crops) have not been imparted with resistance to/tolerance to sulfonyl urea type herbicides, but have been imparted with resistance to/tolerance to glyphosate based herbicides, particularly wherein the glyphosate based herbicide is Roundup®.

Ancillary to the foregoing discovery it is also contemplated that the two or more different types of crops need not be up the same genus, such as different soybeans featuring different varieties or traits which are planted adjacent to, or are planted sufficiently geographically proximate to each other but rather, a more expansive understanding is to be presented. Namely, it is clearly contemplated to that crops of difference genus may be planted adjacent to, or in reasonable geographic proximity with one another and be treated and the manner of the first aspect described immediately above. For example, it is contemplated that that a first crop such as soy, maize (corn), rice, cotton, etc. based on seed, plants or cultivars having been imparted with resistance to/tolerance to sulfonyl urea type herbicides may be planted adjacent to or in reasonable geographic proximity to a second crop such as soy, maize (corn), rice, cotton, etc. based on seed, plants or cultivars which has not been imparted with resistance to/tolerance to sulfonyl urea type herbicides, but preferably have been imparted with resistance to/tolerance to glyphosate based herbicides, particularly wherein the glyphosate based herbicide is Roundup®. It is thus to be understood that different crops may be planted at the same time, or shortly after each other were in such crops or all the different species. This for example make possible for the adjacent planting of different crops of different genus adjacent to each other or proximate to one another. The technical as well as the commercial benefits of the foregoing should be immediately realize to a skilled artisan as it may no longer be necessarily required to physically isolate the first crop from the second crop so as to minimize the likelihood of crop damage when applying a herbicide treatment preparation comprising a herbicidally effective amount of a sulfonylurea based herbicide for fear of undesirably damaging the second crop which may be contacted either directly, or indirectly, such as by overspray of or drifting of the herbicide treatment preparation being applied to the first crop on to the second crop.

Second, as is evident from the foregoing data as presented in Tables 2-5, it has been discovered that many varieties of soybean seed which had previously been only expected to be tolerant to glyphosate herbicides, particularly “Roundup®” are not eradicated, nor undesirably stunted in their growth when contacted with sulfonyl urea-based herbicide to which the said varieties of soybean seed have not been indicated as having any specific tolerance thereto. Thus, this opens the door to the possibility that undesired vegetative growth in plots or fields which have been planted with soybean beans or plants which have not been specifically been genetically modified, crossbred or otherwise altered in order to exhibit specific tolerance to sulfonyl urea-based herbicide might be successfully treated with said sulfonyl urea-based herbicide, either in the presence of, but preferably even in the absence of glyphosate herbicides.

Thus, it is contemplated that in accordance with a yet further aspect of the present invention, there is provided an agricultural method for the control of undesired vegetative growth in a crop which is grown from seeds or is a plant crop having a resistance to/tolerance to glyphosate-type herbicides wherein undesired vegetative growth amongst the crop is controlled with or eradicated by the use of a herbicide treatment preparation comprising a herbicidally effective amount of a sulfonylurea based herbicide which may be applied either pre-planting, pre-emergence or post-emergence of the said crop. Surprisingly, as the results shown on Tables 2-5 illustrate, quite unexpectedly a number of varieties of soybean seeds which are being identified by their current suppliers as a being glypho sate tolerant but not sulfonylurea tolerant quite unexpectedly do exhibit a favorable degree of resistance to/tolerance to sulfonyl urea in a sulfonylurea based herbicide treatment preparation. The technical as well as the commercial benefits of the foregoing should be immediately realize to a skilled artisan as it may no longer be necessarily required to use two or more different herbicide treatment preparations, i.e., a first herbicide treatment preparation comprising a herbicidally effective amount of a sulfonylurea based herbicide and a second herbicide treatment preparation comprising a herbicidally effective amount of a glyphosate based herbicide to separately treat such soybean crops. Rather it appears that the use of a single herbicide treatment preparation comprising a herbicidally effective amount of a sulfonylurea based herbicide on both soybean varieties having “STS/RR” or only “RR” traits may be effectively treated, even in the absence of a glyphosate based herbicide treatment preparation. Of course it is contemplated that the use of a single herbicide treatment preparation comprising both a sulfonylurea based herbicide and a glyphosate based herbicide may be used, as it does not appear that at least the above soybean seed varieties are unduly deleteriously effected.

### Study II:

A controlled field study was conducted evaluate post emerge treatments of several commercially available soybean seed varieties to a sulfonylurea based herbicide treatment preparation, based on PERMIT.

Separate test plots were planted with one of each of the following types of commercially available soybean seed varieties: HBK 4924 a “RR” type soybean, D&PL 4919 a “RR/STS” type soybean, D&PL 5115 a “RR/STS” type soybean, Asgrow 4903 a “RR/STS” type soybean, Asgrow 4503 a “RR/STS” type soybean, and Pioneer 95M50 a “RR/STS” type soybean. The soybeans were allowed to germinate and grow to the V3-4 growth stage. Several replicate test plots were planted of each variety of soybean. Subsequently, separate sulfonylurea based herbicide treatment preparation, each based on PERMIT at various concentrations: a first preparation formulated to provide 0.1 oz. of PERMIT and 1 pint of COC (crop oil concentrate) per acre of crop; a second preparation formulated to provide 0.5 oz. of PERMIT and 1 pint of COC per acre of crop; and, a third preparation formulated to provide 1 oz. of PERMIT and 1 pint of COC per acre of crop. These three preparations were applied “over the top” separately to separate test plots of the above seed varieties, and the growth of the soybean plants was variously observed and evaluated a 7 days, 14 days, 27 days, 34 days and 41 days following treatment.

Similar separate test plots planted with the above soybean seed varieties were separately tested by separately applying the above three preparations “over the top” to these test plots when the soybean plants were in the R1 to R4 growth stage, and the growth of the soybean plants was evaluated at one day subsequent to treatment and also at eight days subsequent to treatment.

It was observed that at all application rates the Asgrow 4503 and HBK 4924 varieties recorded 40-87% crop injury. The Pioneer 95M50 seed variety suffered 20-37% crop injury. This result was surprising as the Asgrow 4503 and the Pioneer 95M50 were both indicated to be “RR/STS” type soybeans, while the HBK 4924 was indicated to be only a “RR” type soybean. In contrast thereto, The two D&PL varieties, DP&L 5115 and DP&L 4919 both indicated to be “RR/STS” type soybeans as well as the Asgrow 4903 soybeans, also indicated to be “RR/STS” type soybeans did show some discoloration at 7-8 days after treatment by it was observed that by 14 days after treatment most of the symptom logy had disappeared.

From the foregoing it is evident that the tolerance of the soybean plants to the separate sulfonylurea based herbicide treatment preparation varied primarily based on the variety of soybean seed and was not particularly dependent upon the specific separate sulfonylurea based herbicide treatment preparations and the concentrations of the sulfonylurea-based herbicide which they contained.

Further, two preemergence tests were conducted on the foregoing soybean seed varieties wherein separate lots of said seed were treated with further separate sulfonylurea based herbicide treatment preparations, each based on PERMIT at various concentrations: a fourth preparation formulated to provide 0.65 oz. of PERMIT and 1 pint of COC per acre of crop; and a fifth preparation formulated to provide 1.3 oz. of PERMIT and 1 pint of COC per acre of crop. These fourth and fifth preparations were applied at 0 days, 1 day, 3 days, 4 days, and 6 days following planting. It was observed that for all soybean seed varieties, at four days after planting approximately 15% of the soybeans had germinated and the soybean plants emerged, and by the sixth day approximately 50% of the soybean plants had emerged. These tests surprisingly showed that the various soybean seed varieties whether of the “RR” tolerant type, or of the “RR/STS” tolerant type were not adversely affected by the application of separate sulfonylurea based herbicide treatment preparations, each based on PERMIT at various concentrations during this stage of plant growth. Such strongly suggests the utility of separate sulfonylurea based herbicide treatment preparations, on various soybean varieties particularly at the premergence stages of crop growth as well as during early stages, typically to about the 3^{rd} day of crop plant growth.

Certain results of the foregoing “Study II” are indicated on the following Table 6 which reports the visually estimated percent soybean crop injury at V-3 to V-4 timings, and at R2 and R3 timings of the soybean plant development.

TABLE 6

| | | Herbicide | % crop injury, V-3 | | % crop injury, R2 | |
|---|---|---|---|---|---|---|
| Seed | Source | (PERMIT) | to V-4 timings | | to R3 timings | |
| Variety | variety and | application | 14 days after | 41 days after | 8 days after | 15 days after |
| No. | trait | (oz/acre | treatment | treatment | treatment | treatment |
| 20 | HBK 4924, | 0.1 | 57 | 57 | 40 | 60 |
| | RR | 0.5 | 75 | 75 | 40 | 60 |
| | | 1.0 | 70 | 70 | 40 | 60 |
| 19 | DPL 4919, | 0.1 | 2.5 | 0 | 10 | 10 |
| | RRSTS | 0.5 | 10 | 0 | 10 | 0 |
| | | 1.0 | 5 | 0 | 10 | 0 |
| 18 | Asgrow 4903, | 0.1 | 0 | 0 | 10 | 0 |
| | RRSTS | 0.5 | 7.5 | 0 | 10 | 0 |
| | | 1.0 | 10 | 0 | 10 | 0 |
| 28 | Pioneer | 0.1 | 25 | 25 | 20 | 20 |
| | 95M50, | 0.5 | 30 | 27.5 | 20 | 20 |
| | RRSTS | 1.0 | 30 | 27.5 | 20 | 20 |
| 23 | DPL 5115, | 0.1 | 0 | 0 | 10 | 0 |
| | RRSTS | 0.5 | 7.5 | 0 | 10 | 0 |
| | | 1.0 | 7.5 | 0 | 10 | 0 |
| 31 | Asgrow 4503, | 0.1 | 67.5 | 67.5 | 40 | 57.5 |
| | RRSTS | 0.5 | 80 | 85 | 40 | 57.5 |
| | | 1.0 | 77.5 | 87.5 | 40 | 40 |

Certain further results of the foregoing “Study II” are indicated on the following Table 7 which reports the visually estimated percent soybean crop injury at either 17 days after planting or 47 days after planting on soybean plots which had been treated either at 3 or 5 days after planting in the test plots.

TABLE 7

| | | | | % crop injury, visual assessment | | |
|---|---|---|---|---|---|---|
| | | | Herbicide | Herbicide | Herbicide | Herbicide |
| | | | application at | application at | application at | application at |
| | | | 3 days after | 5 days after | 3 days after | 5 days after |
| | | Herbicide | planting | planting | planting | planting |
| Seed | Source | (PERMIT) | assessment at | assessment at | assessment at | assessment at |
| Variety | variety and | application | 17 days after | 47 days after | 17 days after | 47 days after |
| No. | trait | (oz/acre) | planting | planting | planting | planting |
| 20 | HBK 4924, | 0.65 | 10 | 27.5 | 0 | 0 |
| | RR | 1.3 | 12.5 | 28.8 | 0 | 0 |
| 19 | DPL 4919, | 0.65 | 0 | 2.5 | 0 | 0 |
| | RRSTS | 1.3 | 2.5 | 2.5 | 0 | 0 |
| 18 | Asgrow 4903, | 0.65 | 0 | 0 | 0 | 0 |
| | RRSTS | 1.3 | 0 | 0 | 0 | 0 |
| 28 | Pioneer | 0.65 | 0 | 0 | 7.5 | 0 |
| | 95M50, | 1.3 | 0 | 2.5 | 2.5 | 2.5 |
| | RRSTS | | | | | |
| 23 | DPL 5115, | 0.65 | 0 | 2.5 | 0 | 0 |
| | RRSTS | 1.3 | 0 | 0 | 0 | 0 |

Yet further results of the foregoing “Study II” are indicated on the following Table 8 which reports the visually estimated percent soybean crop injury which were all assessed at 19 days after planting on soybean plots which had been treated at either 0 days, 1 day, 4 days or 6 days after planting in the test plots. All applications of the PERMIT herbicide were at 1.3 ounces per acre.

TABLE 8

| | | | % crop injury, visual assessment | | | |
|---|---|---|---|---|---|---|
| | | Herbicide | Herbicide | Herbicide | Herbicide | Herbicide |
| Seed | Source | (PERMIT) | application at 0 | application at 1 | application at 4 | application at 6 |
| Variety | variety and | application | days after | days after | days after | days after |
| No. | trait | (oz/acre) | planting | planting | planting | planting |
| 20 | HBK 4924, | 1.3 | 0 | 7.5 | 40 | 80 |
| | RR | | | | | |
| 19 | DPL 4919, | 0.65 | 0 | 0 | 0 | 0 |
| | RRSTS | | | | | |
| 28 | Pioneer | 0.65 | 0 | 0 | 0 | 0 |
| | 95M50, | | | | | |
| | RRSTS | | | | | |
| 23 | DPL 5115, | 0.65 | 0 | 0 | 0 | 0 |
| | RRSTS | | | | | |

As can be seen from the foregoing, surprisingly certain seeds varieties which had not been imparted with “STS” resistance traits were quite resistant to the application of sulfonylurea based herbicides, which is contrary to the current understanding in the art. With the present inventors discovery, it is now apparently feasible to plant different crops having tolerance to different classes of herbicides, either adjacent to or contiguous to one one another or in reasonable sufficient geographic proximity to one another and to treat the first crops with at least a first herbicide without unduly damaging or risking the undesirable damage of the second crop by either directly, or indirectly contacting the second crop with the first herbicide. Such appears to be particularly the case wherein application of the sulfonylurea based herbicides occurs during early stages of the soybean plant development, particularly if applied in the germination stage or first several days of growth of the soybean plant.

### Example Compositions:

Several formulation examples of mixed herbicides comprising PERMIT were formulated according to conventional techniques, concurrently with further herbicides namely glyphosates (either as free acid or as ammonium salts) as well as dicamba, sodium salt with the weight “grams active ingredient” (“gai”) and the “active ingredients” (“ai”) of the respective herbicides present in each of the example formulations as indicated below.
Ex.1: Glyphosate (free acid) . . . 362.88 gai

PERMIT . . . 28.32 gai

Corresponding to:

Glyphosate (free acid) . . . 60.79% ai(w/w)

PERMIT . . . 4.74% ai(w/w)
Ex.2: Glyphosate (ammonium salt) . . . 362.88 gai

Dicamba (sodium salt) . . . 124.85 gai

PERMIT . . . 28.375 gai

Corresponding to:

Glyphosate (free acid) . . . 46.16% ai(w/w)

Dicamba (sodium salt) . . . 15.88% ai(w/w)

PERMIT . . . 3.61% ai(w/w)
Ex.3: Glyphosate (free acid) . . . 362.88 gai

PERMIT . . . 28.32 gai

Corresponding to:

Glyphosate (free acid) . . . 73.8% ai(w/w)

PERMIT . . . 5.76% ai(w/w)

Certain physical and chemical properties of further example compositions are indicated on the following Table 9.

TABLE 9

| | % ai(w/w) | | pH | % Suspensibility | |
|---|---|---|---|---|---|
| Example | PERMIT | Wet Time | 1% | (5 g/250 ml) | Particle Size |
| Formula # | @ 22 C. | (sec) | sol. | 342 ppm H₂O | D0.1 D0.5 D0.9 |
| Ex. 4 | 4.46 | 41 | 3.8 | 108.26 | 0.8, 4.3, 15.3 |
| | (avg. 4.42/4.49) | | | (42-invertions) | |
| Ex. 5 | 3.48 | 5 | 3.9 | 106.27 | 1.4, 10.2, 28.5 |
| | (avg. 3.43/3.53) | | | (35-invertions) | |
| Ex. 6 | 5.99 | 15 | 2.0 | 96.95 | 0.6, 3.2, 13.6 |
| | (avg. 5.99/5.98) | | | (60-invertions) | |

### Corn (I)

A study was performed to evaluate the postemergence application of herbicidal treatment compositions comprising halosulfuron methyl on corn crops, and comparing the efficacy of these herbicidal treatment compositions on certain undesired vegetative growth, more specifically Faber's foxtail (Setaria faberi), velvetleaf (Abutilon theoprasti), common waterhemp (Amaranthus tamariscinus), common lambsquarters (Chenopodium album) and ivyleaf morningglory (Ipomoea hederacea). The evaluation was performed on a plurality of 10 ft. by 25 ft. test plots in Iowa wherein the presence of the foregoing undesired vegetative growth as known to be prevalent, and whose presence was confirmed at the locus of the test plots. The corn crop was of the type Zea mays indentata, provided as DeKalb DKC 52-40, and was a glyphosate-tolerant corn type.

Several treatment compositions identified on Table 1C were prepared as tank mix compositions which were sprayed onto separate plots of the corn crop which was visually observed to be primarily in a V4 stage of growth, with the corn plants being predominantly from 6-8 inches high. The treatment was applied 28 days post planting. Each of the tank mix compositions was tested on three replicate plots, which were non-adjacent to one another. Additionally three test plots were planted with the above corn variety but were untreated in order to provide a “control” crop. The tank mix compositions were sprayed on the plants, utilizing a conventional hand sprayer operating at 35 psi, and at a delivery rate of 20 gallons/acre.

The largely aqueous tank mix compositions included the following constituents;

TABLE 1C

| | Tank Mixes | | | | |
|---|---|---|---|---|---|
| | A | B | C | D | C1 |
| PERMIT ® | 0.67 oz/ | 0.5 oz/ | — | — | — |
| | acre | acre | | | |
| YUKON ® | — | — | 4 oz/acre | 3 oz/acre | — |
| ROUNDUP | 22 | 22 | 22 | 22 fl.oz/acre | 22 |
| WeatherMAX ® | fl.oz/acre | fl.oz/acre | fl.oz/acre | | fl.oz/acre |
| nonionic surfactant | 0.25% | 0.25% | 0.25% | 0.25% | 0.25% vol/vol |
| | vol/vol | vol/vol | vol/vol | vol/vol | |
| ammonium sulfate | 3 lbs/acre | 3 lbs/acre | 3 lbs/acre | 3 lbs/acre | 3 lbs/acre |
| water | q.s. | q.s. | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The tank mix, “C1” was a tank mix produced as a comparative formulation. The following constituents were utilized, and used “as supplied” from their respective manufacturer and/or supplier:

| | |
|---|---|
| PERMIT ® | commercially available preparation comprising |
| | 75% wt. halosulfuron methyl, (ex. Gowan Co.) |
| YUKON ® | commercially available preparation comprising 12.5% |
| | wt. halosulfuron methyl, 55% wt. dicamba, balance |
| | to 100% wt. of intert constituents (ex. Gowan Co.) |
| ROUNDUP | commercially available preparation comprising 48.7% |
| WeatherMAX ® | wt. sodium salt of a glyphosate herbicidal |
| | composition (ex. Monsanto Co.) |
| nonionic | nonionic surfactant |
| surfactant | |
| ammonium | ammonium sulfate |
| sulfate | |
| water | water |

Each of the foregoing was applied at 28 days post planting, and evaluations as to both the phytotoxicity of the applied tank mix compositions and the efficacy of the applied tank mix compositions against the undesired vegetative growth was evaluated 6, 14, 28, 60, and 120 days after application of the respective tank mix compositions, with the observed results reported on the following Table 1CR. The table also lists the observed results from three replicate “control” plots which were untreated by any composition during the test. The observed phytoxicity of the applied tank mixes applied to the corn plants was visually observed and evaluated based on random standard sized areas of each of the test plots, and the averaged results are reported as % of plants exhibiting phytoxicity. The observed control of the undesired vegetative growth, namely Faber's foxtail (Setaria faberi), velvetleaf (Abutilon theoprasti), common waterhemp (Amaranthus tamariscinus), common lambsquarters (Chenopodium album) and ivyleaf morningglory (Ipomoea hederacea) were reported relative to the untreated control plots, and were evaluated by either visually observing or counting the number of each of the foregoing in random standard sized areas of each of the test plots, and the averaged results from each of the three replicate plots are reported as % control for each of the species.

TABLE 1CR

| | | | Faber's foxtail | | | | Velvetleaf | | | | common waterhemp | | | |
|---|---|---|---|---|---|---|---|---|---|---|---|---|---|---|
| | phytotoxicity | | (% controlled) | | | | (% controlled) | | | | (% controlled) | | | |
| | Days after application: | | | | | | | | | | | | | |
| | | 14 | 14 | 28 | 60 | 120 | 14 | 28 | 60 | 120 | 14 | 28 | 60 | 120 |
| | 6 days | days | days | days | days | days | days | days | days | days | days | days | days | days |
| tank mix A | 3% | 0% | 99 | 95 | 95 | 95 | 99 | 93 | 92 | 99 | 96 | 93 | 93 | 96 |
| tank mix B | 3% | 0% | 99 | 93 | 93 | 95 | 99 | 92 | 90 | 99 | 95 | 92 | 90 | 96 |
| tank mix C | 5% | 0% | 99 | 93 | 95 | 95 | 99 | 95 | 95 | 99 | 93 | 95 | 93 | 99 |
| tank mix D | 5% | 0% | 99 | 95 | 95 | 95 | 99 | 93 | 92 | 99 | 93 | 93 | 93 | 99 |
| tank mix C1 | 0% | 0% | 99 | 93 | 95 | 95 | 99 | 90 | 88 | 98 | 90 | 90 | 83 | 85 |

| | common lambsquarter | | | | ivyleaf morningglory | | | |
|---|---|---|---|---|---|---|---|---|
| | (% controlled) | | | | (% controlled) | | | |
| | Days after application: | | | | | | | |
| | 14 days | 28 days | 60 days | 120 days | 14 days | 28 days | 60 days | 120 days |
| tank mix A | 99 | 99 | 99 | 99 | 98 | 87 | 85 | 77 |
| tank mix B | 99 | 99 | 98 | 99 | 99 | 88 | 87 | 77 |
| tank mix C | 99 | 99 | 99 | 99 | 99 | 88 | 88 | 80 |
| tank mix D | 99 | 99 | 99 | 98 | 98 | 88 | 88 | 82 |
| tank mix C1 | 99 | 95 | 90 | 90 | 98 | 85 | 85 | 78 |

As can be seen from the foregoing reported results from Table 1CR, the tank mixes comprising the halosulfuron methyl herbicidal compounds in conjunction with the glyphosate herbicidal compound provided highly effective control of the undesired vegetative growth, and in some cases provided improved control of certain weeds than the tank mix which excluded the halosulfuron methyl herbicidal compound. Further, any observed initial minor phyotoxic effects were quickly overcome by the corn plants in a number of days.

### Corn (II)

A further study to evaluate the postemergence application of herbicidal treatment compositions comprising halosulfuron methyl on corn crops, and comparing the efficacy of these herbicidal treatment compositions on certain undesired vegetative growth, more specifically; Faber's foxtail, also known as “giant foxtail” (Setaria faberi), yellow nutsedge (Cyperus esculentus), giant ragweed (Ambrosia trifida), common cocklebur (Xanthium strumarium), common ragweed (Ambrosia artemisiifolia), and velvetleaf (Abutilon theoprasti). The evaluation was performed on a plurality of 10 ft. by 24 ft. test plots in southern Illinois wherein the presence of the foregoing undesired vegetative growth, viz., weeds, as known to be prevalent, and whose presence was confirmed at the locus of the test plots. The corn crop was of the type Zea mays indentata, provided as Pioneer 33K44 (ex.DuPont), and was a glyphosate-tolerant corn type.

Several treatment compositions as described on Table 2C were prepared as tank mix compositions which were sprayed onto separate plots of the corn crop. At the time of application, the presence of each of the foregoing weeds were confirmed, and which varied in height and number of leaves present per species. Each of the tank mix compositions was tested on four replicate plots, which were non-adjacent to one another. Additionally four test plots were planted with the above corn variety but were untreated in order to provide a “control” crop. The tank mix compositions were sprayed on the plants, utilizing a CO2 sprayer operating at 40 psi, providing a flat fan spray pattern operating at a delivery rate of 20 gallons/acre.

The largely aqueous tank mix compositions included the following constituents;

TABLE 2C

| | Tank Mixes | | | | |
|---|---|---|---|---|---|
| | A | B | C | D | C1 |
| PERMIT ® | 0.67 oz/ | 0.5 oz/ | — | — | — |
| | acre | acre | | | |
| YUKON ® | — | — | 4 oz/acre | 3 oz/acre | — |
| ROUNDUP | 22 | 22 | 22 | 22 fl.oz/acre | 22 |
| WeatherMAX ® | fl.oz/acre | fl.oz/acre | fl.oz/acre | | fl.oz/acre |
| ACTIVATOR 90 ® | 0.25% | 0.25% | 0.25% | 0.25% | 0.25% vol/vol |
| | vol/vol | vol/vol | vol/vol | vol/vol | |
| ammonium sulfate | 3 lbs/acre | 3 lbs/acre | 3 lbs/acre | 3 lbs/acre | 3 lbs/acre |
| water | q.s. | q.s. | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The tank mix “C1” was produced as a comparative example. The constituents were utilized, and used “as supplied” from their respective manufacturer and/or supplier:

| | |
|---|---|
| PERMIT ® | commercially available preparation comprising |
| | 75% wt. halosulfuron methyl, (ex. Gowan Co.) |
| YUKON ® | commercially available preparation comprising 12.5% |
| | wt. halosulfuron methyl, 55% wt. dicamba, balance |
| | to 100% wt. of intert constituents (ex. Gowan Co.) |
| ROUNDUP | commercially available preparation comprising 48.7% |
| WeatherMAX ® | wt. sodium salt of a glyphosate herbicidal |
| | composition (ex. Monsanto Co.) |
| ACTIVATOR | non-ionic surfactant containing 90% wt. of |
| 90 ® | Tembotrione: 2-[2-chloro-4-(methylsulfonyl)- |
| | 3-[(2,2,2- trifluoroethoxy)methyl]benzoyl]- |
| | 1,3-cyclohexanedione (ex. Loveland Products Inc.) |
| ammonium | ammonium sulfate |
| sulfate | |
| water | water |

Each of the foregoing was applied at 28 days post planting, and evaluations as to the crop yield (at harvest) as well as both the phytotoxicity of the applied tank mix compositions and the efficacy of the applied tank mix compositions against the undesired vegetative growth was evaluated 7, 14, 28, 60, and 120 days after application of the respective tank mix compositions, with the observed results reported on the following Table 2CR. The table also lists the observed results from four replicate “control” plots which were untreated by any composition during the test. The averaged crop yield in bushels/acre are reported. The observed phytoxicity of the applied tank mixes applied to the corn plants was visually observed and evaluated based on random standard sized areas of each of the test plots, and the averaged results are reported as % of plants exhibiting phytoxicity. The observed control of the undesired vegetative growth, were reported relative to the untreated control plots, and were evaluated by either visually observing or counting the number of each of the foregoing in random standard sized areas of each of the test plots, and the averaged results from each of the three replicate plots are reported as % control for each of the species.

TABLE 2CR

| | % phytotoxicity | | | | | |
|---|---|---|---|---|---|---|
| | days after application | | | | | final harvested |
| | 7 days | 14 days | 28 days | 60 days | 120 days | yield (bushels/acre) |
| untreated (control) | | | | | | 6 |
| tank mix A | 0 | 0 | 0 | 0 | 0 | 137 |
| tank mix B | 0 | 0 | 0 | 0 | 0 | 130 |
| tank mix C | 0 | 0 | 0 | 0 | 0 | 124 |
| tank mix D | 0 | 0 | 0 | 0 | 0 | 123 |
| tank mix C1 | 0 | 0 | 0 | 0 | 0 | 121 |
| (comparative) | | | | | | |

| | giant foxtail | | | | yellow nutsedge | | | | giant ragweed | | | |
|---|---|---|---|---|---|---|---|---|---|---|---|---|
| | (% controlled) | | | | (% controlled) | | | | (% controlled) | | | |
| | Days after application: | | | | | | | | | | | |
| | 14 | 28 | 60 | 120 | 14 | 28 | 60 | 120 | 14 | 28 | 60 | 120 |
| | days | days | days | days | days | days | days | days | days | days | days | days |
| tank mix A | 99 | 97 | 93 | 93 | 83 | 91 | 87 | 87 | 97 | 96 | 94 | 94 |
| tank mix B | 99 | 98 | 90 | 90 | 80 | 91 | 88 | 88 | 96 | 97 | 93 | 93 |
| tank mix C | 99 | 98 | 90 | 90 | 88 | 95 | 87 | 87 | 98 | 97 | 93 | 93 |
| tank mix D | 99 | 97 | 86 | 86 | 84 | 93 | 85 | 85 | 98 | 97 | 95 | 95 |
| tank mix | 99 | 96 | 88 | 88 | 74 | 49 | 33 | 33 | 97 | 93 | 83 | 83 |
| C1 | | | | | | | | | | | | |
| | common cocklebur | | | | common ragweed | | | | | | | |
| | (% controlled) | | | | (% controlled) | | | | velvetleaf (% controlled) | | | |
| | Days after application: | | | | | | | | | | | |
| | 14 | 28 | 60 | 120 | 14 | 28 | 60 | 120 | 14 | 28 | 60 | 120 |
| | days | days | days | days | days | days | days | days | days | days | days | days |
| tank mix A | 98 | 98 | 96 | 96 | 99 | 99 | 98 | 98 | 97 | 90 | 89 | 89 |
| tank mix B | 99 | 98 | 97 | 97 | 99 | 99 | 98 | 98 | 98 | 89 | 88 | 88 |
| tank mix C | 98 | 95 | 97 | 97 | 99 | 99 | 98 | 98 | 98 | 94 | 95 | 95 |
| tank mix D | 98 | 94 | 96 | 96 | 99 | 99 | 98 | 98 | 98 | 90 | 90 | 88 |
| tank mix | 91 | 80 | 57 | 57 | 99 | 99 | 95 | 95 | 90 | 68 | 62 | 62 |
| C1 | | | | | | | | | | | | |

As can be seen from the foregoing reported results from Table 2CR, the tank mixes comprising the halosulfuron methyl herbicidal compounds in conjunction with the glyphosate herbicidal compound provided highly effective control of the undesired vegetative growth, and in some cases provided improved control of certain weeds than the tank mix which excluded the halosulfuron methyl herbicidal compound, namely the comparative tank mix formulation “C1”. The foregoing results also illustrate that phytotoxic effects were not evident from any of the tank mixes, and also indicate improved crop yields of the tank mixes comprising the halosulfuron methyl herbicidal compounds in conjunction with the glyphosate herbicidal compound as opposed to the comparative tank mix formulation “C1”.

### Corn (III)

A study was performed to evaluate the post-plant, postemergence application of herbicidal treatment compositions comprising halosulfuron methyl on corn crops grown from glyphosate-tolerant seed, and comparing the efficacy of these herbicidal treatment compositions on certain undesired vegetative growth, more specifically, velvetleaf (Abutilon theoprasti), yellow nutsedge (Cyperus esculentus), common ragweed (Ambosia artemisiifolia), common lambsquarters (Chenopodium album) and Pennsylvania smartweed (Polygonum pensylvanicum). The evaluation was performed on a plurality of 10 ft. by 24 ft. test plots in Iowa wherein the presence of the foregoing undesired vegetative growth, viz., weeds, as known to be prevalent, and whose presence was confirmed at the locus of the test plots. The corn crop was of the type Zea mays indentata, provided as DKC 5-20 RR/CB (ex. DeKalb), and was a glyphosate-tolerant corn type.

Several treatment compositions as described on Table 3C were prepared as tank mix compositions which were sprayed onto separate plots of the corn crop. At the time of application, the presence of each of the foregoing weeds were confirmed, and which varied in height and number of leaves present per species. Each of the tank mix compositions was tested on three replicate plots, which were non-adjacent to one another. Additionally three test plots were planted with the above corn variety but were untreated in order to provide a “control” crop. The tank mix compositions were sprayed on the plants, utilizing a CO2 pressurized backpack sprayer operating at 40 psi, providing a flat fan spray pattern operating at a delivery rate of 20 gallons/acre.

The largely aqueous tank mix compositions included the following constituents;

TABLE 3C

| | tank mixes | | | | |
|---|---|---|---|---|---|
| | C2 | A | B | C | D |
| PERMIT ® | — | 0.67 oz/ | 0.67 oz/ | 0.67 oz/ | 0.67 oz/ |
| | | acre | acre | acre | acre |
| YUKON ® | — | — | — | — | — |
| CALLISTO ® | 6 oz/acre | — | — | — | 3 oz/acre |
| GLYPHOMAX XRT ® | 24 oz/acre | 24 oz/acre | 24 oz/acre | 24 oz/acre | 24 oz/acre |
| ATRAZINE 4L ® | — | — | 1 lb/acre | — | — |
| BALANCE PRO ® | — | — | — | 1.5 oz/ | — |
| | | | | acre | |
| COC | 1% v/v | 1% v/v | 1% v/v | 1% v/v | 1% v/v |
| UAN | 1% v/v | 1% v/v | 1% v/v | 1% v/v | 1% v/v |
| water | q.s. | q.s. | q.s. | q.s. | q.s. |

| | tank mixes | | | | | |
|---|---|---|---|---|---|---|
| | E | F | G | H | I | J |
| PERMIT ® | 0.67 oz/acre | 0.67 oz/ | 0.67 oz/ | 0.67 oz/ | 0.67 oz/ | — |
| | | acre | acre | acre | acre | |
| YUKON ® | — | — | — | — | — | 4 oz/acre |
| CALLISTO ® | 2 oz/acre | 1 oz/acre | — | — | — | — |
| GLYPHOMAX | 24 oz/ | 24 oz/ | 24 oz/ | 24 oz/ | 24 oz/ | 24 oz/ |
| XRT ® | acre | acre | acre | acre | acre | acre |
| SENCOR ® | — | — | 5.33 oz/ | — | — | — |
| | | | acre | | | |
| PRINCEP 90DF | — | — | — | 3.3 lb/ | — | — |
| | | | | acre | | |
| HARMONY GT ® | — | — | — | — | 0.6 oz/ | — |
| | | | | | acre | |
| COC | 1% v/v | 1% v/v | 1% v/v | 1% v/v | 1% v/v | 1% v/v |
| UAN | 1% v/v | 1% v/v | 1% v/v | 1% v/v | 1% v/v | 1% v/v |
| water | q.s. | q.s. | q.s. | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The tank mix “C2” identified above was produced as further comparative examples to the untreated “control” plots, which are identified as “C1”. The constituents were utilized, and used “as supplied” from their respective manufacturer and/or supplier:

| | |
|---|---|
| PERMIT ® | commercially available preparation comprising 75% wt. |
| | halosulfuron methyl, (ex. Gowan Co.) |
| YUKON ® | commercially available preparation comprising 12.5% wt. |
| | halosulfuron methyl, 55% wt. dicamba, balance to 100% wt. of |
| | intert constituents (ex. Gowan Co.) |
| ROUNDUP | commercially available preparation comprising 48.7% wt. |
| WeatherMAX ® | sodium salt of a glyphosate herbicidal composition (ex. |
| | Monsanto Co.) |
| CALLISTO ® | commercially available herbicidal preparation containing 40% |
| | % wt. of mesotrione (ex. Syngenta) |
| GLYPHOMAX XRT ® | commercially available herbicidal preparation containing 53.6% |
| | wt glyphosate IPA salt (ex. Dow Agroscience) |
| ATRAZINE 4L ® | commercially available herbicidal preparation containing |
| | 40.8% atrazine which is 2-chloro-4-ethylamino-6- |
| | isopropylamino-s-triazine (ex. Agrisolutions) |
| SENCOR ® | a commercial herbicidal preparation containing 75% % wt. of |
| | Metribuzin (ex. Bayer Cropscience) |
| PRINCEP 90DF ® | commercially available herbicidal preparation containing 90% |
| | simazine which is 6-chloro-N-N′-diethyl-1,3,5-triazine-2,4- |
| | diamine (ex. Syngenta) |
| HARMONY GT ® | commercially available herbicidal preparation containing 75% |
| | hifensulfuron-methyl Methyl 3-[[[[(4-methoxy-6-methyl-1,3,5- |
| | triazin-2-yl) amino]carbonyl]amino]sulfonyl]-2- |
| | thiophenecarboxylate (ex. DuPont) |
| COC | crop oil concentrate |
| UAN | urea ammonium nitrate |
| water | water |

Each of the foregoing was applied at 5 days post planting. The averaged observed phytotoxicity of the applied tank mix compositions was evaluated at 20 days from planting, while the efficacy of the applied tank mix compositions against the undesired vegetative growth was evaluated at 39 days from planting (34 days after application), with the observed results reported on the following Table 3CR. The table also lists the observed results for the replicates “control” plots which were untreated by any composition during the test. The observed phytoxicity of the applied tank mixes applied to the corn plants was visually observed and evaluated based on random standard sized areas of each of the test plots, and the averaged results are reported as % of plants exhibiting phytoxicity. The observed control of the undesired vegetative growth, were reported relative to the untreated control plots, and were evaluated by either visually observing or counting the number of each of the foregoing in random standard sized areas of each of the test plots, and the averaged results from each of the three replicate plots are reported as % control for each of the species.
The table also lists the observed results for the replicates “control” plots “C1” which were untreated by any composition during the test, as well as of the comparative examples based on tank mix “C2”.

TABLE 3CR

| | | | common | | | Pennsylvania |
|---|---|---|---|---|---|---|
| tank mix | | yellow nutsedge | ragweed | lambsquarter | velvetleaf | smartweed |
| applied | phytotoxicity (%) | (% control) | (% controlled) | (% controlled) | (% controlled) | (% controlled) |
| none (C1) | 0 | 0 | 0 | 0 | 0 | 0 |
| C2 | 0 | 99 | 99 | 99 | 99 | 99 |
| A | 0 | 99 | 96.7 | 99 | 93 | 99 |
| B | 0 | 99 | 99 | 93 | 99 | 99 |
| C | 1.7 | 99 | 99 | 99 | 99 | 99 |
| D | 0 | 99 | 99 | 99 | 99 | 99 |
| E | 0 | 99 | 99 | 98.3 | 99 | 99 |
| F | 0 | 99 | 99 | 99 | 99 | 99 |
| G | 1.7 | 99 | 99 | 99 | 99 | 99 |
| H | 1.7 | 99 | 99 | 99 | 99 | 99 |
| I | 5 | 99 | 99 | 96 | 97.7 | 99 |
| J | 0 | 99 | 99 | 97 | 98.3 | 99 |

As can be seen from the foregoing reported results from Table 3CR, the tank mixes comprising the halosulfuron methyl herbicidal compounds in conjunction with the further herbicidal compound provided highly effective control of the undesired vegetative growth. Any phytotoxicity was minor, and the corn plants grown from glyphosate-tolerant seed were observed to substantially recover in a short time following the date of evaluation.

### Corn (IV)

A study was performed to evaluate the post-plant, postemergence application of herbicidal treatment compositions comprising halosulfuron methyl on corn crops grown from glyphosate-tolerant seed, and comparing the efficacy of these herbicidal treatment compositions on certain undesired vegetative growth, more specifically, velvetleaf (Abutilon theoprasti), common ragweed (Ambosia artemisiifolia), common lambsquarters (Chenopodium album) and tall Morningglory (Ipomoea Purpuea (L.) Roth) The evaluation was performed on a plurality of 10 ft. by 24 ft. test plots in Illinois wherein the presence of the foregoing undesired vegetative growth, viz., weeds, as known to be prevalent, and whose presence was confirmed at the locus of the test plots. The corn crop was of the type Zea Mays L. ssp. Indentata Sturt. provided as PIONEER P33N12 (ex. DuPont), and was indicated by its supplier to be glyphosate-tolerant corn type.

Several treatment compositions as described on Table 4C were prepared as tank mix compositions which were sprayed onto separate plots of the corn crop. At the time of application, the presence of each of the foregoing weeds were confirmed, and which varied in height and number of leaves present per species. Each of the tank mix compositions was tested on three replicate plots, which were non-adjacent to one another. Additionally three test plots were planted with the above corn variety but were untreated in order to provide a “control” crop. The tank mix compositions were sprayed on the plants, utilizing a CO2 pressurized backpack sprayer operating at 42 psi, providing a flat fan spray pattern operating at a delivery rate of 20 gallons/acre.

The largely aqueous tank mix compositions included the following constituents;

TABLE 4C

| | tank mixes | | | | |
|---|---|---|---|---|---|
| | C2 | C3 | C4 | A | B |
| PERMIT ® | — | — | — | 0.031 lbs. | 0.031 lbs. |
| | | | | active/acre | active/acre |
| YUKON ® | — | — | — | — | — |
| CALLISTO ® | 4 lbs. | — | — | — | — |
| | active/acre | | | | |
| ATRAZINE 90DF ® | 0.33 lbs. | — | 1 lbs. | 0.75 lbs. | 1 lbs. |
| | active/acre | | active/acre | active/acre | active/acre |
| ROUNDUP Original | 0.75% v/v | 0.75% lbs. | — | — | — |
| MAX ® 4.5 AE | | active/acre | | | |
| HALEX GT 4.38L ® | — | — | 2.19 lbs. | — | — |
| | | | active/acre | | |
| COC | 1% v/v | 1% v/v | 2.19% v/v | 1%% v/v | 1%% v/v |
| liquid AMS | 2.5% v/v | — | 2.5% v/v | 2.5% v/v | 2.5% v/v |
| ACTIVATOR 90 ® | — | 2.5% v/v | — | — | — |
| water | q.s. | q.s. | q.s. | q.s. | q.s. |
| | tank mixes | | | | |
| | C | D | E | F | G |
| PERMIT ® | 0.031 lbs. | 0.031 lbs. | 0.031 lbs. | 0.031 lbs. | 0.031 lbs. |
| | active/acre | active/acre | active/acre | active/acre | active/acre |
| YUKON ® | — | — | — | — | — |
| CALLISTO ® | — | — | 0.016 lbs. | 0.031 lbs. | — |
| | | | active/acre | active/acre | |
| ATRAZINE 90DF ® | — | — | — | — | — |
| ROUNDUP Original | — | — | — | — | — |
| MAX ® 4.5 AE | | | | | |
| HALEX GT 4.38L ® | — | — | — | — | — |
| IMPACT 2.8SC ® | 0.0027 lbs. | 0.0055 | — | — | — |
| | active/acre | 0.031 lbs. | | | |
| | | active/acre | | | |
| LAUDIS 3.5SC ® | — | — | — | — | 0.027 lbs. |
| | | | | | active/acre |
| COC | 1% v/v | 1% v/v | 1% v/v | 1% v/v | 1% v/v |
| liquid AMS | 2.5% v/v | 2.5% v/v | 2.5% v/v | 2.5% v/v | 2.5% v/v |
| ACTIVATOR 90 ® | — | — | — | — | — |
| water | q.s. | q.s. | q.s. | q.s. | q.s. |
| | tank mixes | | | | |
| | H | I | J | K | L |
| PERMIT ® | 0.031 lbs. | — | — | 0.031 lbs. | 0.023 lbs. |
| | active/acre | | | active/acre | active/acre |
| YUKON ® | — | 0.169 lbs. | 0.169 lbs. | — | — |
| | | active/acre | active/acre | | |
| CALLISTO ® | — | — | — | — | — |
| ATRAZINE 90DF ® | — | — | — | — | — |
| ROUNDUP Original | — | — | — | 0.75 lbs. | 0.75 lbs. |
| MAX ® 4.5 AE | | | | active/acre | active/acre |
| HALEX GT 4.38L ® | — | — | — | — | — |
| IMPACT 2.8SC ® | — | — | — | — | — |
| LAUDIS 3.5SC ® | — | — | — | — | — |
| SENCOR DF ® | 0.094 lbs. | — | 0.094 lbs. | — | — |
| | active/acre | | active/acre | | |
| COC | — | 1% v/v | — | — | — |
| liquid AMS | 2.5% v/v | 2.5% v/v | 2.5% v/v | 2.5% v/v | 2.5% v/v |
| ACTIVATOR 90 ® | 0.25% v/v | — | 0.25% v/v | 0.25% v/v | 0.25% v/v |
| water | q.s. | q.s. | q.s. | q.s. | q.s. |

tank mixes

| | M | N |
|---|---|---|
| PERMIT ® | — | — |
| YUKON ® | 0.169 lbs. | 0.13 lbs. |
| | active/acre | active/acre |
| CALLISTO ® | — | — |
| ATRAZINE 90DF ® | — | — |
| ROUNDUP Original | 0.75 lbs. | 0.75 lbs. |
| MAX ® 4.5 AE | active/acre | active/acre |
| HALEX GT 4.38L ® | — | — |
| IMPACT 2.8SC ® | — | — |
| LAUDIS 3.5SC ® | — | — |
| SENCOR DF ® | — | — |
| COC | — | — |
| liquid AMS | 2.5% v/v | 2.5% v/v |
| ACTIVATOR 90 ® | 0.25% v/v | 0.25% v/v |
| water | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The tank mixes “C2”. “C3” and “C4” identified above were produced as further comparative examples to the untreated “control” plots, which are identified as “C1”. The constituents were utilized, and used “as supplied” from their respective manufacturer and/or supplier:

| | |
|---|---|
| PERMIT ® | commercially available preparation comprising 75% wt. |
| | halosulfuron methyl, (ex. Gowan Co.) |
| YUKON ® | commercially available preparation comprising 12.5% wt. |
| | halosulfuron methyl, 55% wt. dicamba, balance to 100% wt. of |
| | intert constituents (ex. Gowan Co.) |
| ROUNDUP Original | commercially available herbicidal preparation |
| MAX ® | containing 48.7% wt. of glyphosate (ex. Monsanto) |
| CALLISTO ® | CALLISTO is a commercially available herbicidal preparation |
| | containing 40%% wt. of mesotrione (ex. Syngenta) |
| ATRAZINE 90DF ® | a commercially available herbicidal preparation containing 90% |
| | wt. of atrazine, available from Agriliance LLC |
| SENCOR ® | a commercial herbicidal preparation containing 75%% wt. of |
| | Metribuzin (ex. Bayer Cropscience) |
| HALEX GT 4.38L ® | commercial herbicidal preparation containing S-metolachlor |
| | 20.50% Glyphosate, N-(phosphonomethyl) glycine 20.50%, |
| | and Mesotrione (ex. Syngenta Co./Inc.) |
| IMPACT 2.8SC ® | a commercially available herbidicdal preparation containing |
| | 29.7% wt. of Topramezone [3-(4,5-dihydro-3-isoxazolyl)-2- |
| | methyl-4-(methylsulfonyl) phenyl] (5-hydroxy-1-methyl-1H- |
| | pyrazol-4-yl) methanone (ex. AMVAC Co.) |
| LAUDIS 3.5SC ® | a commercially available herbicidal preparation containing |
| | 34.5% wt. of Tembotrione: 2-[2-chloro-4-(methylsulfonyl)-3- |
| | [(2,2,2-trifluoroethoxy)methyl]benzoyl]-1,3-cyclohexanedione |
| | (ex. Bayer CropScience) |
| SENCOR DF ® | a commercially available herbicidal preparation containing |
| | 75%% wt. of Metribuzin (ex. Bayer CropScience) |
| COC | crop oil concentrate |
| liquid AMS | liquid ammonium sulfate |
| ACTIVATOR 90 ® | non-ionic wetting agent containing 90% wt. of |
| | Tembotrione: 2-[2-chloro-4-(methylsulfonyl)-3-[(2,2,2- |
| | trifluoroethoxy)methyl]benzoyl]-1,3-cyclohexanedione (ex. |
| | Loveland Products Inc.) |
| water | water |

Each of the foregoing was applied at 21 days post planting. The efficacy of the applied tank mix compositions against the undesired vegetative growth was evaluated at 38, 58, 79, and 113 days from planting, with the observed results reported on the following Table 4CR. The observed control of the undesired vegetative growth, were reported relative to the untreated control plots, and were evaluated by either visually observing or counting the number of each of the foregoing in random standard sized areas of each of the test plots, and the averaged results from each of the three replicate plots are reported as % control for each of the species. The table also lists the observed results for the replicates “control” plots “C1” which were untreated by any composition during the test, as well as of the comparative examples based on tank mixes “C2”, “C3” and “C4”.

TABLE 4CR

| | common lambsquarter | | | | common ragweed | | | |
|---|---|---|---|---|---|---|---|---|
| | (% controlled) | | | | (% controlled) | | | |
| | Days after planting: | | | | | | | |
| | 38 | 58 | 79 | 113 | 38 | 58 | 79 | 113 |
| Tank mix: | days | days | days | days | days | days | days | days |
| none (C1) | 0 | 0 | 0 | 0 | 0 | 0 | 0 | 0 |
| C2 | 99 | 99 | 99 | 99 | 99 | 99 | 99 | 99 |
| C3 | 99 | 98 | 98 | 95 | 94 | 88 | 93 | 86 |
| C4 | 99 | 99 | 99 | 99 | 99 | 99 | 99 | 99 |
| A | 99 | 99 | 96 | 94 | 95 | 91 | 89 | 87 |
| B | 99 | 99 | 99 | 99 | 99 | 93 | 96 | 94 |
| C | 98 | 83 | 80 | 75 | 99 | 87 | 83 | 78 |
| D | 99 | 90 | 80 | 74 | 99 | 95 | 87 | 84 |
| E | 99 | 89 | 82 | 73 | 99 | 93 | 89 | 85 |
| F | 99 | 96 | 88 | 84 | 99 | 97 | 94 | 90 |
| G | 99 | 99 | 89 | 85 | 99 | 99 | 92 | 88 |
| H | 99 | 97 | 91 | 88 | 98 | 84 | 83 | 80 |
| I | 99 | 99 | 96 | 94 | 99 | 99 | 97 | 96 |
| J | 99 | 99 | 99 | 99 | 99 | 98 | 99 | 99 |
| K | 99 | 99 | 96 | 97 | 99 | 96 | 93 | 90 |
| L | 99 | 99 | 99 | 94 | 99 | 93 | 94 | 90 |
| M | 99 | 99 | 99 | 99 | 99 | 99 | 99 | 99 |
| N | 99 | 99 | 98 | 99 | 99 | 99 | 99 | 99 |
| | velvetleaf | | | | tall Morningglory | | | |
| | (% controlled) | | | | (% controlled) | | | |
| | Days after planting: | | | | | | | |
| | 38 | 58 | 79 | 113 | 38 | 58 | 79 | 113 |
| Tank mix: | days | days | days | days | days | days | days | days |
| none (C1) | 0 | 0 | 0 | 0 | 0 | 0 | 0 | 0 |
| C2 | 99 | 99 | 99 | 99 | 96 | 93 | 84 | 81 |
| C3 | 96 | 88 | 90 | 84 | 91 | 80 | 79 | 70 |
| C4 | 99 | 99 | 99 | 99 | 98 | 95 | 93 | 90 |
| A | 96 | 98 | 94 | 90 | 93 | 89 | 72 | 65 |
| B | 98 | 96 | 99 | 97 | 97 | 90 | 83 | 79 |
| C | 99 | 98 | 90 | 88 | 90 | 67 | 72 | 63 |
| D | 99 | 98 | 98 | 97 | 93 | 73 | 75 | 68 |
| E | 99 | 99 | 90 | 86 | 96 | 78 | 67 | 58 |
| F | 99 | 99 | 97 | 94 | 96 | 84 | 75 | 70 |
| G | 99 | 99 | 97 | 93 | 95 | 84 | 75 | 58 |
| H | 96 | 96 | 89 | 87 | 88 | 67 | 67 | 62 |
| I | 99 | 97 | 97 | 96 | 95 | 89 | 83 | 79 |
| J | 98 | 99 | 99 | 98 | 84 | 87 | 84 | 80 |
| K | 99 | 94 | 94 | 91 | 93 | 86 | 85 | 80 |
| L | 99 | 95 | 94 | 89 | 94 | 87 | 81 | 78 |
| M | 99 | 94 | 99 | 97 | 97 | 95 | 93 | 89 |
| N | 99 | 99 | 99 | 96 | 97 | 92 | 87 | 83 |

As is seen from the foregoing, compositions according to the invention exhibited excellent control of undesired vegetative growth among glyphosate tolerant corn plants in the corn crop.

### Soybean (I)

A field trial was initiated near Ft. Atkinson, Iowa to evaluate the crop safety and weed control efficacy seen from pre-emergence applications of PERMIT® herbicide to soybeans. Several treatment compositions which were prepared as tank mix compositions described on Table 1S were applied at a variety of timings, namely 21 days preplanting, 14 days preplanting, 7 days preplanting, on the day of planting, and again 5 days after planting which was just prior to crop emergence, viz., pre-cracking, as well as 7 days after planting. It is to be noted that such treatments were single applications according to one of the above timings, and not to be understood as indicating a sequence of timings of applications to any single test plot.

The several tested, largely aqueous tank mix compositions included the following constituents;

TABLE 1S

| | Tank Mixes | | |
|---|---|---|---|
| | A | B | C1 |
| PERMIT ® | 0.67 oz/acre | 1.33 oz/acre | — |
| YUKON ® | — | — | — |
| FIRSTRATE ® 84DF | — | — | 0.6 oz/acre |
| water | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The tank mix “C1” was produced as a comparative example. The constituents were provided, and used “as supplied” from their respective manufacturer and/or supplier:

| | |
|---|---|
| PERMIT ® | commercially available preparation comprising 75% wt. |
| | halosulfuron methyl, (ex. Gowan Co.) |
| FIRSTRATE ® 84DF | FIRSTRATE ® 84DF is a herbicide comprising 84% wt |
| | Cloransulam-methyl currently registered for preemergence |
| | use on soybeans; and its application rate of 0.6 oz/acre is |
| | indicated by its supplier to be the normal stand-alone |
| | preemergence application rate for this product. (ex. Dow |
| | AgroSciences) |
| ACTIVATOR 90 ® | non-ionic surfactant containing 90% wt. of |
| | Tembotrione: 2-[2-chloro-4-(methylsulfonyl)-3-[(2,2,2- |
| | trifluoroethoxy)methyl]benzoyl]-1,3-cyclohexanedione (ex. |
| | Loveland Products Inc.) |
| ammonium sulfate | ammonium sulfate |
| water | water |

Nine soybean varieties were selected to evaluate crop safety of the above tank mix compositions applied at the foregoing timings.; all were indicated to be Roundup Ready varieties, viz, glyphosate tolerant, and certain were also indicated as also be genetically modified in order to exhibit sulfonylurea tolerance. The following soybean varieties were tested:

Asgrow AG1903 RR, 1.9 RM (ex. Monsanto)

Pioneer 91M91, 1.9 RM (ex. DuPont)

Stine 1918-4RR, 1.9 RM (ex. Stine)

Northrup King NK S19-R5 RR, 1.9 RM (ex. Syngenta)

Dairyland DL2000 RR/STS, 2.0 RM (ex. Dairyland)

Crows 2015RR, 2.0 RM (ex. Crows)

Garst 2018RR, 2.0 RM (ex. Syngenta)

Asgrow AG2204RR/STS, 2.2 RM (ex. Monsanto)

Pioneer 92M32 RR, 2.3 RM (ex. DuPont)

The foregoing varieties were planted in maturity order (RM 1.9 to RM 2.3) as listed above in 4 row strips (4 rows×38″ rows, or 12.7 ft. strips). There were 3 replicates of each treatment per pre-plant application timing. Application of the above tank mixes at the respective indicated timings were performed by a CO2 backpack application, with nozzles which applied the compositions at height of 18 inches above ground and at a rate of 20 gallons/acre.

As the soybeans emerged and began active growth, it was noted that visible injury to the soybean plants was essentially non-existent in all treatments independent of application timing. Stand counts were unaffected by herbicide treatments provided by the tank mixes indicated. Therefore applications of PERMIT® in tank mixes A and B did not appear to adversely affect germination or emergence of the tested soybean varieties.

### Rice (I):

A study was performed to evaluate the postemergence application of herbicidal treatment compositions comprising halosulfuron methyl on rice crops, and comparing the efficacy of these herbicidal treatment compositions on certain undesired vegetative growth, more specifically: common barnyard grass (Echinochloa crus-galli), sesbania (Sesbania exaltata), yellow nutsedge (Cyperus esculentus), and soybean (Glycine max). The evaluation was performed on a plurality of 6.67 ft. by 15 ft. test rice paddies located in Louisiana wherein the presence of the foregoing undesired vegetative growth as known to be prevalent, and whose presence was confirmed at the locus of the test rice paddies. The rice crop was common rice (Oryza sativa).

Several treatment compositions as described on Table 1R were prepared as tank mix compositions and sprayed at time intervals of either 10-14 days preplanting, or preemergence of the rice crop. Each of these tank mix compositions was tested on three replicate plots, which were non-adjacent to one another. Additionally six test plots were planted with the above rice variety but were untreated in order to provide a “control” crop in order to provide a comparison of the efficacy of the applied tank mixes to both 10-14 day preplanting, and preemergent rice crops. The tank mix compositions were sprayed on the plants, utilizing a conventional CO2 pressurized backpack sprayer with a conventional Greenleaf nozzle operating at 31 psi, and at a delivery rate of 15 gallons/acre of the respective tank mix.

The largely aqueous tank mix compositions included the following constituents;

TABLE 1R

tank mixes

| | A | B |
|---|---|---|
| PERMIT ® | 0.5 oz/acre | 0.66 oz/acre |
| water | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The constituents were provided, and used “as supplied” from their respective manufacturer and/or supplier:

| | |
|---|---|
| PERMIT ® | commercially available preparation comprising 75% wt. |
| | halosulfuron methyl, (ex. Gowan Co.) |
| Water | water |

Each of the foregoing was applied as indicated above, and the test plots were evaluated at 7, 16, 27, 55 and 86 days after planting in order to evaluate the efficacy of the applied tank mix compositions against the undesired vegetative growth with the averaged observed results reported on the following Table 1RR. The table also lists the averaged observed results from two sets of the three replicate “control” plots which were untreated by any composition during the test. The observed control of the undesired vegetative growth were reported relative to the related untreated control plots, and were evaluated by either visually observing or counting the number of each of the foregoing in random standard sized areas of each of the test plots, and the averaged results from each of the three replicate plots are reported as % control for each of the species. On the following table “C1” indicates the untreated rice plots which were compared to the rice plots treated at 10-14 days preplanting, while “C2” indicates the untreated rice plots which were compared to the rice plots treated post planting but preemergence.

Also reported are the crop yields harvested from the plots, reported as the average of the three replicates, with the actual yield harvested from the identified test plots, and a calculated yield of bushels/acre based on the actual yield harvested.

TABLE 1RR

| | soybean | | | | | common barnyard grass | | | | |
|---|---|---|---|---|---|---|---|---|---|---|
| | (% controlled) | | | | | (% controlled) | | | | |
| | Days after application: | | | | | | | | | |
| | 7 days | 16 days | 27 days | 55 days | 86 days | 7 days | 16 days | 27 days | 55 days | 86 days |
| C1 | 0 | 0 | 0 | 93 | 95 | 77 | 87 | 53 | 95 | 95 |
| Tank mix A (applied 10-14 | 87 | 90 | 77 | 93 | 95 | 90 | 88 | 75 | 93 | 93 |
| days preplanting) | | | | | | | | | | |
| Tank mix B (applied 10-14 | 87 | 87 | 78 | 93 | 95 | 90 | 88 | 73 | 95 | 95 |
| days preplanting) | | | | | | | | | | |
| C2 | 0 | 0 | 53 | 93 | 95 | 77 | 90 | 53 | 93 | 93 |
| Tank mix A (applied | 88 | 92 | 87 | 93 | 95 | 90 | 90 | 85 | 93 | 93 |
| preemergence) | | | | | | | | | | |
| Tank mix B (applied | 88 | 92 | 77 | 93 | 95 | 90 | 90 | 77 | 93 | 93 |
| preemergence) | | | | | | | | | | |
| | yellow nutsedge | | | | | sesbania | | | | |
| | (% controlled) | | | | | (% controlled) | | | | |
| | Days after application: | | | | | | | | | |
| | 7 days | 16 days | 27 days | 55 days | 86 days | 7 days | 16 days | 27 days | 55 days | 86 days |
| C1 | 53 | 80 | 63 | 93 | 95 | 95 | 73 | — | 93 | 95 |
| Tank mix A (applied 10-14 | 80 | 95 | 92 | 93 | 95 | 88 | 93 | 85 | 93 | 95 |
| days preplanting) | | | | | | | | | | |
| Tank mix B (applied 10-14 | 90 | 95 | 92 | 93 | 95 | 93 | 93 | 87 | 93 | 95 |
| days preplanting) | | | | | | | | | | |
| C2 | 53 | 77 | 63 | 93 | 95 | 95 | 73 | — | 93 | 95 |
| Tank mix A (applied | 83 | 93 | 92 | 93 | 95 | 95 | 95 | 77 | 93 | 95 |
| preemergence) | | | | | | | | | | |
| Tank mix B (applied | 83 | 93 | 92 | 93 | 95 | 95 | 95 | 78 | 93 | 95 |
| preemergence) | | | | | | | | | | |

| | average crop yield | calculated crop yield |
|---|---|---|
| identity of test plots (untreated or treated by:) | (lbs/plot) | (bushels/acre) |
| C1 | 7 | 116 |
| tank mix A (applied 10-14 days preplanting) | 9 | 138 |
| tank mix B (applied 10-14 days preplanting) | 9 | 138 |
| C2 | 7 | 116 |
| tank mix A (applied preemergence) | 9 | 137 |
| tank mix B (applied preemergence) | 9 | 138 |

As is readily seen from the foregoing data, the treatment compositions comprising halosulfuron methyl provided good control of undesired vegetative growth and provided significantly improved crop yields.

### Rice (II)

A study was performed to evaluate the preemergence and postemergence application of herbicidal treatment compositions comprising halosulfuron methyl on rice crops, and comparing the efficacy of these herbicidal treatment compositions on certain undesired vegetative growth, (viz, weeds) more specifically: Pennsylvania smartweed (Polygonum pensylvanicum), carpetweed (Mollugo verticillata), broadleaf signalgrass (Brachiariaplatyphylla (Griseb.)), pitted morningglory (Ipomoea lacunosa), yellow nutsedge (Cyperus esculentus), northern jointvetch, sesbania (hemp) (Sesbania exaltata (Raf.)) The evaluation was performed on a plurality of 10 ft. by 25 ft. test rice paddies located in Arkansas wherein the presence of the foregoing undesired vegetative growth as known to be prevalent, and whose presence was confirmed at the locus of the test rice paddies. For the test, the test rice paddies were also overseeded with sesbania (hemp). The rice crop tested was common rice (Oryza sativa). Four (4) replicate plots were used for each test. Each of the plots were treated both preplanting and postplanting according to various regimens of treatments and application methods which were applied according to the following timings and protocols:

| | | |
|---|---|---|
| Treat- | applied 10-14 | applied to the plots utilizing a conventional |
| ment 1 | days preplanting | CO2 backpack sprayer operating at 20 psi, |
| | | supplied with drifting type nozzle which |
| | | delivered the composition at a rate of 10 |
| | | gallons/acre. |
| Treat- | applied on day of | applied to the plots utilizing a conventional |
| ment 2 | planting (0 days) | CO2 backpack sprayer operating at 20 psi, |
| | | supplied with drifting type nozzle which |
| | | delivered the composition at a rate of 10 |
| | | gallons/acre |
| Treat- | applied 14 days | applied to the plots utilizing a conventional |
| ment 3 | after planting | Mudmaster sprayer operating with |
| | | compressed air, supplied with drifting type |
| | | nozzle which delivered the composition at a |
| | | rate of 10 gallons/acre |
| Treat- | applied 25 days | applied to the plots utilizing a tractor at an |
| ment 4 | after planting | application rate of 10 gallons/acre |

For sake of convenient reference, the treated crops are identified by a letter code, referred to as a “crop code” identifying the specific treatment compositions and concentrations applied to the four replicates of the rice crops at each of the four foregoing treatment intervals. Such may be referred to as a treatment process or treatment regimen.

| Crop | | |
|---|---|---|
| Code: | Treatment | Treatment Composition |
| A | 1 | COMMAND ®, applied at 1 pint/acre |
| | 2 | RICESTAR HT ® applied at 20 ounces/acre with COC at 1% vol/vol |
| | 3 | RICESTAR HT ® applied at 20 ounces/acre with COC at 1% vol/vol |
| | 4 | — |
| B | 1 | — |
| | 2 | COMMAND ®, applied at 1 pint/acre with ROUNDUP WeatherMAX ® at |
| | | 22 ounces/acre |
| | 3 | RICESTAR HT ® applied at 20 ounces/acre with COC at 1% vol/vol |
| | 4 | RICESTAR HT ® applied at 20 ounces/acre with COC at 1% vol/vol |
| C | 1 | — |
| | 2 | PERMIT ® applied at 0.5 ounces/acre with ROUNDUP WeatherMAX ® |
| | | at 22 ounces/acre |
| | 3 | RICESTAR HT ® applied at 20 ounces/acre with COC at 1% vol/vol |
| | 4 | RICESTAR HT ® applied at 20 ounces/acre with COC at 1% vol/vol |
| D | 1 | — |
| | 2 | PERMIT ® applied at 0.66 ounces/acre with ROUNDUP WeatherMAX ® |
| | | at 22 ounces/acre |
| | 3 | RICESTAR HT ® applied at 20 ounces/acre with COC at 1% vol/vol |
| | 4 | RICESTAR HT ® applied at 20 ounces/acre with COC at 1% vol/vol |
| E | 1 | — |
| | 2 | PERMIT ® applied at 0.5 ounces/acre with ROUNDUP WeatherMAX ® |
| | | at 22 ounces/acre and with COMMAND at 1 pint/acre |
| | 3 | RICESTAR HT ® applied at 20 ounces/acre with COC at 1% vol/vol |
| | 4 | RICESTAR HT ® applied at 20 ounces/acre with COC at 1% vol/vol |
| F | 1 | — |
| | 2 | PERMIT ® applied at 0.66 ounces/acre with ROUNDUP WeatherMAX ® |
| | | at 22 ounces/acre and with COMMAND at 1 pint/acre |
| | 3 | RICESTAR HT ® applied at 20 ounces/acre with COC at 1% vol/vol |
| | 4 | RICESTAR HT ® applied at 20 ounces/acre with COC at 1% vol/vol |
| G | 1 | PERMIT ® applied at 0.5 ounces/acre with ROUNDUP WeatherMAX ® |
| | | at 22 ounces/acre and with COMMAND at 1 pint/acre |
| | 2 | — |
| | 3 | RICESTAR HT ® applied at 20 ounces/acre with COC at 1% vol/vol |
| | 4 | RICESTAR HT ® applied at 20 ounces/acre with COC at 1% vol/vol |
| H | 1 | PERMIT ® applied at 0.66 ounces/acre with ROUNDUP WeatherMAX ® |
| | | at 22 ounces/acre and with COMMAND at 1 pint/acre |
| | 2 | — |
| | 3 | RICESTAR HT ® applied at 20 ounces/acre with COC at 1% vol/vol |
| | 4 | RICESTAR HT ® applied at 20 ounces/acre with COC at 1% vol/vol |
| I | 1 | STRADA ® applied at 2.1 ounces/acre with ROUNDUP WeatherMAX ® |
| | | at 22 ounces/acre and with COMMAND at 1 pint/acre |
| | 2 | — |
| | 3 | RICESTAR HT ® applied at 20 ounces/acre with COC at 1% vol/vol |
| | 4 | RICESTAR HT ® applied at 20 ounces/acre with COC at 1% vol/vol |
| J | 1 | STRADA ® applied at 4.2 ounces/acre with ROUNDUP WeatherMAX ® |
| | | at 22 ounces/acre and with COMMAND at 1 pint/acre |
| | 2 | — |
| | 3 | RICESTAR HT ® applied at 20 ounces/acre with COC at 1% vol/vol |
| | 4 | RICESTAR HT ® applied at 20 ounces/acre with COC at 1% vol/vol |
| K | 1 | PERMIT ® applied at 1.33 ounces/acre with ROUNDUP WeatherMAX ® |
| | | at 22 ounces/acre and with COMMAND at 1 pint/acre |
| | 2 | — |
| | 3 | RICESTAR HT ® applied at 20 ounces/acre with COC at 1% vol/vol |
| | 4 | RICESTAR HT ® applied at 20 ounces/acre with COC at 1% vol/vol |

The foregoing crops identified by “crop codes” A, B and I which omitted the PERMIT® herbicidal composition are provided as comparative examples.

The identity of the foregoing constituents used for producing the treatment compositions identified in the prior table are identified in the following table:

| | |
|---|---|
| PERMIT ® | commercially available preparation comprising |
| | 75% wt. halosulfuron methyl, (ex. Gowan Co.) |
| COMMAND ® | commercially available herbicidal preparation |
| | comprising 31.1% wt clomazone (ex. FMC Corp.) |
| ROUNDUP | commercially available preparation comprising |
| WeatherMAX ® | 48.7% wt. sodium salt of a glyphosate herbicidal |
| | composition (ex. Monsanto Co.) |
| RICESTAR | commercially available preparation comprising |
| HT ® | 6.37-7.04% wt Fenoxaprop-p-ethyl herbicidal |
| | composition (ex. Bayer Cropscience) |
| STRADA ® | commercially available preparation comprising _50% |
| | wt Orthosulfamuron herbicidal composition |
| | (ex. Isagro USA) |
| COC | crop oil concentrate |
| water | water |

The foregoing constituents were provided, and used “as supplied” from their respective manufacturer and/or supplier to form the identified treatment composition which were largely aqueous. Each of the foregoing treatment compositions used were formed as tank mixes in which water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common usage in the art. Each of these largely aqueous tank mixes was prepared in a conventional manner, viz., by adding the following constituents, optionally under stirring, at the amounts/rates per acre specified to a larger volume of water until they were well dispersed or dissolved. The constituents were provided, and used “as supplied” from their respective manufacturer and/or supplier.

Each of the crops referred by crop codes A through K were treated according to the treatment regimen as indicated in the forgoing. The crops undergoing one of the foregoing treatment regimens were periodically examined for the effect of the treatment regimen on the specific rice crops as well as efficacy in controlling the undesired vegetative growth at various times after planting, and the averaged observed results (based on the four replicate plots for each of the crop codes A through K) are reported on the following Table 2RR. The observed control of the undesired vegetative growth were reported relative to untreated control plots which were also present but untreated, and the evaluation was performed by either visually observing or counting the number of each of the foregoing in random standard sized areas of each of the test plots, and the averaged results from each of the four replicate plots are reported as % control for each of the species. Also reported are the crop yields harvested from the plots, reported as the average of the four replicate plots for crops identified by the crop codes A through K.

Also reported are the crop yields harvested from the plots, reported as the average of the four replicates relating to each of crop codes A through K, with the averaged actual yield harvested from the identified test plots, and a calculated yield of bushels/acre based on the actual yield harvested.

TABLE 2RR

| | | | | | | | | yellow | |
|---|---|---|---|---|---|---|---|---|---|
| | broadleaf | | Pennsylvania | | | | pitted | nutsedge | northern |
| | signalgrass | | smartweed | | Sesbania | carpetweed | Morningglory | (% | jointvetch |
| | (% control) | | (% control) | | (% control) | (% control) | (% control) | control) | (% control) |
| | days, post-planting: | | | | | | | | |
| | 0 days | 14 days | 0 days | 119 days | 34 days | 34 days | 34 days | 119 days | |
| crop code: A | — | 61 | — | 60 | 0 | 0 | 0 | 0 | 85 |
| crop code: B | 90 | 100 | 48 | 75 | 70 | 18 | 93 | 38 | 80 |
| crop code: C | 0 | 50 | 55 | 88 | 38 | 10 | 39 | 78 | 73 |
| crop code: D | 30 | 68 | 55 | 95 | 0 | 0 | 0 | 38 | 58 |
| crop code: E | 94 | 100 | 85 | 93 | 58 | 26 | 88 | 80 | 40 |
| crop code: F | 95 | 100 | 96 | 100 | 91 | 41 | 74 | 88 | 0 |
| crop code: G | — | 100 | — | 100 | 85 | 74 | 85 | 88 | 75 |
| crop code: H | — | 100 | — | 96 | 81 | 79 | 90 | 95 | 75 |
| crop code: I | — | 100 | — | 100 | 81 | 68 | 88 | 78 | 60 |
| crop code: J | — | 98 | — | 100 | 85 | 76 | 94 | 88 | 33 |
| crop code: K | — | 100 | — | 100 | 93 | 90 | 98 | 95 | 68 |

observed injury to rice plants (% injury)
days, post-planting:

| | 14 days | 34 days | 62 days | 124 days |
|---|---|---|---|---|
| crop code: A | 8 | 0 | 0 | 0 |
| crop code: B | 5 | 0 | 0 | 0 |
| crop code: C | 1 | 0 | 0 | 0 |
| crop code: D | 5 | 0 | 0 | 0 |
| crop code: E | 3 | 0 | 0 | 0 |
| crop code: F | 6 | 0 | 0 | 0 |
| crop code: G | 11 | 0 | 0 | 0 |
| crop code: H | 10 | 0 | 0 | 0 |
| crop code: I | 9 | 0 | 0 | 0 |
| crop code: J | 9 | 0 | 0 | 0 |
| crop code: K | 9 | 0 | 0 | 0 |

| | |
|---|---|
| | calculated crop |
| average crop yield | yield |
| (lbs/plot) | (bushels/acre) |

days, post-planting:

| | 124 days | 124 days |
|---|---|---|
| crop code: A | 20.5 | 99.6 |
| crop code: B | 25 | 122.2 |
| crop code: C | 24.8 | 120.6 |
| crop code: D | 23.6 | 114.8 |
| crop code: E | 26.7 | 129.5 |
| crop code: F | 25 | 121.1 |
| crop code: G | 26.8 | 130.3 |
| crop code: H | 27.5 | 133.8 |
| crop code: I | 26.8 | 130.2 |
| crop code: J | 24.4 | 118.4 |
| crop code: K | 30.6 | 148.7 |

As is evident from the above, use of halosulfuron-methyl herbicide provided in treatment regimens used on rice crops provided excellent crop yields, good control of undesirable vegetative growth and did not deleteriously affect the rice plants to any significant degree.

### Rice (III)

A study was performed to evaluate both the preemergence and postemergence application of herbicidal treatment compositions comprising halosulfuron methyl on rice crops, and comparing the efficacy of these herbicidal treatment compositions on certain undesired vegetative growth, more specifically: common barnyard grass (Echinochloa crus-galli), sesbania (Sesbania exaltata), yellow nutsedge (Cyperus esculentus), pitted morningglory (Ipomoea Iacunosa), and a strain of glyphosate-tolerant soybean plants (Glycine max). The evaluation was performed on a plurality of 6.67 ft. by 15 ft. test rice paddies located in Mississippi wherein the presence of the foregoing undesired vegetative growth as known to be prevalent, and whose presence was confirmed at the locus of the test rice paddies (plots). The rice crop was common rice (Oryza sativa) of the Cocodrie variety.

Several treatment compositions identified on Table 3R were prepared as tank mix compositions and sprayed at a first time interval of 15-18 days preplanting, or at a second time interval of 10-14 days post planting but preemergence of the rice crop. Each of the tank mix compositions was tested on four replicate plots, which were non-adjacent to one another. Additionally eight test plots were planted with the above rice variety but were treated with a control composition based on commercially available herbicide preparations which did not include halosulfuron-methyl so to provide a “control” crop in order to provide a comparison of the efficacy of the applied tank mixes to both preplanting, and preemergent rice crops. The control composition was applied in the same manner as the following tank mix compositions, with a first set of four replicate “control” plots treated at 15-18 days preplanting and a second set of the remaining four further replicate “control” plots treated 10-14 days post planting but preemergence of the rice plants. All of the tank mix compositions as well as the control compositions were sprayed on the plants, utilizing a conventional CO2 pressurized backpack sprayer with a conventional Greenleaf nozzle operating at 26 psi, and at a delivery rate of 15 gallons/acre of the respective tank mix.

The largely aqueous tank mix compositions and control compositions included the indicated constituents;

TABLE 3R

| | | |
|---|---|---|
| A | B | C1 |

| PERMIT ® | 0.5 | oz/acre | 0.67 | oz/acre | — | |
|---|---|---|---|---|---|---|
| ROUNDUP | 23.3 | oz/acre | 23.3 | oz/acre | 23.3 | oz/acre |
| WeatherMAX ® | | | | | | |
| COMMAND ® | 1.3 | pints/acre | 1.3 | pints/acre | 1.3 | pints/acre |

| | | | |
|---|---|---|---|
| water | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The constituents were provided, and used “as supplied” from their respective manufacturer and/or supplier:

| | |
|---|---|
| PERMIT ® | commercially available preparation comprising |
| | 75% wt. halosulfuron methyl, (ex. Gowan Co.) |
| ROUNDUP | commercially available preparation comprising |
| WeatherMAX ® | 48.7% sodium salt of glyphosate herbicidal |
| | composition (ex. Monsanto Co.) |
| COMMAND ® | commercially available herbicidal preparation |
| | comprising 31.1% wt Clomazone (ex. FMC Corp.) |
| water | Water |

Each of the foregoing was applied as indicated above, separately at 15-18 days preplanting, or 10-14 days post planting but preemergence of the rice crop in the test rice plots. The condition of the rice and undesired vegetative growth was evaluated at various times; condition of the rice plants which emerged 7 days after planting were evaluated at 7, 14, 30 and 55 days after planting. For test plots treated preplanting, evaluations were performed at 0, 7, 14 30 and 55 days after planting, while for test plots treated post-planting but preemergence , evaluations were performed at 7, 14 30 and 55 days after planting in order to evaluate the efficacy of the applied tank mix compositions and control compositions. The averaged observed results for each set of similarly treated test plots are reported on the following Table 3RR. The table also lists the averaged observed results from two sets of the four replicate “control” plots which were treated with the control composition during the test. The observed control of the undesired vegetative growth were reported relative to the two sets of the four replicate “control” plots, and were evaluated by either visually observing or counting the number of each of the foregoing in random standard sized areas of each of the test plots, and the averaged results from each of the three replicate plots are reported as % control for each of the species. On the following table “C-Pre” indicates the rice plots treated preplanting with the control composition “C1”, while “C-Post” indicates the rice plots treated post planting but preemergence. Also reported are the crop yields harvested from the plots, reported as the average of the four replicates, with the actual yield harvested from the identified test plots, and a calculated yield of bushels/acre based on the actual yield harvested.

TABLE 3RR

| | soybean | | | | | common barnyard grass | | | | |
|---|---|---|---|---|---|---|---|---|---|---|
| | (% controlled) | | | | | (% controlled) | | | | |
| | Days after application: | | | | | | | | | |
| | 0 days | 7 days | 14 days | 30 days | 55 days | 0 days | 7 days | 14 days | 30 days | 55 days |
| C-Pre | 0 | 0 | 0 | 0 | 99 | 99 | 99 | 86 | — | 90 |
| Tank mix A (applied 15-18 | 79 | 74 | 76 | 77 | 99 | 99 | 99 | 79 | — | 87 |
| days preplanting) | | | | | | | | | | |
| Tank mix B (applied 15-18 | 79 | 76 | 70 | 68 | 99 | 99 | 99 | 85 | — | 85 |
| days preplanting) | | | | | | | | | | |
| C-Post | — | 0 | 0 | 0 | 99 | — | 91 | 91 | — | 86 |
| Tank mix A (applied 10-14 | — | 48 | 58 | 75 | 99 | — | 91 | 91 | — | 91 |
| days postplanting) | | | | | | | | | | |
| Tank mix B (applied 10-14 | — | 55 | 63 | 76 | 99 | — | 91 | 90 | — | 85 |
| days postplanting) | | | | | | | | | | |
| | yellow nutsedge | | | | | sesbania | | | | |
| | (% controlled) | | | | | (% controlled) | | | | |
| | Days after application: | | | | | | | | | |
| | 0 days | 7 days | 14 days | 30 days | 55 days | 0 days | 7 days | 14 days | 30 days | 55 days |
| C-Pre | 60 | 63 | 54 | 0 | 90 | 93 | 81 | 81 | 53 | 99 |
| Tank mix A (applied 15-18 | 79 | 80 | 87 | 85 | 94 | 92 | 71 | 78 | 63 | 99 |
| days preplanting) | | | | | | | | | | |
| Tank mix B (applied 15-18 | 85 | 85 | 88 | 85 | 93 | 91 | 81 | 81 | 79 | 97 |
| days preplanting) | | | | | | | | | | |
| C-Post | — | 50 | 73 | 25 | 88 | — | 89 | 84 | 65 | 99 |
| Tank mix A (applied 10-14 | — | 64 | 91 | 88 | 96 | — | 85 | 88 | 85 | 99 |
| days postplanting) | | | | | | | | | | |
| Tank mix B (applied 10-14 | — | 69 | 90 | 93 | 95 | — | 90 | 90 | 83 | 98 |
| days postplanting) | | | | | | | | | | |

| | pitted Morningglory | | | | |
|---|---|---|---|---|---|
| | (% controlled) | | | | |
| | Days after application: | | | | |
| | 0 days | 7 days | 14 days | 30 days | 55 days |
| C-Pre | — | — | — | 0 | 99 |
| Tank mix A (applied 15-18 | — | — | — | 48 | 99 |
| days preplanting) | | | | | |
| Tank mix B (applied 15-18 | — | — | — | 60 | 99 |
| days preplanting) | | | | | |
| C-Post | — | — | — | 0 | 99 |
| Tank mix A (applied 10-14 | — | — | — | 64 | 99 |
| days postplanting) | | | | | |
| Tank mix B (applied 10-14 | — | — | — | 70 | 99 |
| days postplanting) | | | | | |

observed injury to rice plants (% injury)
days, post-planting:

| | 7 days | 14 days | 30 days | days |
|---|---|---|---|---|
| C-Pre | 0 | 0 | 0 | 0 |
| Tank mix A | 2 | 0 | 0 | 0 |
| (applied 15-18 | | | | |
| days preplanting) | | | | |
| Tank mix B | 4 | 1 | 1 | 0 |
| (applied 15-18 | | | | |
| days preplanting) | | | | |
| C-Post | 0 | 1 | 0 | 0 |
| tank mix A | 3 | 5 | 5 | 3 |
| (applied 10-14 | | | | |
| days postplanting) | | | | |
| tank mix B | 5 | 6 | 5 | 1 |
| (applied 10-14 | | | | |
| days postplanting) | | | | |

| | average crop yield | calculated crop yield |
|---|---|---|
| | (lbs/plot) | (bushels/acre) |
| C-Pre | 8 | 182 |
| tank mix A (applied 15-18 days preplanting) | 8 | 189 |
| tank mix B (applied 15-18 days preplanting) | 8 | 185 |
| C-Post | 8 | 190 |
| tank mix A (applied 10-14 days postplanting) | 8 | 179 |
| tank mix B (applied 10-14 days postplanting) | 8 | 183 |

The foregoing shows that improved control of undesired vegetative growth may be attained with treatment compositions comprising halosulfuron-methyl, with minimal damage to rice crops and with comparable or increased rice harvest yields.

### Cotton (I)

A study was performed to evaluate the effect of application of herbicidal treatment compositions comprising halosulfuron methyl on cotton crops, and also to determine the efficacy of these herbicidal treatment compositions on certain undesired vegetative growth, specifically pigweed and purple nutsedge, present in the cotton crop. The evaluation was performed on a plurality of 13.3 ft. by 30 ft. test plots in Texas wherein the presence of purple nutsedge as known to be prevalent, and whose presence was confirmed at the locus of the test plots. Three replicate test plots were used to evaluate each treatment regimen, viz, the application of a specific treatment composition at a specific timing. The cotton used in all of the test plots was an AFC3511RR variety.

In the test, four different treatment compositions which are identified on Table 1T were prepared as tank mix compositions, and each of which were sprayed on test plots at one of the following timings: 49, 42, 35, 28, 21, 14, 7, 0 days before planting. Each of the tank mix compositions was tested on each of the three replicate plots, which were non-adjacent to one another. Additionally two further sets of three test plots were planted with the above cotton variety but were untreated in order to provide a “control” crop. In each application, the tank mix compositions (treatment compositions) were sprayed to broadcast the composition utilizing a conventional CO2 pressurized backpack sprayer equipped with a turbotee nozzle, operating at 26 psi, and at a delivery rate of 10 gallons/acre.

The largely aqueous tank mix compositions (treatment compositions) included the following constituents;

TABLE 1T

| | Tank mixes | | | | | | | |
|---|---|---|---|---|---|---|---|---|
| | A | | B | | C | | D | |
| PERMIT ® | 0.5 | oz/acre | 0.67 | oz/acre | 0.75 | oz/acre | 1.0 | oz/acre |
| nonionic surfactant | 0.25% | vol/vol | 0.25% | vol/vol | 0.25% | vol/vol | 0.25% | vol/vol |

| | | | | |
|---|---|---|---|---|
| water | q.s. | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The constituents were provided, and used “as supplied” from their respective manufacturer and/or supplier:

| | |
|---|---|
| PERMIT ® | commercially available preparation comprising |
| | 75% wt. halosulfuron methyl, (ex. Gowan Co.) |
| nonionic surfactant | nonionic surfactant |
| water | water |

As noted, separate sets of test plots were treated with at 49, 42, 35, 28, 21, 14, 7, 0 days before planting with one of tank mixes A, B, C, D. Subsequent to the emergence of the cotton plants, the condition of the cotton plants was evaluated at 17, 24, 33, 61 and 68 days post planting. The degree of observed damage to the various treated cotton crops treated according to the specific treatment regimens is identified on the following Table 1TR.

TABLE 1TR

| | preplanting | Observed damage to cotton plants (% damage) | | | |
|---|---|---|---|---|---|
| | day of tank | 17 days | 24 days | 61 days | 68 days |
| tank mix | mix | post | post | post | post |
| applied | application | planting | planting | planting | planting |
| A | 49 | 0 | 0 | 0 | 0 |
| B | 49 | 0 | 0 | 0 | 0 |
| C | 49 | 0 | 0 | 0 | 0 |
| D | 49 | 0 | 0 | 0 | 0 |
| A | 42 | 0 | 0 | 0 | 0 |
| B | 42 | 0 | 0 | 0 | 0 |
| C | 42 | 0 | 0 | 0 | 0 |
| D | 42 | 0 | 0 | 0 | 0 |
| A | 35 | 0 | 0 | 0 | 0 |
| B | 35 | 0 | 0 | 0 | 0 |
| C | 35 | 0 | 0 | 0 | 0 |
| D | 35 | 0 | 0 | 0 | 0 |
| A | 8 | 0 | 0 | 0 | 0 |
| B | 28 | 0 | 0 | 0 | 0 |
| C | 28 | 0 | 0 | 0 | 0 |
| D | 28 | 0 | 0 | 0 | 0 |
| A | 21 | 0 | 0 | 0 | 0 |
| B | 21 | 0 | 0 | 0 | 0 |
| C | 21 | 0 | 0 | 0 | 0 |
| D | 21 | 0 | 0 | 0 | 0 |
| A | 14 | 0 | 0 | 0 | 0 |
| B | 14 | 0 | 0 | 0 | 0 |
| C | 14 | 0 | 0 | 0 | 0 |
| D | 14 | 0 | 0 | 0 | 0 |
| A | 7 | 0 | 0 | 0 | 0 |
| B | 7 | 0 | 0 | 0 | 0 |
| C | 7 | 0 | 0 | 0 | 0 |
| D | 7 | 0 | 0 | 0 | 0 |
| A | 0 | 0 | 0 | 0 | 0 |
| B | 0 | 0 | 0 | 0 | 0 |
| C | 0 | 0 | 0 | 0 | 0 |
| D | 0 | 0 | 0 | 0 | 0 |

The foregoing results illustrate the surprising discovery of the utility of the halosulfuron methyl based herbicidal compounds in use with cotton plants, especially in preplanting applications, as no apparent damage or injury to the cotton plants was observed in any of the preplanting applications.

Concurrently with the above evaluation, the observed control of the undesired vegetative growth of pigweed was evaluated relative to the untreated control plots which were also present but untreated, and the evaluation was performed by either visually observing or counting the number of each of the foregoing in random standard sized areas of each of the test plots, and the averaged results from each of the sets of replicate plots are reported as % control for each of the species. The evaluation was made 33 days post planting of the cotton crop, and the observed degree of control of the pigweed is identified in the following further section of table 1TR.

TABLE 1TR

| | preplanting day | |
|---|---|---|
| tank mix | of tank mix | pigweed |
| applied | application | (% controled) |
| A | 49 | 94 |
| B | 49 | 91 |
| C | 49 | 98 |
| D | 49 | 97 |
| A | 42 | 95 |
| B | 42 | 97 |
| C | 42 | 98 |
| D | 42 | 96 |
| A | 35 | 98 |
| B | 35 | 99 |
| C | 35 | 100 |
| D | 35 | 96 |
| A | 8 | 93 |
| B | 28 | 98 |
| C | 28 | 95 |
| D | 28 | 91 |
| A | 21 | 96 |
| B | 21 | 100 |
| C | 21 | 96 |
| D | 21 | 98 |
| A | 14 | 92 |
| B | 14 | 95 |
| C | 14 | 98 |
| D | 14 | 96 |
| A | 7 | 100 |
| B | 7 | 99 |
| C | 7 | 95 |
| D | 7 | 93 |
| A | 0 | 93 |
| B | 0 | 95 |
| C | 0 | 100 |
| D | 0 | 99 |

The untreated plots exhibited “0% control” of the pigweed present amongst the cotton plants. This information in conjunction with the foregoing data regarding damage to cotton plants surprisingly reveals the safety and utility of the treatment compositions in preplanting applications.

### Alfalfa (I)

A study was performed to evaluate the effect of application of herbicidal treatment compositions comprising halosulfuron methyl on dormant alfalfa crops, applied in the autumn after the final annual cutting of the plants and after the crop became dormant for the winter months. The evaluation was performed on a plurality of 10 ft. by 30 ft. test plots in Iowa Three replicate test plots were used to evaluate each treatment applied. The alfalfa was Maxi-Graze GT (ex. Land O'Lakes Co.)

In the test, four different treatment compositions as identified on Table 1A were prepared as tank mix compositions, and each of which were sprayed on once on the dormant crop in late November. Each of the tank mix compositions was tested on each of the three replicate plots, which were non-adjacent to one another. Additionally a set of three test plots which included the alfalfa but which were untreated in order to provide a “control” crop. In each application, the tank mix compositions (treatment compositions) were sprayed to broadcast the composition utilizing a conventional CO2 pressurized backpack sprayer, operating at 40 psi, and at a delivery rate of 20 gallons/acre.

The largely aqueous tank mix compositions (treatment compositions) included the following constituents;

TABLE 1A

| | Tank mixes | | | |
|---|---|---|---|---|
| | A | B | C | D |
| PERMIT ® | 0.5 oz/acre | 0.67 oz/acre | 1.0 oz/acre | 1.33 oz/acre |
| water | q.s. | q.s. | q.s. | q.s. |

water was present in “q.s.”, or “quantum sufficient” in order to provide the balance of the compositions of each of the following mixtures. It is to be noted that the amounts (alternately, dosage or application rates/acre) of the constituents present are based the amounts required for treatment of an acre of the crop, or in other units of measurements which are commonly recognized and in common useage in the art. Each of these largely aqueous tank mixes was prepared in a conventional manner, viz., by adding the following constituents, optionally under stirring, at the amounts/rates per acre specified to a larger volume of water until they were well dispersed or dissolved. The constituents were provided, and used “as supplied” from their respective manufacturer and/or supplier:

| | |
|---|---|
| PERMIT ® | commercially available preparation comprising 75% wt. |
| | halosulfuron methyl, (ex. Gowan Co.) |
| water | water |

Following the first cutting of the plots in the last week of the following May, the following observations as reported on Table 1AR were made with regard to the quality of and the yield of the cut alfalfa per unit area:

TABLE 1AR

| | | | | weight | |
|---|---|---|---|---|---|
| | Average | | | (lbs.) per 4 | |
| | plant | | | square foot | calculated US |
| tank mix treatment | height | phytochlorosis | phytonecrosis | patch of test | tons/acre cut |
| applied: | (inches) | (%) | (%) | plot | alfalfa yield |
| A | 28.4 | 0 | 0 | 1.367 | 7.45 |
| B | 29.6 | 0 | 0 | 1.343 | 7.31 |
| C | 30.5 | 0 | 0 | 1.614 | 8.79 |
| D | 30.5 | 0 | 0 | 1.505 | 8.19 |
| untreated “control” | 29.47 | 0 | 0 | 1.258 | 6.85 |

Surprisingly and unexpectedly it was observed that the application of the foregoing treatment compositions appeared to improve the crop density and/or crop quality without the application of any other treatments in the time interval from application to the “first cut” in the following year. Such improved yields relative to the untreated control for the tank mixes A, B,C and D were respectively on the order of: 8.7%, 6.7%, 28.3% and 19.5%. Such improved yields are highly significant.

1. An agricultural method for the control of undesired vegetative growth in two (or more) crops each having a specific resistance to different classes of herbicides, wherein at least one of the crops has a resistance to or tolerance to halosulfuron methyl, and at least one of the other crops has does not exhibit a resistance to or tolerance to halosulfuron methyl, wherein the said crops are either adjacent to each other, or are in sufficient geographical proximity to one another whereby there exists a likelihood of inadvertent or of direct application of a first herbicide treatment preparation being applied to the said first crop to be either inadvertently or directly applied to at least a part of the second crop, wherein said application of said first herbicide treatment preparation does not undesirably or unduly deleteriously effect the treated seeds, or plants forming part of said second crop.

2. The agricultural method according to claim 1 wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.

3. An agricultural method for the control of undesired vegetative growth especially in a field or plot wherein a crop plant is to be planted or is already present in the form of a seed or plant having a resistance to or tolerance to glyphosate-type herbicides wherein undesired vegetative growth amongst the crop is controlled with or eradicated by the use of a herbicidal treatment preparation comprising a herbicidally effective amount of a halosulfuron methyl based herbicide which may be applied either pre-planting, pre-emergence or post-emergence of the said crop.

4. The method according to claim 3 wherein the halosulfuron methyl based herbicide is methyl, 3-chloro-5-(4,6-dimethoxypyrimidin-2-ylcarbamoylsulfamoyl)-1-methylpyrazole-4-carboxylic acid, or is a salt form thereof.

5. An agricultural method for the control of undesired vegetative growth in a corn (maize) crop grown from corn seeds or corn plants having glyphosate tolerance and the undesired vegetative growth is one or more of: Lambsquarter, Velvetleaf, Sesbania (hemp), Morningglory, ragweed, palmer amaranth, cocklebur, sunflower and foxtail which method comprises the step of applying a herbicidally effective amount of a treatment composition comprising a halosulfuron methyl based herbicide and optionally also with a glyphosate herbicidal compound to the crop, in order to control the said undesired vegetative growth within the crop.

6. The method according to claim 5 wherein the halosulfuron methyl based herbicide is methyl, 3-chloro-5-(4,6-dimethoxypyrimidin-2-ylcarbamoylsulfamoyl)-1-methylpyrazole-4-carboxylic acid, or is a salt form thereof.

7. A method of safening herbicidal compositions applied to soybeans or soybean plants, the method comprising the step of: incorporating an effective amount of halosulfuron methyl as a safener constituent to said herbicidal compositions.

8. The method according to claim 3, wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.

9. A method for the treatment of cotton crops which method includes the step of: applying halosulfuron methyl to a cotton crop.

10. The method according to claim 9, wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.

11. The method according to claim 9, wherein the application of halosulfuron methyl to the cotton crop occurs prior to planting of the crop.

12. The method according to claim 11, wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.

13. A method for controlling undesired vegetative growth amongst rice plants in a rice crop, which method includes step of: applying halosulfuron methyl to the rice crop.

14. The method according to claim 13, wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.

15. An agricultural method for increasing the harvestable yield of alfalfa, which method comprises the application of halosulfuron methyl to a dormant alfalfa crop following its final annual cutting, and prior to its reemergence in the spring.

16. The method according to claim 15, wherein the halosulfuron methyl is methyl, 3-chloro-5-(4,6-dimethoxypyrimidin-2-ylcarbamoylsulfamoyl)-1-methylpyrazole-4-carboxylic acid, or is a salt form thereof.
